(19) United States
(12) Patent Application Publication
(10) Pub. No.: US 2009/0201482 A1
(43) Pub. Date: Aug. 13, 2009

(54) Exposure Method and Apparatus

(76) Inventors: Takao Ozaki, Kanagawa-ken (JP); Tomoya Kitagawa, Kanagawa-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/922,724

(22) PCT Filed: Jun. 22, 2006
(86) PCT No.: PCT/JP2006/312937

§ 371 Date: Dec. 21, 2007

(30) Foreign Application Priority Data
Jun. 24, 2005 (JP) 2005-184488

(51) Int. Cl. G03B 27/72; G03B 27/32

(52) U.S. Cl. 355/71; 355/77

(57) ABSTRACT

A photosensitive material (for example, a glass substrate coated with a photoresist) is exposed to light in a predetermined pattern by illuminating the photosensitive material with exposure light by an exposure head which emits light that has been modulated by a spatial light modulation device. The exposure head and the photosensitive material are moved in a sub-scan direction at least twice for each photosensitive material. The operation of the spatial light modulation device is controlled in each of sub-scan movements to form an exposed area, of which the exposure amount is at least at two different levels, in the photosensitive material.

### TECHNICAL FIELD

The present invention relates to an exposure method and an exposure apparatus. Particularly, the present invention relates to an exposure method and an exposure apparatus for exposing a photosensitive material, such as a photoresist, to light in a predetermined pattern by illuminating the photosensitive material with light modulated by a spatial light modulation device.

### BACKGROUND ART

Conventionally, in production of a TFT (thin film transistor) for an LCD (liquid crystal display), a photolithography (hereinafter, referred to as photolitho) process is widely adopted. Basically, in the photolitho process for producing the TFT or the like, a thin photoresist coating is applied to a glass substrate on which a coating of metal or semiconductor has been formed. The photoresist is exposed to exposure light which is transmitted through a mask in which a predetermined pattern is formed. Then, the photoresist is developed to form a predetermined resist pattern.

In the photolitho process, as described above, the number of steps needs to be reduced, for example, to cut production costs of LCD's. As an exposure method for reducing the number of steps in the photolitho process, a method disclosed in Japanese Unexamined Patent Publication No. 2000-206571 is well known. In the method disclosed in Japanese Unexamined Patent Publication No. 2000-206571, halftone exposure is adopted. In this exposure method, an exposure mask which can change the intensity of exposure light to multiple levels of intensity within the area of the exposure mask is used. In this method, it is possible to form exposed areas on a photoresist at multiple exposure amounts which are different from each other by performing a single exposure operation. Hence, when development process is performed later, it is possible to leave a resist, based on a pattern, of which the thickness has been controlled at multiple levels.

Further, in Japanese Unexamined Patent Publication No. 2002-350897, a method for forming a plurality of structural members on a TFT panel by utilizing a photolitho process is disclosed. In this method, halftone exposure is adopted in a manner similar to the method disclosed in Japanese Unexamined Patent Publication No. 2000-206571 to form a plurality of structural members, of which the thicknesses are different from each other.

Further, in the structure disclosed in “High Transmissive Advanced TFT-LCD Technology”, Koichi Fujimori et al., Sharp Technical Report, No. 85, pp. 34-37, April 2003, a reflective member is provided on an LCD-TFT panel, which is a base material. The thickness of the reflective member is greater than that of a transmissive area formed on the LCD-TFT panel. Further, a very fine uneven pattern is formed on the surface of the reflective member to enhance the light scattering effect of the surface of the reflective member. Conventionally, the very fine uneven pattern, which is structured as described above, is formed by processing the surface of the reflective member which has been formed by performing a photolitho process.

Further, in Japanese Unexamined Patent Publication No. 2004-062157, a method for forming an optical wiring circuit on a circuit board without using a photomask is disclosed. In this method, an etching technique using modulated light beam is adopted to form a plurality of optical wiring circuits at different thickness levels in the layering direction. In this method, the plurality of optical wiring circuits at different thickness levels is formed by changing the exposure amount of the light beam.

In the exposure method disclosed in Japanese Unexamined Patent Publication No. 2000-206571, halftone exposure is adopted. Therefore, when a single exposure operation is performed, it is possible to achieve a process corresponding to a plurality of exposure operations performed using an ordinary mask. Hence, in this method, the number of steps in the photolitho process can be reduced.

However, in this method, a special mask which has slit-shaped opening patterns, of which the interval is very narrow, is needed to achieve halftone exposure. It is necessary that the accuracy of such a kind of mask is at least twice that of an ordinary mask in which halftone exposure is not performed. The pattern accuracy of the ordinary mask is approximately ±0.5 μm. However, since a highly precise mask is extremely expensive, the cost for performing the exposure method using the highly precise mask inevitably becomes high.

The problem, as described above, is also recognized in the method disclosed in Japanese Unexamined Patent Publication No. 2002-350897, in which a plurality of structural members, of which the thicknesses are different from each other, is formed by adopting halftone exposure in a manner similar to the method as described above.

Meanwhile, in the method disclosed in “High Transmissive Advanced TFT-LCD Technology”, Koichi Fujimori et al., Sharp Technical Report, No. 85, pp. 34-37, April 2003, after a certain member is formed on a base material by performing a photolitho process, a very fine even pattern is formed on the surface of the member. In this method, since the structure becomes complex, there is a problem that the production cost becomes high.

Further, in the method disclosed in Japanese Unexamined Patent Publication No. 2004-062157, a photosensitive material is exposed to light at multiple exposure amounts in a single sub-scan operation (single vertical scan operation). In this method, it is necessary to control an output from a light source so that the maximum exposure power for an object to be exposed can be output to achieve multiple-level exposure gradation. However, in some cases, the maximum output is required only by a small portion of an image, namely a few percent of the whole image. In that case, the exposure power may be wasted in an optical system, such as a DMD, which uses illumination light.

Further, it is necessary to assign data having gradation to each exposure point to achieve multiple-level exposure gradation in a single sub-scan operation. Therefore, the data processing amount increases several times, and there is a problem that it is difficult to maintain the processing speed.

### DISCLOSURE OF INVENTION

In view of the foregoing circumstances, it is an object of the present invention to provide an exposure method in which halftone exposure (intermediate exposure) of a photosensitive material, such as a photoresist, can be achieved at a low cost. It is also an object of the present invention to provide an exposure apparatus in which the exposure method is performed.

An exposure method according to the present invention is an exposure method for exposing a photosensitive material to light in a predetermined pattern by illuminating the photosensitive material with exposure light emitted by an exposure head which emits light modulated by a spatial light modulation device, wherein an area extending in a predetermined direction on the photosensitive material is illuminated with the exposure light which is emitted from the exposure head, and wherein while the area is illuminated, the exposure head and the photosensitive material are moved relative to each other in a direction substantially perpendicular to the predetermined direction at least twice for each photosensitive material, and wherein the operation of the spatial light modulation device is controlled in each of the relative movements so as to enable formation of exposed areas, of which the exposure light amounts are at least at two different levels, on the photosensitive material.

Further, in the exposure method according to the present invention, it is preferable that a two-dimensional spatial light modulation device having a plurality of two-dimensionally arranged pixels is used as the spatial light modulation device, and that a portion of the photosensitive material is illuminated with light from a plurality of pixels consecutively aligned in a sub-scan direction so that the same portion is illuminated more than once.

Further, it is preferable that a DMD (digital micromirror device) is used as the spatial light modulation device.

Further, in the exposure method according to the present invention, it is preferable that the photosensitive material, which is an object to be exposed, is a photoresist formed on a base material or a structural member material formed on the base material so as to process the base material or the structural member material.

As the photoresist, as described above, a photoresist which has a two-layer structure including a layer which is formed on the base material, and which has a relatively high sensitivity, and a layer which is formed on the relatively high sensitivity layer, and which has a relatively low sensitivity, may be preferably used.

Further, when the photoresist as described above is used as an object to be exposed, it is possible to form at least two structural members by removing the photoresist stepwise from portions, of which the exposure light amounts are different from each other.

Further, if the base material is an LCD-TFT (Liquid Crystal Display—Thin Film Transistor) panel, the structural member material may be a material for forming a TFT (Thin Film Transistor) circuit.

Further, if the base material is a conductive film, a photosensitive material which has a two-layer structure including a layer which is formed on the base material, and which has a relatively high sensitivity, and a layer which is formed on the relatively high sensitivity layer, and which has a relatively low sensitivity, can be preferably used.

Further, in the exposure method according to the present invention, the photosensitive material, which is an object to be exposed, may be a kind of structural member material which remains on the base material and the remained material may include portions, of which the thicknesses are at least at two different levels.

Particularly, it is preferable that the base material is an LCD-TFT panel, and that the structural member material is a material for a reflective member which is formed on the LCD-TFT panel, and which has an uneven pattern on its surface.

Further, in the exposure method according to the present invention, the photosensitive material, which is an object to be exposed, may be at least two kinds of structural member material which remain on the base material.

It is preferable that such a structural member material has at least two layers, wherein the two layers are a layer which is formed on the base material, and which has a relatively high sensitivity, and a layer which is formed on the relatively high sensitivity layer, and which has a relatively low sensitivity. Particularly, the base material is, for example, an LCD-CF (Liquid Crystal Display—Color Filter) panel. When the base material is the LCD-CF, the structural member material may be at least a material for a rib member and a material for a post member.

Further, when the base material is an LCD-CF (Liquid Crystal Display—Color Filter) panel, the structural member material may be at least a material for an RGB (Red, Green and Blue) member for transmission and a material for an RGB member for reflection.

Meanwhile, a first exposure apparatus according to the present invention is an exposure apparatus for exposing a photosensitive material to light in a predetermined pattern by illuminating the photosensitive material with exposure light modulated by a spatial light modulation device, the apparatus comprising;

an exposure head for illuminating an area extending in a predetermined direction on the photosensitive material with the modulated exposure light;

a sub-scan means for moving the exposure head and the photosensitive material relative to each other in a direction substantially perpendicular to the predetermined direction at least twice for each photosensitive material; and

an exposure amount control means for controlling the operation of the spatial light modulation device in each of the relative movements, wherein exposed areas, of which the exposure light amounts are at least at two different levels, can be formed on the photosensitive material.

It is preferable that the spatial light modulation device is a two-dimensional spatial light modulation device having a plurality of two-dimensionally arranged pixels.

Particularly, a DMD can be preferably used as the spatial light modulation device.

Further, a second exposure apparatus according to the present invention is an exposure apparatus comprising:

a data division means for dividing original data on an image to be formed on a photosensitive material into image data on a low-sensitivity portion and image data on a high-sensitivity portion;

an exposure amount operation means for performing an operation, based on the image data on the low-sensitivity portion, to obtain an exposure amount for exposing a first photosensitive layer on the photosensitive material to light and for performing an operation, based on the image data on the high-sensitivity portion, to obtain an exposure amount for exposing a second photosensitive layer on the photosensitive material to light; and

an exposure control means for controlling each of exposure of the first photosensitive layer and exposure of the second photosensitive layer, based on the operation result obtained by the exposure amount operation means, separately in a forward movement and in a backward movement when exposure heads and the photosensitive material are moved relative to each other, wherein the first photosensitive layer and the second photosensitive layer on the photosensitive material are exposed to light by forming an image on the photosensitive material by projection of a light beam from a plurality of linearly arranged exposure heads onto the photosensitive material and by moving the plurality of exposure heads and the photosensitive material, forward and backward, relative to each other in a sub-scan direction, which is substantially perpendicular to the direction in which the plurality of exposure heads is linearly arranged, wherein the photosensitive material is formed by superposing the first photosensitive layer, which has a relatively low sensitivity, and the second photosensitive layer, which has a relatively high sensitivity, one on the other on a conductive film on a surface of a support.

Further, a third exposure apparatus according to the present invention is an exposure apparatus comprising:

a data division means for dividing data on a printed circuit diagram, which is original data on an image for forming a printed circuit on a photosensitive material, into image data on a through-hole portion, which is related to the position of a through-hole penetrating the photosensitive material from one side of the photosensitive material to the other side thereof, and image data on a circuit pattern portion, which is related to a circuit pattern to be formed on the photosensitive material;

an exposure amount operation means for performing an operation, based on the image data on the through-hole portion, to obtain an exposure amount for exposing a first photosensitive layer on the photosensitive material to light and for performing an operation, based on the image data on the circuit pattern portion, to obtain an exposure amount for exposing a second photosensitive layer on the photosensitive material to light; and

an exposure control means for controlling each of exposure of the first photosensitive layer and exposure of the second photosensitive layer, based on the operation result obtained by the exposure amount operation means, separately in a forward movement and in a backward movement when exposure heads and the photosensitive material are moved relative to each other, wherein the first photosensitive layer and the second photosensitive layer on the photosensitive material are exposed to light by forming an image on the photosensitive material by projection of a light beam from a plurality of linearly arranged exposure heads onto the photosensitive material and by moving the plurality of exposure heads and the photosensitive material, forward and backward, relative to each other in a sub-scan direction, which is substantially perpendicular to the direction in which the plurality of exposure heads is linearly arranged, wherein the photosensitive material is formed by superposing the first photosensitive layer, which has a relatively low sensitivity, and the second photosensitive layer, which has a relatively high sensitivity, one on the other on a conductive film on a surface of a support.

In the second exposure apparatus and the third exposure apparatus according to the present invention, it is preferable that the light amount of the light beam emitted from the plurality of exposure heads is constant, and that the exposure control means changes the sub-scan speed, at which the plurality of exposure heads and the photosensitive material move relative to each other in the sub-scan direction, so that the sub-scan speed in the forward movement and the sub-scan speed in the backward movement are different from each other.

Alternatively, in the second exposure apparatus and the third exposure apparatus according to the present invention, it is preferable that the sub-scan speed, at which the plurality of exposure heads and the photosensitive material move relative to each other in the sub-scan direction, is constant through the forward movement and the backward movement, and that the exposure control means controls the light amount of the light beam emitted from the plurality of exposure heads so that the light amount becomes a maximum light amount during exposure of the first photosensitive layer and the light amount of the light beam becomes 1/n (n is a positive integer) of the maximum light amount during exposure of the second photosensitive layer.

Further, in the third exposure apparatus according to the present invention, it is preferable that the exposure control means moves the exposure heads and the photosensitive material relative to each other at higher speed without performing exposure in an area other than through-hole portions which are scattered on the photosensitive material during exposure based on the image data on the through-hole portion.

In the exposure method according to the present invention, the exposure head and the photosensitive material are moved relative to each other, in other words, sub-scan is performed with exposure light, at least twice for each photosensitive material. Therefore, it is possible to form an exposed area, of which the exposure light amount is at least at two different levels, on the photosensitive material. Specifically, for example, when sub-scan is performed twice, a region A of the photosensitive material may be illuminated with exposure light only in the first sub-scan operation, and a region B of the photosensitive material may be illuminated with exposure light in both of the first sub-scan operation and the second sub-scan operation. If the region A and the region B are exposed to light in such a manner, it is possible to expose the area A at a relatively small exposure amount and to expose the area B at a relatively large exposure amount.

If the operation is performed as described above, it is not necessary to use the highly precise mask, as described above, or any exposure mask at all. Therefore, it is possible to perform halftone exposure on the photosensitive material at a low cost. If exposed areas, of which the exposure amounts are different from each other, can be formed on the photosensitive material, as described above, when development process is performed later, it is possible to leave a resist or structural member, based on a pattern, of which the thickness has been controlled at multiple levels.

Further, in the exposure method according to the present invention, exposure at multiple exposure amounts is achieved by performing exposure a plurality of times. Therefore, it is possible to reduce the power of a light source and to keep the consumption amount of the power at a low level. Further, even if exposure is performed a plurality of times, it is possible to perform the plurality of exposure using the same data amount at the same calculated speed. Therefore, it is possible to design an exposure apparatus which can achieve optimum image processing performance. Further, it is possible to reduce the cost for producing the exposure apparatus.

Further, in the exposure method according to the present invention, a two-dimensional spatial light modulation device having a plurality of two-dimensionally arranged pixels may be used as the spatial light modulation device. Further, a portion of the photosensitive material may be illuminated with light from a plurality of pixels consecutively aligned in a sub-scan direction so that the same portion is illuminated more than once. If exposure is performed in such a manner, it is possible to illuminate the photosensitive material at a higher exposure amount in each single sub-scan operation. For example, a two-dimensional spatial light modulation device having two pixels which are aligned in the sub-scan direction may be used. If such a two-dimensional spatial light modulation device is used, and if it is possible to illuminate the photosensitive material at an exposure amount of Ex by each of the two pixels, the same portion of the photosensitive material can be illuminated at the exposure amount of 2Ex in a single sub-scan operation. Therefore, it is possible to illuminate the same portion of the photosensitive material at the exposure amount of 4Ex in two sub-scan operations.

If the two-dimensional spatial light modulation device as described above is used, and if the drive of the two pixels is controlled based on an exposure pattern in a single sub-scan operation, it is possible to form exposed areas at two different thickness levels by performing only a single sub-scan operation. However, in that case, the maximum exposure amount is 2Ex. Hence, the method according to the present invention is more advantageous in that a higher exposure amount can be achieved.

Further, the first exposure apparatus according to the present invention includes an exposure head for illuminating an area extending in a predetermined direction on the photosensitive material with modulated exposure light, a sub-scan means for performing a sub-scan operation with exposure light by moving the exposure head and the photosensitive material relative to each other and an exposure amount control means for controlling the operation of the spatial light modulation device in each sub-scan operation. Therefore, it is possible to carry out the low-cost halftone exposure method, as described above.

Further, in the second exposure apparatus according to the present invention, the data division means divides original data on an image to be formed on a photosensitive material into image data on a low-sensitivity portion and image data on a high-sensitivity portion. The image data on the low-sensitivity portion is data on an area in which the first photosensitive layer is exposed to light. Further, the image data on the high-sensitivity portion is data on an area in which the second photosensitive layer is exposed to light. Further, the exposure amount operation means performs an operation, based on the image data on the low-sensitivity portion, to obtain an exposure amount for exposing the first photosensitive layer, which is a low-sensitivity layer, to light. The exposure amount operation means also performs an operation, based on the image data on the high-sensitivity portion, to obtain an exposure amount for exposing the second photosensitive layer, which is a high-sensitivity layer, to light.

The exposure control means controls exposure, based on the necessary exposure amount obtained by the exposure amount operation means, separately in a forward movement and in a backward movement when an exposure head and the photosensitive material are moved relative to each other so that the low-sensitivity first photosensitive layer is exposed to light in a pattern based on the image data on the low-sensitivity portion and the high-sensitivity second photosensitive layer is exposed to light in a pattern based on the image data on the high-sensitivity portion. Specifically, when the exposure head is moved forward and backward relative to the photosensitive material, the photosensitive material is exposed to light both in a pattern based on the image data on the low-sensitivity portion and in a pattern based on the image data on the high-sensitivity portion. Here, when the first photosensitive layer is exposed to light in the pattern based on the image data on the low-sensitivity portion, the second photosensitive layer, on which the first photosensitive layer is superposed, is also exposed to light.

Since the exposure control means controls exposure separately in the forward movement and in the backward movement, as described above, it is possible to adjust an exposure amount for exposing the first photosensitive layer to light in the pattern based on the image data on the low-sensitivity portion and an exposure amount for exposing the second photosensitive layer to light in the pattern based on the image data on the high-sensitivity portion. Further, since the exposure control means separately performs an exposure operation in the forward movement and an exposure operation in the backward movement, the two exposure operations are performed at different time. Therefore, it is possible to prevent interference between the two operations, thereby performing optimum exposure processing in each of the two operations.

Further, in the third exposure apparatus according to the present invention, the data division means divides data on a printed circuit diagram, which is original data on an image for forming a printed circuit on a photosensitive material, into image data on a through-hole portion, which is related to the position of a through-hole, and image data on a circuit pattern portion, which is related to an actual circuit. Further, the exposure amount operation means performs an operation, based on the image data on the through-hole portion, to obtain a necessary exposure amount for exposing the low-sensitivity first photosensitive layer to light. The exposure amount operation means also performs an operation, based on the image data on the circuit pattern portion, to obtain a necessary exposure amount for exposing the high-sensitivity second photosensitive layer to light.

Then, the exposure control means controls each of exposure of the first photosensitive layer and exposure of the second photosensitive layer, based on the necessary exposure amounts obtained by the exposure amount operation means, separately in each of a forward movement and a backward movement when an exposure head and the photosensitive material are moved relative to each other. The exposure control means controls exposure so that the low-sensitivity first photosensitive layer is exposed to light in a pattern based on the image data on the through-hole portion and the high-sensitivity second photosensitive layer is exposed to light in a pattern based on the image data on the circuit pattern. Specifically, when the exposure head is moved forward and backward relative to the photosensitive material, the photosensitive material is exposed to light both in the pattern based on the image data on the through-hole portion and in the pattern based on the image data on the circuit pattern portion. Here, when the first photosensitive layer is exposed to light in the pattern based on the image data on the through-hole portion, the second photosensitive layer, on which the first photosensitive layer is superposed, is also exposed to light.

Since the exposure control means separately controls exposure in the forward movement and in the backward movement, as described above, it is possible to adjust exposure amounts so that the first photosensitive layer is exposed to light to form a through-hole portion and the second photosensitive layer is exposed to light to form a circuit pattern. Therefore, it is not necessary to increase or decrease the number of light sources to adjust the exposure amounts. Further, it is possible to prevent an increase in the production cost of the exposure apparatus caused by an increase in the number of light sources.

Here, a thin photosensitive layer (second photosensitive layer) should be adopted in a circuit pattern portion image area because a high resolution image is required in the circuit pattern portion image area. Further, a thick photosensitive layer (first photosensitive layer) should be adopted in a through-hole portion image area because a so-called tent characteristic (protectiveness of coating) is required in the through-hole image portion area. If such a kind of layer is adopted in each of the circuit pattern portion image area and the through-hole portion image area, it is possible to appropriately exposure each of the image areas.

As described above, in the second exposure apparatus and the third exposure apparatus according to the present invention, exposure of the photosensitive material is separately controlled in a forward movement and in a backward movement. Therefore, it is possible to increase or decrease the exposure amount for exposing the surface of the photosensitive material, which has been produced by applying a multilayered photosensitive layer, without changing the number of light sources. Further, it is also possible to expose the photosensitive material to light to form an image of a high-sensitivity portion (for example, an image of a print pattern portion, which requires high resolution) and an image of a low-sensitivity portion (for example, an image of a through-hole portion, in which protection of the inner wall and the edge thereof with copper foil is required). The second exposure apparatus and the third exposure apparatus according to the present invention can achieve such excellent advantageous effects.

Further, in the second exposure apparatus or the third exposure apparatus, the light amount of a light beam emitted from the exposure head may be constant, and the exposure control means may control exposure so that sub-scan speed (the speed of relative movement by the exposure head and the photosensitive material in the sub-scan direction) in the forward movement and the sub-scan speed in the backward movement are different from each other. Especially, if the second exposure apparatus or the third exposure apparatus is structured, as described above, even if the light amount of the light beam emitted from the exposure head is constant, it is possible to expose the second photosensitive layer to light at a lower exposure amount by increasing sub-scan speed to reduce the exposure amount. Further, it is also possible to expose the first photosensitive layer to light at a higher exposure amount by reducing the sub-scan speed to increase the exposure amount. Here, when the first photosensitive layer is exposed to light, the second photosensitive layer, on which the first photosensitive layer is superposed, is also exposed to light.

Therefore, if the sub-scan speed is changed so that the sub-scan speed in the forward movement and the sub-scan speed in the backward movement are different from each other in relative movement by the exposure head and the photosensitive material, it is possible to increase or decrease the exposure amount at the photosensitive material without increasing or decreasing the number of light sources.

Further, in the second exposure apparatus or the third exposure apparatus, sub-scan speed, at which the exposure head and the photosensitive material move relative to each other in the sub-scan direction, may be constant through the forward movement and the backward movement. Further, the exposure control means may control exposure of each of the first photosensitive layer and the second photosensitive layer so that the light amount of the light beam emitted from the exposure head becomes a maximum light amount during exposure of the first photosensitive layer and the light amount of the light beam becomes 1/n (n is a positive integer) of the maximum light amount during exposure of the second photosensitive layer. Especially, if the second exposure apparatus or the third exposure apparatus is structured, as described above, even if the sub-scan speed is constant through the forward movement and the backward movement, the exposure control means can increase the light amount of the light beam emitted from the exposure head to the maximum value so as to increase the exposure amount when the first photosensitive layer is exposed to light in a pattern based on image data. Accordingly, the low-sensitivity first photosensitive layer can be more quickly exposed to light.

Meanwhile, when the second photosensitive layer is exposed to light in a pattern based on image data, the exposure amount may be reduced, for example, by reducing the light amount of the light beam to 1/n (n is a positive integer) of the maximum light amount by a filter or the like which is set in the exposure head. Accordingly, only the second photosensitive layer is exposed to light. If the light amount of light emitted from the exposure head is reduced, it is possible to reduce the exposure amount without reducing the number of light sources.

Therefore, even if the sub-scan speed is constant through the forward movement and the backward movement in the forward/backward movement by the exposure head and the photosensitive material, it is possible to increase or reduce the exposure amount in exposure of the photosensitive material. The exposure amount can be increased or reduced by increasing or reducing the light amount of the light beam without changing the number of the light sources.

Further, in the third exposure apparatus, the exposure control means may move the exposure head and the photosensitive material relative to each other at higher speed without performing exposure in an area other than through-hole portions which are scattered on the photosensitive material during exposure based on the image data on the through-hole portion. The through-hole portions are scattered at arbitrary positions of the photosensitive material, and only the positions of the scattered through-hole portions are exposed to light in exposure processing based on the image data on the through-hole portion. Therefore, it is not necessary to expose the area other than through-holes to light. Hence, the sub-scan speed is increased in the area other than the through-holes. Since the sub-scan speed is increased, as described above, it is possible to reduce the total processing time for exposing the photosensitive material based on the whole image data on the through-hole portion. Further, it is possible to improve the productivity.

Next, the photosensitive material (multilayer photosensitive material and printed circuit board (photosensitive material)) which is adopted in the present invention will be described. [Multilayer Photosensitive Material (DFR (dry film resist))]

A multilayer photosensitive material (DFR) adopted in the present invention includes at least two layers of photosensitive resin composition consisting essentially of a binder polymer, a monomer having an ethylenically unsaturated bond and a photopolymerization initiator. In the multilayer photosensitive material, a first photosensitive layer and a second photosensitive layer are superposed one on the other and arranged in this order. The first photosensitive layer is a layer of which the sensitivity is relatively low, and the second photosensitive layer is a layer, of which the sensitivity is relatively high. Hereinafter, the multilayer photosensitive material is referred to as a dry film photoresist (DFR). The composition condition of the DFR will be listed below.

(1) The thickness of the first photosensitive layer (low-sensitivity layer) is less than or equal to 50 μm. The thickness of the second photosensitive layer (high-sensitivity layer) is within the range of 1 μm to 10 μm (please refer to FIG. 36, which will be described later). The first photosensitive layer is thicker than the second photosensitive layer.

(2) The ratio A/B between a necessary light amount A for curing the second photosensitive layer and a necessary light amount B for curing the first photosensitive layer is within the range of 0.01 to 0.5 (please refer to FIG. 36, which will be described later).

(3) The difference (C-A) between the necessary light amount A for curing the second photosensitive layer and a necessary light amount C for initiating cure of the first photosensitive layer is less than ten times of the necessary light amount A for curing the second photosensitive layer.

(4) The difference (C-A) between the necessary light amount A for curing the second photosensitive layer and the necessary light amount C for initiating cure of the first photosensitive layer is less than or equal to 100 mJ/cm².

(5) Each of the first photosensitive layer and the second photosensitive layer consists essentially of the same binder polymer, the same monomer having an ethylenically unsaturated bond and the same photopolymerization initiator. The amount of the photopolymerization initiator contained in the second photosensitive layer is greater than that of the photopolymerization initiator contained in the first photosensitive layer.

(6) The second photosensitive layer further includes a sensitizer.

As described above, the DFR can be produced by forming the first photosensitive layer and the second photosensitive layer so that a photopolymerization initiator content of the second photosensitive layer is higher than that of the first photosensitive layer, for example. Alternatively, the DFR can be produced by adding a sensitizer to the second photosensitive layer.

It is preferable that the binder polymer which is used in the DFR is soluble in an alkaline aqueous solution. Alternatively, it is preferable that the binder polymer is a copolymer which at least swells by contact with an alkaline aqueous solution.

A preferred example of the monomer having an ethylenically unsaturated bond is a compound having at least two ethylenically unsaturated double bonds (hereinafter, referred to as a polyfunctional monomer). An example of the polyfunctional monomer is a compound disclosed in Japanese Patent Publication No. 36 (1961)-005093, Japanese Patent Publication No. 35 (1960)-014719, Japanese Patent Publication No. 44 (1969)-028727 or the like.

As examples of the photopolymerization initiator, there are an aromatic ketone, a vicinal polyketaldonyl compound disclosed in U.S. Pat. No. 2,367,660, an acyloin ether compound disclosed in U.S. Pat. No. 2,448,828, an aromatic acyloin compound substituted by α-hydrocarbon, disclosed in U.S. Pat. No. 2,722,512, a polynuclear quinone compound disclosed in U.S. Pat. No. 3,046,127 and U.S. Pat. No. 2,951,758, a combination of a triarylimidazol dimer and a p-aminoketone disclosed in U.S. Pat. No. 3,549,367, a benzothiazole compound and a trihalomethyl-s-triazine compound disclosed in Japanese Patent Publication No. 51 (1976)-048516, a trihalomethyl-s-triazine compound disclosed in U.S. Pat. No. 4,239,850, a trihalomethyl-oxadiazole compound disclosed in U.S. Pat. No. 4,212,976, or the like.

In the DFR which is adopted in the present invention, a sensitizer may be added to a photosensitive layer or photosensitive layers. Generally, the sensitizer is added only to the second photosensitive layer. The DFR may include a leuco dye or pigment for photosensitive layers. Dye may be used in the DFR to color the photosensitive layers or to enhance storage stability.

Further, a so-called close-contact accelerator may be used in the photosensitive layer or layers to improve the degree of close-contact between the first photosensitive layer and the second photosensitive layer of the DFR. Alternatively, the close-contact accelerator may be used to improve the degree of close-contact between the second photosensitive layer of the DFR and a base board (substrate) for forming a printed circuit board. A well-known close-contact accelerator may be used.

As a material for a support member, various kinds of plastic film, such as polyethylene terephthalate, polyethylene naphthalate, polypropylene, polyethylene, cellulose triacetate, cellulose diacetate, poly(metha)acrylic alkyl ester, poly(metha)acrylic ester copolymer, polyvinyl chloride, polyvinyl alcohol, polycarbonate, polystyrene, cellophane, polyvinylidene chloride copolymer, polyamide, polyimide, vinyl chloride, vinyl acetate copolymer, polytetrafluoroethylene and polytrifluoroethylene, may be used. Further, a composite material including at least two kinds of these materials may be used.

In the DFR, a protective film may be further provided on the second photosensitive material. As the protective film, the plastic film used as the support member may be used. Alternatively, paper, paper laminated with polyethylene or polypropylene or the like may be used as the protective film. Particularly, it is preferable that the protective film is a polyethylene film or a polypropylene film.

### [Principle of Method for Producing Printed Circuit Board Including DFR Layer

The principle of a method for producing printed circuit boards including DFR layers will be described.

A laminated body in which a copper-clad laminate plate, a second photosensitive layer, a first photosensitive layer and a polyethylene terephthalate film are superposed one on another in this order is produced. The laminated body is produced by superposing the second photosensitive layer of the DFR, from which the polyethylen film has been removed, on the copper-clad laminate plate which has a through-hole with a diameter of 3 mm and by attaching them together by applying pressure thereto by a heat roll laminator so that no air bubbles are trapped there between. A copper plate layer is provided on the surface of the inner wall of the through-hole, and the surface of the copper-clad laminate plate is covered with a dry copper layer, of which the surface has been ground.

Then, a circuit pattern formation area of the copper-clad laminate plate is exposed to light by an exposure apparatus which has a blue laser light source which emits light with a wavelength of 405 nm from a position above the polyethylene terephthalate film of the laminated body. The circuit pattern formation area is illuminated with light in a predetermined pattern at 4 mJ/cm². Meanwhile, the opening of the through-hole of the copper-clad laminate plate and the vicinity of thereof is illuminated with light of 40 mJ/cm² to expose the photosensitive layer to light.

After exposure is performed, the polyethylene terephthalate film is peeled off from the laminated body. Then, sodium carbonate aqueous solution in a concentration of 1 mass percent is sprayed on the surface of the second photosensitive layer to remove uncured portions of the first photosensitive layer and the second photosensitive layer by dissolving them. Accordingly, a relief formed by a cured layer is obtained.

When the pattern of the cured layer in the copper-clad laminate plate is observed, no defects, such as a peeled-off portion or a gap, are found in the cured layer on the circuit pattern formation area and the cured layer on the opening of the through-hole. Further, the thickness of the cured layer is measured. The thickness of the cured layer on the circuit pattern formation area is 5 μm and the thickness of the cured layer on the opening of the through-hole is 30 μm.

Next, ferrous chloride etchant (etching solution containing ferrous chloride) is applied to a surface of the copper-clad laminate plate by spraying. Accordingly, a copper layer in an exposed area, which is not covered with a cured layer, is removed by dissolving it. Then, the relief formed by the cured layer is removed by spraying sodium hydroxide aqueous solution in a concentration of a second mass percent. Accordingly, a printed circuit board which has a through-hole, and which has a copper layer in a circuit pattern on the surface thereof is obtained. When the through-hole of the obtained printed circuit board is visually observed, no abnormalities are identified.

### BRIEF DESCRIPTION OF DRAWINGS

FIG. 1 is a perspective external view illustrating an exposure apparatus according to an embodiment of the present invention;

FIG. 2 is a perspective view illustrating the configuration of a scanner in the exposure apparatus illustrated in FIG. 1;

FIG. 3A is a plan view illustrating exposed areas formed on a photoresist;

FIG. 3B is a diagram illustrating the arrangement of exposed areas formed by respective exposure heads;

FIG. 4 is a schematic perspective view illustrating the configuration of an exposure head in the exposure apparatus illustrated in FIG. 1;

FIG. 5 is a sectional view of the exposure head:

FIG. 6 is a partially enlarged view illustrating the configuration of a digital micromirror device (DMD);

FIG. 7A is a diagram for explaining the operation of the DMD;

FIG. 7B is a diagram for explaining the operation of the DMD;

FIG. 8A is a schematic diagram for comparing the arrangement of exposure beams and scan lines when a DMD is not tilted and the arrangement when the DMD is tilted;

FIG. 8B is a schematic diagram for comparing the arrangement of exposure beams and scan lines when a DMD is not tilted and the arrangement when the DMD is tilted;

FIG. 8C is an explanatory diagram illustrating overlaps among exposure beam spots;

FIG. 9A is a perspective view illustrating the configuration of a fiber array light source;

FIG. 9B is a front view illustrating the arrangement of light emission points in a laser emission portion of the fiber array light source;

FIG. 10 is a diagram illustrating the structure of a multi-mode optical fiber;

FIG. 11 is a plan view illustrating the structure of a multiplex laser light source;

FIG. 12 is a plan view illustrating the structure of a laser module;

FIG. 13 is a side view illustrating the structure of the laser module illustrated in FIG. 12;

FIG. 14 is a partial front view illustrating the structure of the laser module illustrated in FIG. 12;

FIG. 15 is a block diagram illustrating the electrical configuration of the exposure apparatus;

FIG. 16A is a diagram illustrating an example of a used area of a DMD;

FIG. 16B is a diagram illustrating an example of a used area of a DMD;

FIG. 17 is a block diagram illustrating an example of the configuration of an exposure apparatus for performing exposure processing in parallel on a plurality of divided areas of a photosensitive material;

FIG. 18 is a flow chart of exposure processing performed by the exposure apparatus configured, as illustrated in FIG. 17;

FIG. 19 is a schematic diagram illustrating a sectional side view of an example of an LCD-TFT panel in which an exposure method according to the present invention is adopted;

FIG. 20A is a flow chart for comparing the exposure method according to the present invention and a conventional exposure method;

FIG. 20B is a flow chart for comparing the exposure method according to the present invention and a conventional exposure method;

FIG. 21 is a schematic diagram illustrating a sectional side view of a part of an LCD-CF panel in which the exposure method according to the present invention is adopted;

FIG. 22 is a schematic diagram illustrating a sectional side view of another part of the LCD-CF panel in which the exposure method according to the present invention is adopted;

FIG. 23A is a schematic diagram illustrating the step of producing an active matrix substrate in which the exposure method according to the present invention is adopted;

FIG. 23B is a schematic diagram illustrating the step of producing an active matrix substrate in which the exposure method according to the present invention is adopted;

FIG. 23C is a schematic diagram illustrating the step of producing the active matrix substrate in which the exposure method according to the present invention is adopted;

FIG. 24D is a schematic diagram illustrating the step of producing the active matrix substrate;

FIG. 24E is a schematic diagram illustrating the step of producing the active matrix substrate;

FIG. 24F is a schematic diagram illustrating the step of producing the active matrix substrate;

FIG. 25G is a schematic diagram illustrating the step of producing the active matrix substrate;

FIG. 25H is a schematic diagram illustrating the step of producing the active matrix substrate;

FIG. 25I is a schematic diagram illustrating the step of producing the active matrix substrate;

FIG. 26J is a schematic diagram illustrating the step of producing the active matrix substrate;

FIG. 26K is a schematic diagram illustrating the step of producing the active matrix substrate;

FIG. 26L is a schematic diagram illustrating the step of producing the active matrix substrate;

FIG. 27M is a schematic diagram illustrating the step of producing the active matrix substrate;

FIG. 27N is a schematic diagram illustrating the step of producing the active matrix substrate;

FIG. 27O is a schematic diagram illustrating the step of producing the active matrix substrate;

FIG. 28P is a schematic diagram illustrating the step of producing the active matrix substrate;

FIG. 28Q is a schematic diagram illustrating the step of producing the active matrix substrate;

FIG. 28R is a schematic diagram illustrating the step of producing the active matrix substrate;

FIG. 29S is a schematic diagram illustrating the step of producing the active matrix substrate;

FIG. 30 is a schematic diagram illustrating a perspective view of an image exposure apparatus according another embodiment of the present invention;

FIG. 31 is a schematic diagram illustrating a side view of the image exposure apparatus illustrated in FIG. 30;

FIG. 32A is a plan view illustrating areas exposed by an exposure head unit of the image exposure apparatus illustrated in FIG. 30;

FIG. 32B is a plan view illustrating the arrangement pattern of head assemblies;

FIG. 33 is a plan view illustrating the arrangement of dot patterns in a single head assembly;

FIG. 34 is a plan view illustrating a part of a printed circuit board adopted as a photosensitive material in the image exposure apparatus illustrated in FIG. 30;

FIG. 35A is a schematic diagram illustrating the sectional shape of a portion along the line IV-VI in FIG. 34 in production of a printed circuit board from an original substrate through each of exposure, development and etching processes;

FIG. 35B is a schematic diagram illustrating the sectional shape of a portion along the line IV-VI in FIG. 34 in production of a printed circuit board from an original substrate through each of exposure, development and etching processes;

FIG. 35C is a schematic diagram illustrating the sectional shape of a portion along the line IV-VI in FIG. 34 in production of a printed circuit board from an original substrate through each of exposure, development and etching processes;

FIG. 35D is a schematic diagram illustrating the sectional shape of a portion along the line IV-VI in FIG. 34 in production of a printed circuit board from an original substrate through each of exposure, development and etching processes;

FIG. 35E is a schematic diagram illustrating the sectional shape of a portion along the line IV-VI in FIG. 34 in production of a printed circuit board from an original substrate through each of exposure, development and etching processes;

FIG. 35F is a schematic diagram illustrating the sectional shape of a portion along the line IV-VI in FIG. 34 in production of a printed circuit board from an original substrate through each of exposure, development and etching processes;

FIG. 35G is a schematic diagram illustrating the sectional shape of a portion along the line IV-VI in FIG. 34 in production of a printed circuit board from an original substrate through each of exposure, development and etching processes;

FIG. 36 is a characteristic diagram illustrating a relationship between an exposure amount and sensitivity;

FIG. 37 is a block diagram illustrating a control operation for changing an exposure amount so as to perform exposure at different exposure amounts between a forward movement and a backward movement in a forward/backward movement of an exposure stage in the image exposure apparatus illustrated in FIG. 30;

FIG. 38A is an explanatory diagram illustrating the movement of the exposure stage in the image exposure apparatus illustrated in FIG. 30 when exposure processing is performed in a forward movement and in a backward movement;

FIG. 38B is an explanatory diagram illustrating the movement of the exposure stage in the image exposure apparatus illustrated in FIG. 30 when exposure processing is performed in a forward movement and in a backward movement;

FIG. 39 is a diagram illustrating the waveform of a signal generated by a means for detecting the movement of the exposure stage in the image exposure apparatus illustrated in FIG. 30;

FIG. 40 is a flow chart illustrating a process of dividing image data, a process of processing the divided data and a process of controlling exposure in a forward movement and in a backward movement;

FIG. 41A is an explanatory diagram illustrating the movement of the exposure stage and processing for controlling a light amount when the exposure amount is changed between exposure processing in forward movement and exposure processing in backward movement;

FIG. 41B is an explanatory diagram illustrating the movement of the exposure state and processing for controlling a light amount when the exposure amount is changed between exposure processing in forward movement and exposure processing in backward movement;

FIG. 42 is a diagram illustrating block areas in a DMD;

FIG. 43 is a schematic diagram illustrating the configuration of a control signal transfer unit for each of block areas in the DMD;

FIG. 44A is a diagram illustrating timing of transfer and modulation of a control signal in each of the block areas in the DMD;

FIG. 44B is a diagram illustrating drawn points when an image has been drawn at the timing illustrated in FIG. 44A;

FIG. 45 is a diagram illustrating another example of timing of transfer and modulation of a control signal in each of the block areas in the DMD;

FIG. 46A is a diagram illustrating timing of transfer and modulation of a control signal in each of divided area in each of the block areas of the DMD;

FIG. 46B is a diagram illustrating an example of drawn points when an image is drawn at the timing illustrated in FIG. 46A;

FIG. 47 is a diagram illustrating timing of transfer and modulation of a control signal in each of divided area in each of the block areas of the DMD;

FIG. 48A is a diagram illustrating timing of transfer and modulation of a control signal in an exposure apparatus according to the related art;

FIG. 48B is a diagram illustrating an example of drawn points when an image is drawn at the timing illustrated in FIG. 48A; and

FIG. 49 is an explanatory diagram illustrating an example of required time for each processing in the exposure apparatus according to the present invention.

### BEST MODE FOR CARRYING OUT THE INVENTION

Hereinafter, an embodiment of the present invention will be described with reference to the attached drawings.

### [Structure of Exposure Apparatus]

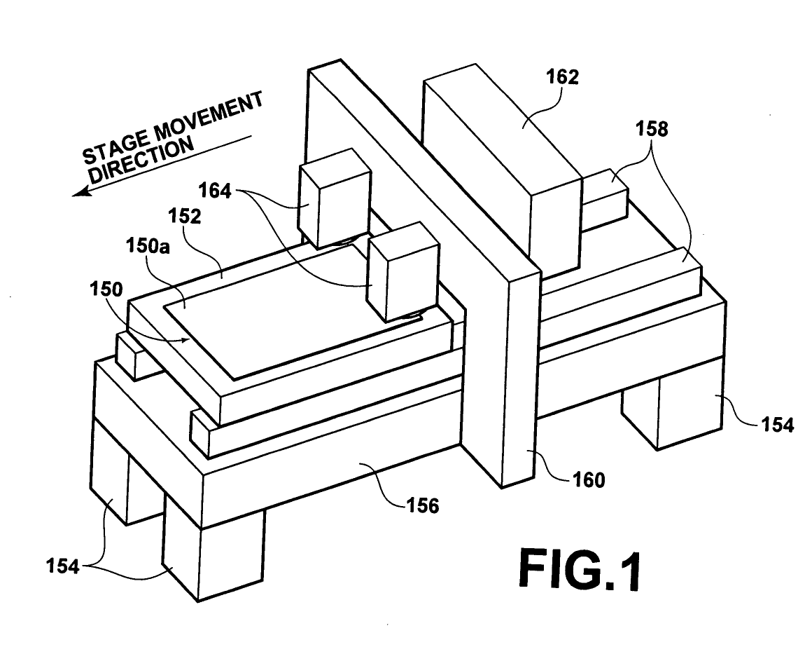

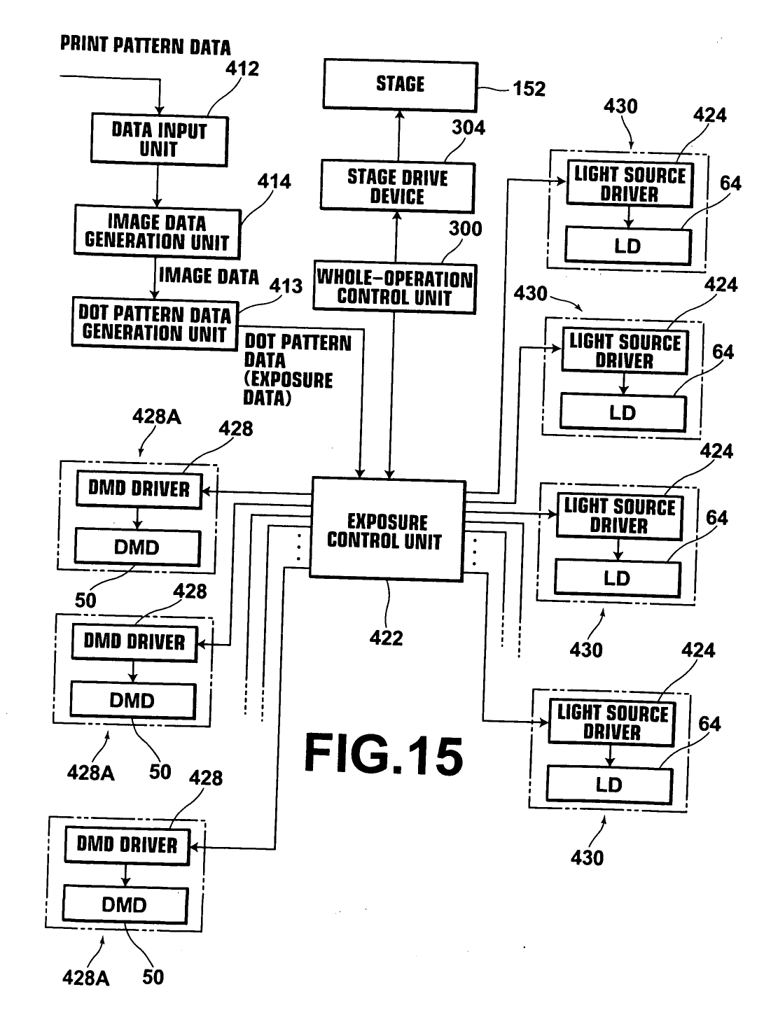

As illustrated in FIG. 1, an exposure apparatus according to the present invention includes a flat-plate-shaped moving stage 152 which holds a glass substrate 150 on the surface thereof by suction. A thin coating of photoresist 150a has been applied to the surface of the glass plate 150. Further, two guides 158 extending along the movement direction of the stage 152 are provided on the upper surface of a base 156. The base 156 has a shape of a thick flat plate and it is supported by four legs 154a. The stage 152 is placed in a manner that the longitudinal direction thereof is arranged in the movement direction of the stage 152, and the stage 152 is supported by the guides 158 in a manner that allows forward and backward movement of the stage 152. Further, a stage drive device 304 (please refer to FIG. 15), which will be described later, is provided in the exposure apparatus so as to drive the stage 152, as a sub-scan means, along the guides 158.

A C-shaped gate 160 straddling the movement path of the stage 152 is provided at the center of the base 156. Each end of the C-shaped gate 160 is secured to either side of the base 156. A scanner 162 is provided on one side of the gate 160 and a plurality of sensors 164 (for example, two sensors) is provided on the other side of the gate 160. The plurality of sensors 164 detects the leading edge and the rear edge of the glass substrate 150 and a pattern on the substrate. Each of the scanner 162 and the sensors 164 is attached to the gate 160. The scanner 162 and the sensors 164 are arranged at fixed positions above the movement path of the stage 152. The scanner 162 and the sensors 164 are connected to a controller or controllers (not illustrated) for controlling them.

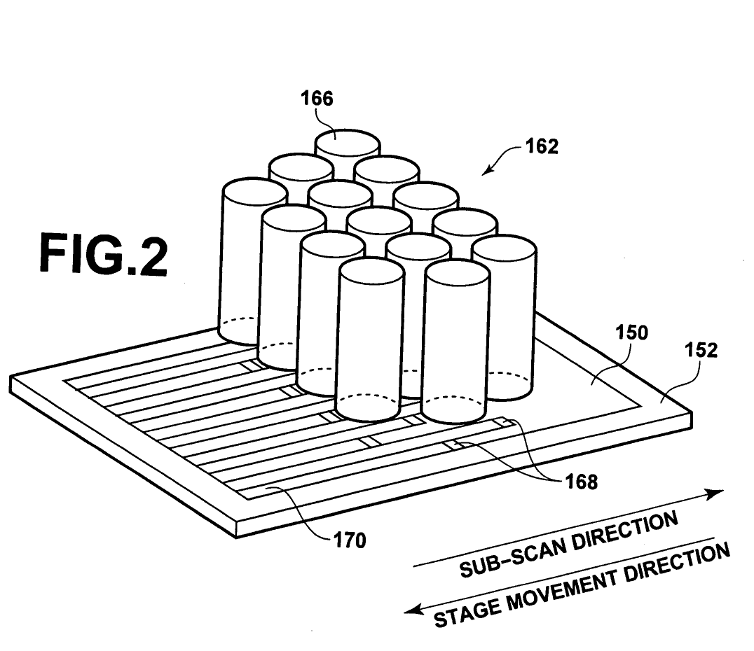

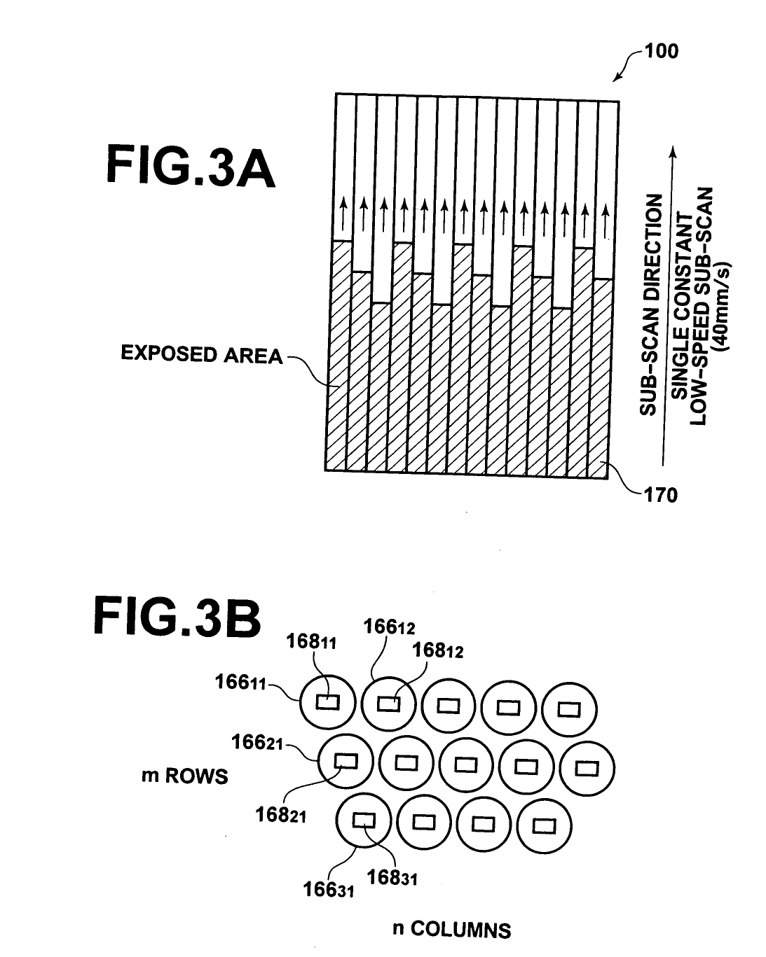

The scanner 162 includes a plurality of exposure heads 166 (for example, 14 exposure heads) which are arranged substantially in a matrix including m rows×n columns (for example, 3 rows×5 columns), as illustrated in FIGS. 2 and 3B. In this example, four exposure heads 166 are arranged on the third row due to the width of the glass substrate 150. In this specification, an exposure head arranged in the m-th row of the n-th column is represented by an exposure head 166ₘₙ.

The shape of each of areas 168 exposed by the exposure heads 166 is a rectangular shape with its short side placed in a sub-scan direction. Therefore, as the stage 152 moves, a band shaped exposed area 170 is formed on the photoresist 150a on the glass substrate 150 by each of the exposure heads 166. In this specification, an exposed area formed by an exposure head arranged in the m-th row of the n-th column is represented by an exposed area 168ₘₙ.

Further, as illustrated in FIGS. 3A and 3B, exposure heads which are linearly arranged in each of the rows are shifted from those in another row in the arrangement direction of the exposure heads by a predetermined distance (a number obtained by multiplying the longer side of an exposed area by a natural number and in this example, the distance is twice the longer side). The exposure heads are shifted so that the band-shaped exposed areas 170 are formed without a gap therebetween in a direction perpendicular to the sub-scan direction. Therefore, an unexposed area between an exposed area 168₁₁ and an exposed area 16812 in the first row can be exposed by an exposed area 16821 in the second row and an exposed area 168₃₁ in the third row.

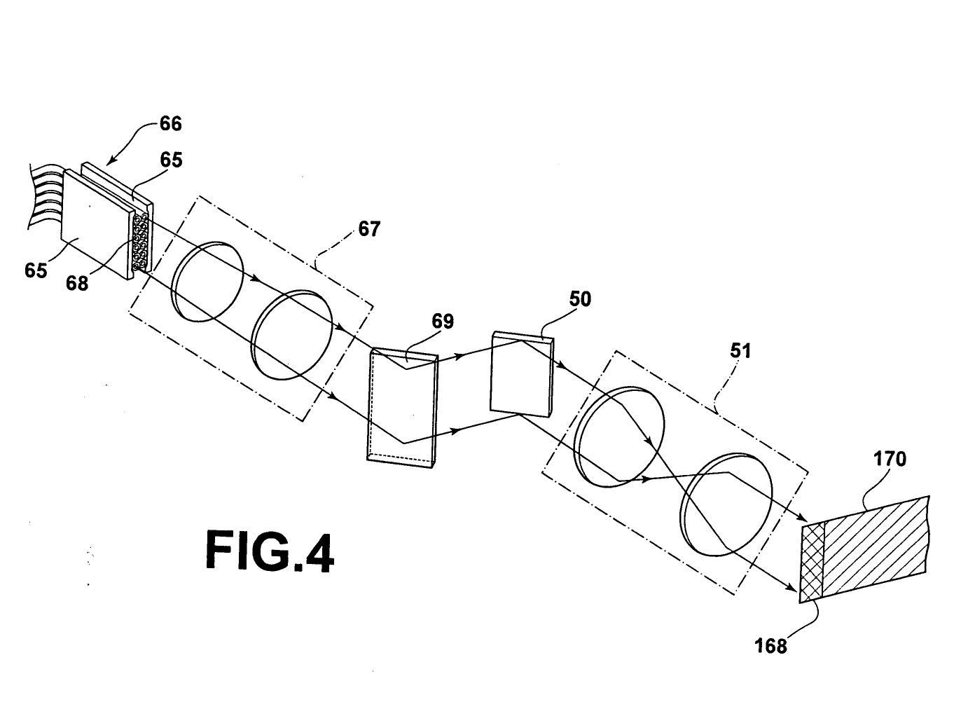

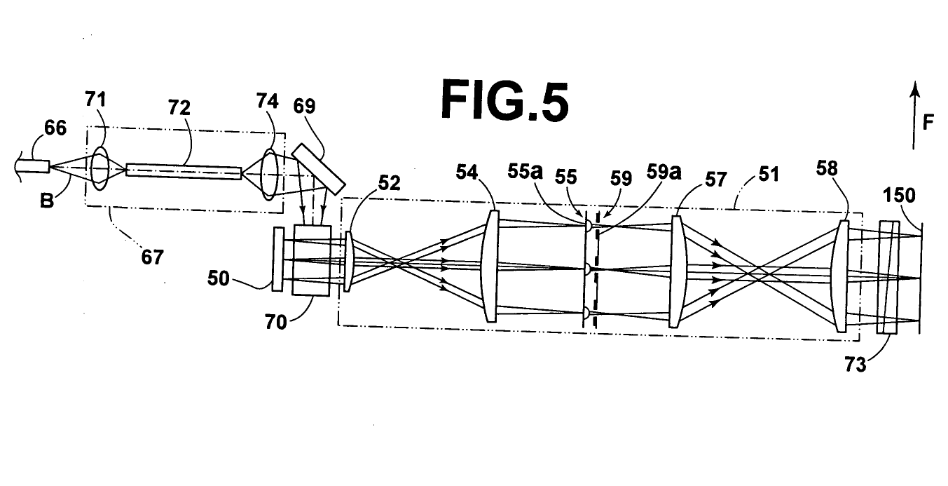

Each of the exposure heads 166₁₁ through 166ₘₙ includes a digital micromirror device (DMD) 50, manufactured by Texas Instruments Incorporated, U.S., as a spatial light modulation device. The spatial light modulation device modulates, based on image data, a light beam which is incident thereon for each pixel, as illustrated in FIGS. 4 and 5. The DMD 50 is connected to a DMD driver 428 (please refer to FIG. 15), which will be described later. The DMD driver 428 includes a data processing unit and a mirror drive control unit. The data processing unit of the DMD driver 428 generates, based on input image data, a control signal for controlling drive of each of the micromirrors in an area to be controlled in the DMD 50 for each of the exposure heads 166. The area to be controlled will be described later. Further, the mirror drive control unit controls, based on the control signal generated by the image data processing unit, the angle of the reflection plane of each of micromirrors in the DMD 50 for each of the exposure heads 166. Control of the angle of the reflection plane will be described later.

Further, a fiber array light source 66, a lens system 67 and a mirror 69 are provided in this order on the light receiving side of the DMD 50. The fiber array light source 66 includes a laser emission portion in which light emitting ends (light emission points) of optical fibers are arranged in a line along a direction corresponding to the longer side of the exposed area 168. The lens system 67 corrects laser light emitted from the fiber array light source 66 and condenses the corrected laser light onto the DMD. The mirror 69 reflects the laser light transmitted through the lens system 67 so that the laser light is transmitted toward the DMD 50. In FIG. 4, the lens system 67 is schematically illustrated.

The lens system 67 includes a condensing lens 71, a rod-shaped optical integrator (hereinafter, referred to as a rod integrator) 72 and an image formation lens 74, as illustrated in detail in FIG. 5. The condensing lens 71 condenses laser light B, as illumination light, which has been emitted from the fiber array light source 66. The rod integrator 72 is inserted in a light path of light transmitted through the condensing lens 71. The image formation lens 74 is arranged on the front side of the rod integrator 72, in other words, on a side closer to the mirror 69. The rod integrator 72 causes the laser light emitted from the fiber array light source 66 to enter the DMD 50 as a light flux which is close to parallel light, and of which the intensity in a sectional plane of a beam is evenly distributed. The shape and the action of the rod integrator 72 will be described later.

The laser light B emitted from the lens system 67 is reflected by the mirror 69. Then, the reflected light is transmitted through a TIR (total internal reflection) prism 70 and the DMD 50 is illuminated with the reflected light. In FIG. 4, the TIR prism 70 is omitted.

Further, an image formation optical system 51 is arranged on the light reflection side of the DMD 50. The image formation optical system 51 forms an image on the photoresist 150a with the laser light B reflected by the DMD 50. The image formation optical system 51 is schematically illustrated in FIG. 4, and it is illustrated in detail in FIG. 5. As illustrated in FIGS. 4 and 5, the image formation optical system 51 includes a first image formation optical system, a second image formation optical system, a microlens array 55 and a mask plate 59. The first image formation optical system includes lens systems 52 and 54, and the second image formation optical system includes lens systems 57 and 58. The micromirror lens array 55 and the mask plate 59 are inserted between the two image formation optical systems.

In the microlens array 55, a multiplicity of microlenses 55a, corresponding to respective pixels of the DMD 50, is two-dimensionally arranged. In this example, micromirrors of only 1024 pixels×256 rows are driven among the micromirrors of 1024 pixels×768 rows in the DMD 50, as will be described later. Therefore, microlenses 55a of 1024 pixels×256 rows, which correspond to the number of driven micromirrors, are arranged. The arrangement pitch of the microlenses 55a is 41 μm in both vertical and horizontal directions. The microlens 55a is a microlens of which the focal length is 0.19 mm, and of which the NA (numerical aperture) is 0.11, for example. Further, the microlens 55a is made of optical glass BF7, for example. The shape of the microlens 55a will be described later. Further, the beam diameter of the laser light B at the position of each of the microlenses 55a is 3.4 μm.

Further, in the mask plate 59, a light shield mask 59a which has an opening for each of the microlenses 55a of the microlens array 55 is formed on a transparent plate-shaped member. The mask plate 59 is placed in the vicinity of the focal position of the microlens 55a. The mask plate 59 can cut reentrant off-light from the DMD 50 and stray light between micromirrors 62.

The first image formation optical system forms an image on the microlens array 55 by magnifying an image formed by the DMD 50 three times. Then, the second image formation optical system forms and projects an image on the photoresist 150a on the glass substrate 150 by magnifying the image transmitted through the microlens array 55 1.6 times. Therefore, the image formed by the DMD 50 is magnified 4.8 times in total and the magnified image is projected onto the photoresist 150a.

In this example, a pair 73 of prisms is arranged between the second image formation optical system and the glass substrate 150. The focus of an image formed on the photoresist 150a on the glass plate 150 can be adjusted by vertically moving the pair 73 of prisms in FIG. 5. In FIG. 5, the glass substrate 150 is moved in a sub-scan direction, as indicated by arrow F.

The DMD 50 is a mirror device in which a multiplicity (for example, 1024×768) of micromirrors 62, each forming a pixel, is arranged in a grid shape on an SRAM cell (memory cell) 60. In each pixel, a rectangular micromirror 62 which is supported by a post is provided at the top. Further, a highly reflective material, such as aluminum, is vapor-deposited on the surface of the micromirror 62. The reflectance of the micromirror 62 is higher than or equal to 90%. The arrangement pitch is, for example, 13.7 μm in both of the vertical direction and the horizontal direction. Further, a CMOS (Complementary Metal Oxide Semiconductor) SRAM (static random access memory) cell 60, which is produced in a production line of ordinary semiconductor memory, is arranged below the micromirror 62 through a support post including a hinge and a yoke. The whole DMD has a monolithic structure.

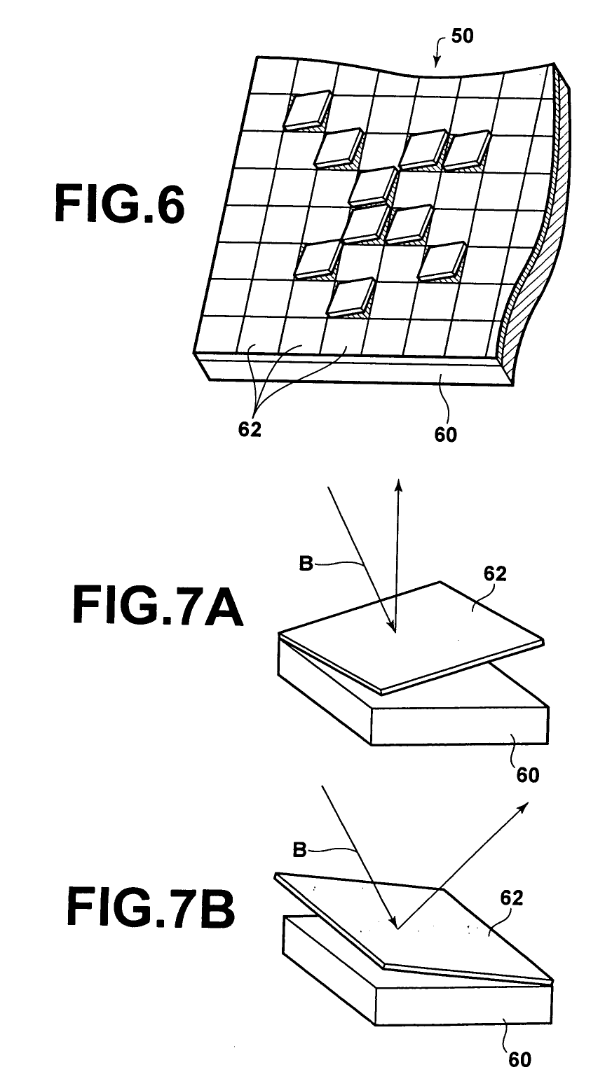

When a digital signal is written in the SRAM cell 60 of the DMD 50, micromirrors 62 supported by support posts are inclined with respect to diagonal lines thereof. The micromirrors are inclined at ±α degrees (for example ±12 degrees) with respect to the substrate on which the DMD 50 is placed. FIG. 7A illustrates an ON state of a micromirror 62, in which the micromirror 62 is inclined at +α degrees. FIG. 7B illustrates an OFF state of a micromirror 62, in which the micromirror 62 is inclined at −α degrees. The inclination angle of the micromirror 62 at each pixel of the DMD 50 is controlled based on an image signal, as illustrated in FIG. 6. Therefore, the laser light B which is incident on the DMD 50 is reflected to the inclination direction of each of the micromirrors 62.

In FIG. 6, a part of the DMD 50 is enlarged. FIG. 6 illustrates an example of the state of the micromirrors 62, which are controlled so as to incline either at +α degrees or at −α degrees. ON/OFF of each of the micromirrors 62 is controlled by a controller 302, which is connected to the DMD 50. Further, a light absorption material (not illustrated) is placed at a position in a propagating direction of the laser light B reflected by a micromirror 62 in an OFF state.

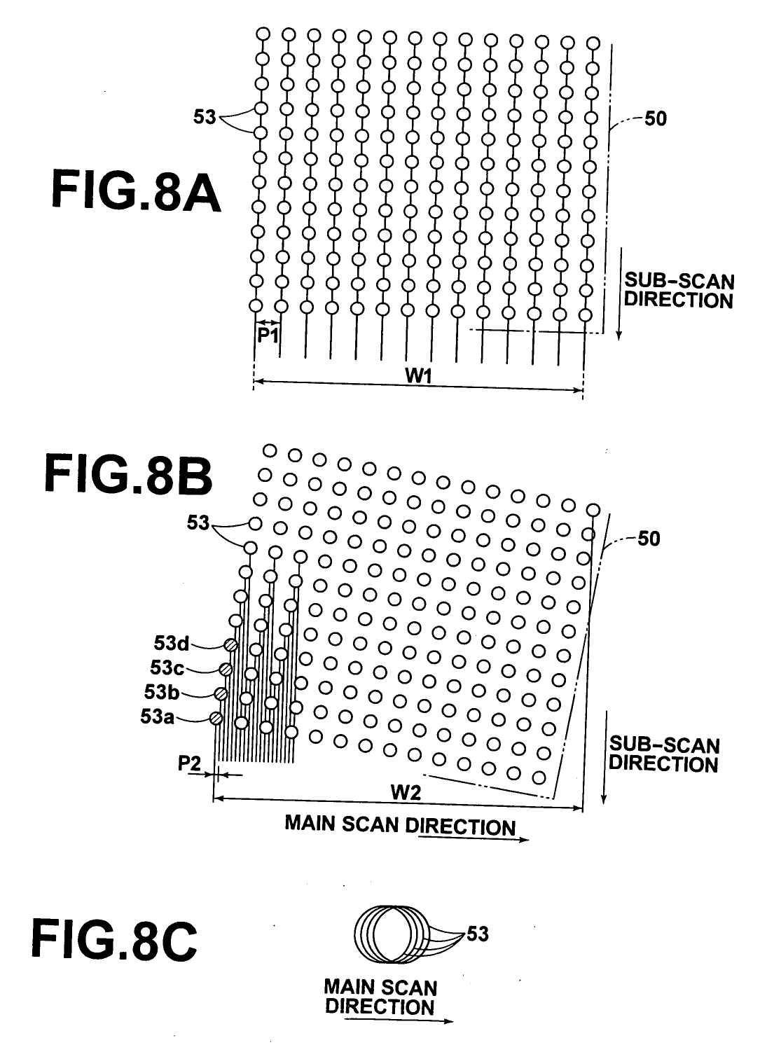

Further, it is preferable that the DMD 50 is slightly tilted so that the shorter side of the DMD 50 forms a predetermined angle α (for example, an angle within the range of 1° to 5°) with respect to the sub-scan direction. In the present embodiment, the DMD 50 is tilted at the predetermined angle. FIG. 8A illustrates a scan path of a reflected light image (exposure beam spot) 53 by each of the micromirrors when the DMD 50 is not tilted. FIG. 8B illustrates a scan path of an exposure beam spot 53 by each of the micromirrors when the DMD 50 is tilted.

In the DMD 50, a multiplicity of micromirrors (for example, 1024 micromirrors) is arranged in a longitudinal direction to form a micromirror row, and a multiplicity of micromirror rows (for example, 756 micromirror rows) is arranged in a shorter-side direction. If the DMD 50 is tilted, as illustrated in FIG. 8B, a pitch P₂ of scan paths (scan lines) with exposure beam spots 53 by the micromirrors becomes narrower than a pitch P₂ of scan paths when the DMD 50 is not tilted. Therefore, it is possible to significantly improve resolution. Meanwhile, since the tilt angle of the DMD 50 is very small, a scan width W₂ when the DMD 50 is tilted and a scan width W₁ when the DMD 50 is not tilted are substantially the same.

Further, each of the micromirrors 62 is arranged so that exposure beam spots which are adjust to each other in the sub-scan direction are shifted from each other in the main scan direction (horizontal scan direction) by a very small amount (for example, by a distance within the range of approximately 0.1 μm to 0.5 μm). Since the diameter of the exposure beam spot is within the range of approximately 5 μm to 20 μm, which is larger than the interval of arrangement of spots, the photoresist 150 is exposed (multiple exposure) in a state in which exposure beam spots formed by at least two pixels of the DMD 50 overlap with each other.

Since multiple exposure is performed, as described above, it is possible to control exposure positions so that even a very small amount is adjusted. Therefore, highly accurate exposure can be performed. Further, since exposure positions are controlled so that even a very small amount is adjusted, it is possible to evenly connect exposed areas formed by a plurality of exposure heads arranged in the main scan direction.

Alternatively, each of the micromirror rows may be shifted from each other by a predetermined interval in a direction perpendicular to the sub-scan direction so that the micromirror rows are arranged in a zigzag pattern. When the micromirror rows are arranged in such a manner, it is possible to achieve an advantageous effect similar to that achieved by using the tilted DMD 50.

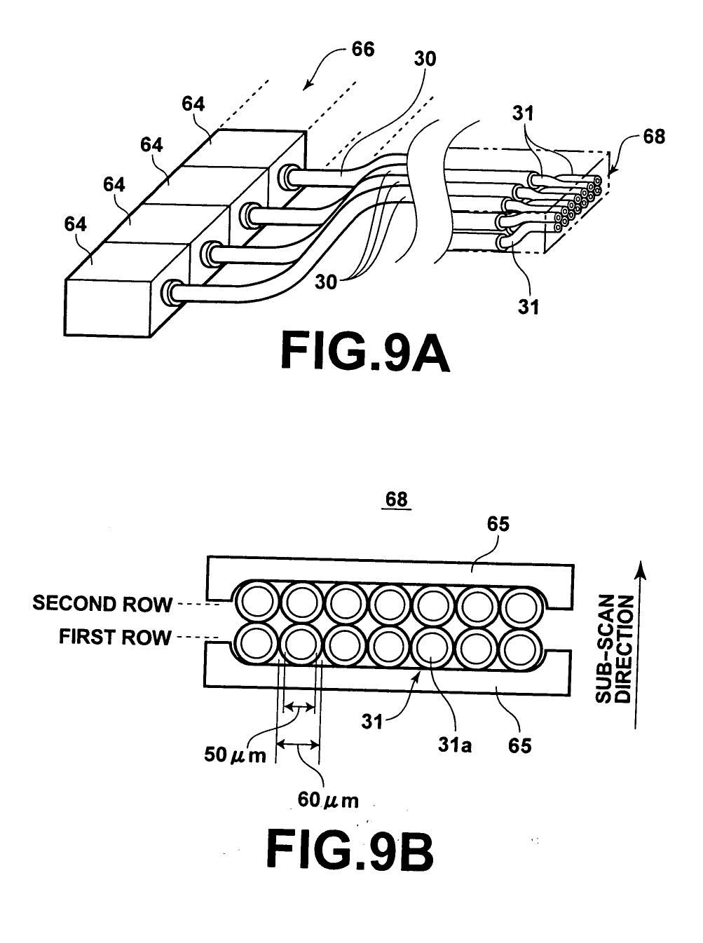

The fiber array light source 66 includes a plurality (for example, 14) of laser modules 64, as illustrated in FIG. 9A. Each of the laser modules 64 is connected to an end of a multi-mode optical fiber 30. The other end of the multi-mode optical fiber 30 is connected to an optical fiber 31, of which the core diameter is the same as that of the multi-mode optical fiber 30, and of which the cladding diameter is less than that of the multi-mode optical fiber 30. As illustrated in FIG. 9B in detail, seven ends of multi-mode optical fibers 31, which are opposite to the ends connected to the multi-mode optical fibers 30, are arranged along the main scan direction, which is perpendicular to the sub-scan direction, and two rows of the seven ends are arranged to form a laser emitting portion 68.

The laser emitting portion 68 is formed by the ends of the multi-mode optical fibers 31, and the laser emitting portion 68 is fixed by being sandwiched by two support plates 65 which have flat surfaces. Further, it is preferable that a transparent protective plate, such as glass, is provided on the surface of the light emitting end of the multi-mode optical fiber 31 to protect the light emitting end. Since the light density at the light emitting end of the multi-mode optical fiber 31 is high, dust particles may easily adhere to the light emitting end. However, if the protective plate, as described above, is provided, it is possible to prevent adhesion of the dust particles to the surface of the light emitting end. Hence, it is possible to delay deterioration of the condition of the light emitting end.

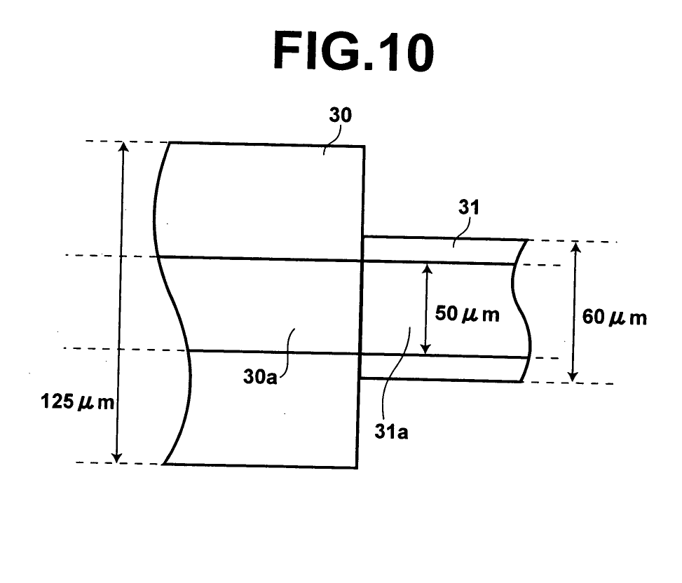

In the present embodiment, an optical fiber 31 which has a small cladding diameter, of which the length is in the range of approximately 1 cm to 30 cm, is coaxially connected to a laser-light-emitting-side end of the multi-mode optical fiber 30 which has a large cladding diameter, as illustrated in FIG. 10. The optical fibers 30 and 31 are united together by welding the light entering end of the optical fiber 31 onto the light emitting end of the optical fiber 30. As described above, the diameter of a core 31a of the optical fiber 31 is the same as that of a core 30a of the multi-mode optical fiber 30.

As the multi-mode optical fiber 30 and the optical fiber 30, any of a step-index type optical fiber, a grated-index type optical fiber and a complex type optical fiber may be used. For example, a step-index type optical fiber manufactured by Mitsubishi Cable Industries, Ltd. may be used. In this example, the multi-mode optical fiber 30 and the optical fiber 31 are step-index type optical fibers. The multi-mode optical fiber 30 has a cladding diameter=125 μm, a core diameter=50 μm, NA=0.2 and a transmittance of coating on the surface of a light entering end=99.5% or greater. The optical fiber 31 has a cladding diameter=60 μm, a core diameter=50 μm and NA=0.2.

However, it is not necessary that the cladding diameter of the optical fiber is 60 μm. The cladding diameters of most of the optical fibers which are used in conventional fiber light sources are 125 μm. However, since a focal depth increases as the cladding diameter becomes smaller, it is preferable that the cladding diameter of the multi-mode optical fiber is 80 μm or less. Particularly, it is preferable that the cladding diameter is 60 μm or less. Further, it is more preferable that the cladding diameter is 40 μm or less. Meanwhile, since it is necessary that the core diameter is at least 3 μm to 4 μm, it is preferable that the cladding diameter of the optical fiber 31 is 10 μm or greater.

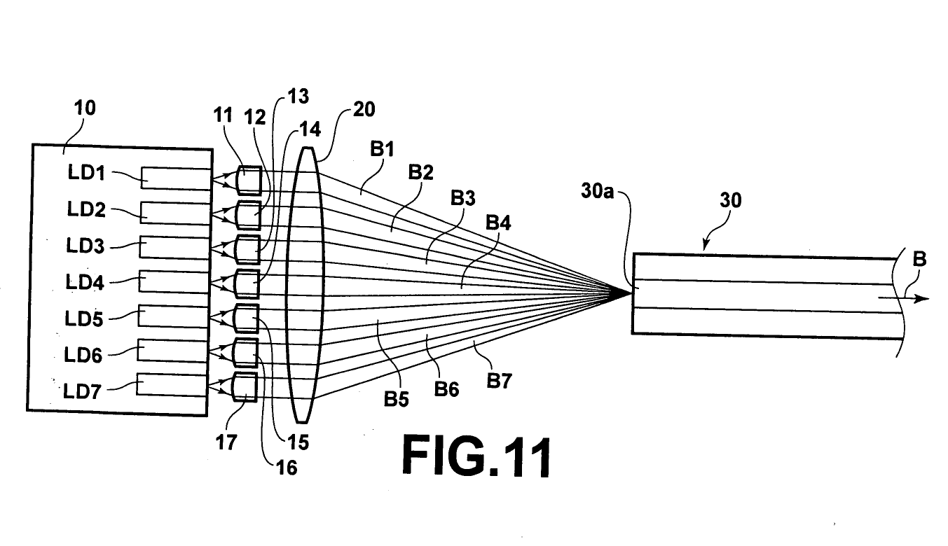

The laser module 64 is formed by a multiplex laser light source (fiber light source) illustrated in FIG. 11. The multiplex laser light source includes a plurality (for example, seven) of chip-type transverse multi-mode or single-mode GaN-based semiconductor lasers LD1, LD2, LD3, LD4, LD5, LD6 and LD7 which are arranged at fixed positions on a heat block 10. The multiplex laser light source also includes collimator lenses 11, 12, 13, 14, 15, 16 and 17 corresponding to the GaN-based semiconductor lasers LD1 through LD7. The multiplex laser light source also includes a single condensing lens 20 and a single multi-mode optical fiber 30. Here, it is not necessary that the number of the semiconductor lasers is seven, and the number of the semiconductor lasers may be a different number. Further, a collimator lens array, in which a plurality of collimator lenses is integrated, may be used instead of the seven collimator lenses 11 through 17, as described above.

The oscillation wavelength of each of the GaN-based semiconductor lasers LD1 through LD7 is the same (for example, 405 nm) Further, the maximum output from each of the GaN-based semiconductor lasers LD1 through LD7 is the same (for example, the maximum output of a multi-mode laser is approximately 100 mW, and the maximum output of a single-mode laser is approximately 50 mW). As the GaN-based semiconductor lasers LD1 through LD7, lasers which oscillate at a wavelength other than 405 nm within the wavelength range of 350 nm to 450 nm may be used.

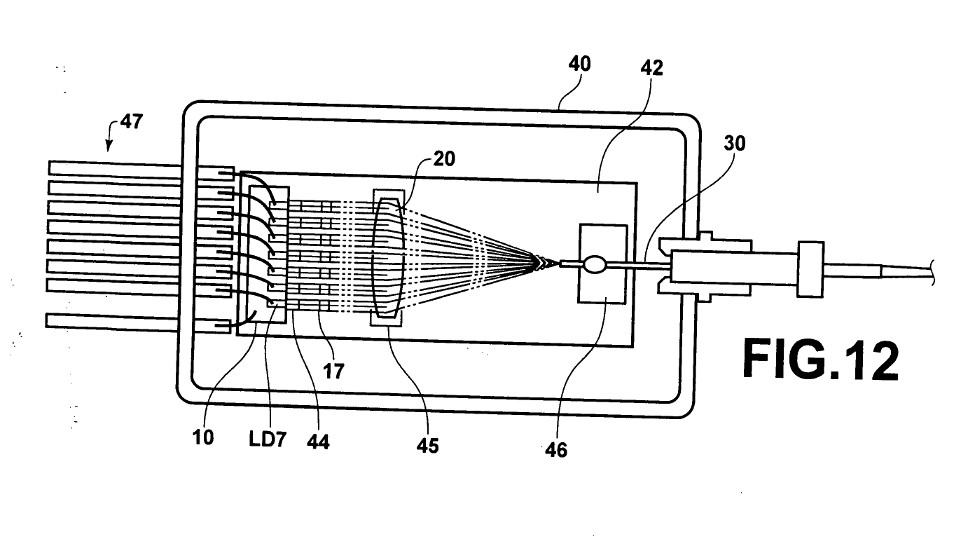

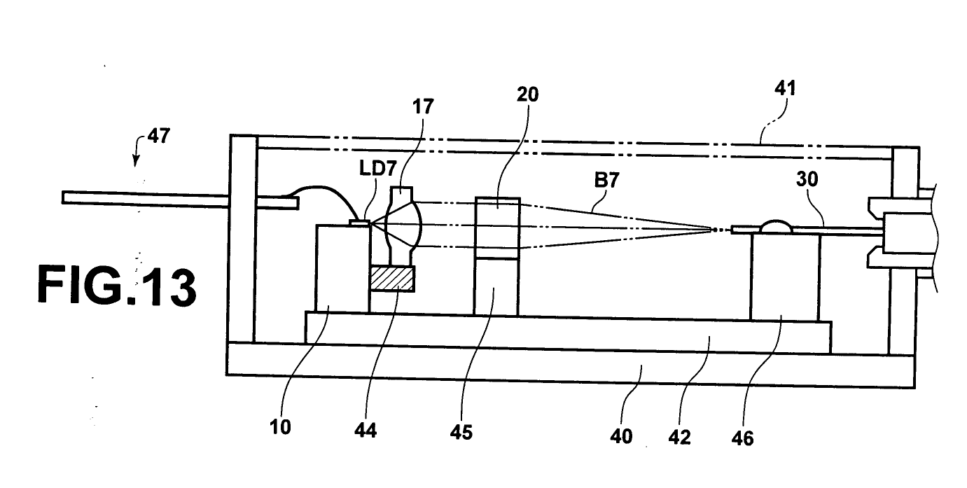

The multiplex laser light source is housed in a box type package 40 which has an opening on the top thereof, as illustrated in FIGS. 12 and 13. The multiplex laser light source is housed in the package 40 together with other optical elements. The package 40 has a package lid 41 for closing the opening. After degassing processing is performed, sealing gas is introduced into the package 40. Then, the opening of the package 40 is closedby the package lid 41. Accordingly, the multiplex laser light source is air-tightly sealed in closed space (sealed space) formed by the package 40 and the package lid 41.

A base plate 42 is secured onto the bottom of the package 40. Further, the heat block 10, a condensing lens holder 45 for holding the condensing lens 20 and a fiber holder 46 for holding the light-entering end of the multi-mode optical fiber 30 are attached to upper surface of the base plate 42. The light-emitting end of the multi-mode optical fiber 30 is drawn from the inside of the package 40 to the outside of the package through an opening formed on a wall of the package 40.

Further, a collimator lens holder 44 is attached to a side wall of the heat block 10 and each of the collimator lenses 11 through 17 is held by the collimator lens holder 44. Further, an opening is formed on the side wall of the package 40 and a wire 47 for supplying driving electric current to each of the GaN-based semiconductor lasers LD1 through LD7 is drawn from the inside of the package 40 to the outside of the package 40 through the opening.

In FIG. 13, a reference numeral is attached only to the GaN-based semiconductor laser LD7 among the plurality of GaN-based semiconductor lasers to simplify the diagram. Further, a reference numeral is attached only to the collimator lens 17 among the plurality of collimator lenses.

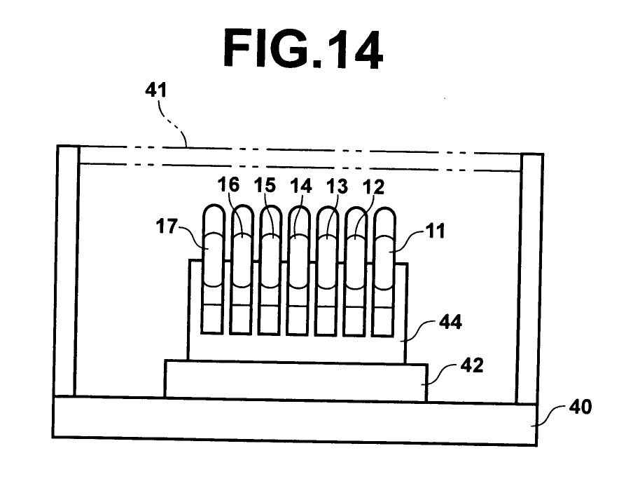

FIG. 14 is a diagram illustrating a front view of a portion at which the collimator lenses 11 through 17 are mounted. Each of the collimator lenses 11 through 17 has an elongate shape having a non-spherical surface, which is formed by cutting out a portion of a circular lens by parallel flat planes. The portion of the circular lens is a portion including an optical axis of the circular lens. The elongated collimator lens can be formed by molding resin or optical glass, for example. The collimator lenses 11 through 17 are arranged in contact with each other in the arrangement direction of the light emitting points so that the longitudinal direction of each of the collimator lenses 11 through 17 is perpendicular to the arrangement direction (horizontal direction in FIG. 14) of the light emitting points of the GaN-based semiconductor lasers LD1 through LD7.

Meanwhile, as the GaN-based semiconductor lasers LD1 through LD7, lasers, each of which has an active layer with a light emission width of 2 μm, and which emit laser light B1 through B7, are used. The lasers emit laser light B1 through B7 with a divergence angle of 10° in a direction parallel to the active layer and with a divergence angle of 30° in a direction perpendicular to the active layer, for example. The GaN-based semiconductor lasers LD1 through LD7 are arranged so that the light-emitting points are aligned in a direction parallel to the active layer.

Therefore, the laser light B1 through B7 emitted from the respective light-emitting points is incident on respective collimator lenses 11 through 17, which have elongated shapes as described above. The laser light B1 through B7 enters each of the collimator lenses so that a direction in which the divergence angle is larger corresponds to the longitudinal direction of each of the collimator lenses 11 through 17 and a direction in which the divergence angle is smaller corresponds to the width direction (direction perpendicular to the longitudinal direction) of each of the collimator lenses 11 through 17. Specifically, the width of each of the collimator lenses 11 through 17 is 1.1 mm and the length of each of the collimator lenses 11 through 17 is 4.6 mm. Thebeamdiameter of the laser light B1 through B7 which is incident on the collimator lenses is 0.9 mm in the horizontal direction and 2.6 mm in the vertical direction. Further, each of the collimator lenses 11 through 17 has a focal length f₁=3 mm, NA=0.6 and a lens arrangement pitch=1.25 mm.

The condensing lens 20 has a shape, of which the longer side parallel to the arrangement direction of the collimator lenses 11 through 17, in other words, in the horizontal direction, and of which the shorter side in a direction perpendicular to the long side. The condensing lens 20 is a lens having a non-spherical surface, which is formed by cutting out a portion of a circular lens by parallel flat planes. The portion of the circular lens is a portion including an optical axis of the circular lens. The condensing lens 20 has a focal length f₂=23 mm and NA=0.2. The condensing lens 20 is also formed by molding resin or optical glass, for example.

Next, the electric configuration of the exposure apparatus according to the present embodiment will be described with reference to FIG. 15. As illustrated in FIG. 15, a stage drive device 304 for driving the stage 152 and an exposure control unit 422 are connected to a whole-operation control unit 300. A dot pattern data generation unit 418 is connected to the exposure control unit 422. Further, an image data generation unit 414 is connected to the dot pattern generation unit 418. The image data generation unit 414 receives print pattern data through a data input unit 412. Further, a plurality of head assemblies 428A and a plurality of light source units 430 are connected to the exposure control unit 422. Each of the head assemblies 428A includes the DMD 50 and the DMD driver 428 for driving the DMD 50. Each of the light source units 430 includes the laser module 64 and a light source driver 424 for driving the laser module 64.

### [Operation of Exposure Apparatus]

Next, the operation of the exposure apparatus will be described. In each exposure head 166 of the scanner 162, laser light B1, B2, B3, B4, B5, B6 and B7 in a dispersion light state is emitted from the GaN-based semiconductor lasers LD1 through LD7 (please refer to FIG. 11). The GaN-based semiconductor lasers LD1 through LD7 are lasers which form a multiplex laser light source of the fiber array light source 66. Then, the laser light B1, B2, B3, B4, B5, B6 and B7 is collimated by respective collimator lenses 11 through 17. The collimated laser light B1, B2, B3, B4, B5, B6 and B7 is condensed by the condensing lens 20 and converges on the surface of the light entering end of the core 30a of the multi-mode optical fiber 30.

In the present embodiment, a condensing optical system is formed by the collimator lenses 11 through 17 and the condensing lens 20. Further, a multiplex optical system is formed by the condensing optical system and the multi-mode optical fiber 30. Specifically, the laser light B1 through B7 condensed by the condensing lens 20, as described above, is incident on the core 30a of the multi-mode optical fiber 30 and propagates through the optical fiber. Accordingly, the laser light B1 through B7 is combined and emitted from the optical fiber 31 connected to the light-emitting end of the multi-mode optical fiber 30.

In each of the laser modules, if the connection efficiency of the laser light B1 through B7 to the multi-mode optical fiber 30 is 0.9 and an output from each of the GaN-based semiconductor lasers LD1 through LD7 is 50 mW, multiplex laser light B of which the output is 315 mW (=50 mW×0.9×7) can be obtained for each of the optical fibers 31 arranged in an array. Therefore, laser light B of which the output is 4.4 W (=0.315 W×14) can be obtained by all of the 14 multi-mode optical fibers 31.

When exposure is performed, print pattern data is input to the image data generation unit 414 through the data input unit 412, as illustrated in FIG. 15. The image data generation unit 414 generates image data based on the input print pattern data and sends the generated image data to the dot pattern data generation unit 418. The dot pattern data generation unit 418 converts the image data to dot pattern data and sends the dot pattern data to the exposure control unit 422 as exposure data. The exposure data is data representing the density of each of pixels forming an image, for example, using three values (high density dot recording, low density dot recording and without dot recording). The exposure data is temporally stored in a frame memory of the exposure control unit 422.

The exposure control unit 422 sends a lighting signal to the light source driver 424 of the light source unit 430 based on timing for starting processing (for example, time when the moving stage 152, illustrated in FIG. 1, starts to move). Then, the light source driver 424 turns on the laser module 64 based on the lighting signal.

Meanwhile, the exposure control unit 422 controls the DMD driver 428 in each of the plurality of head assemblies 428A based on the exposure data to cause the DMD driver 428 to send an ON/OFF signal to the DMD 50. The DMD 50 is driven based on the ON/OFF signal.

A glass substrate 150 is attached to the surface of the stage 152 by suction. The stage 152 is moved at constant speed from an upstream side toward a downstream side by the stage drive device 304, as a sub-scan means, which is illustrated in FIG. 15. The operation of the stage drive device 304 is controlled by the whole-operation control unit 300. When the stage 152 passes under the gate 160, if the leading edge of the glass substrate 150 is detected by a sensor 164 attached to the gate 160, the image data stored in the frame memory is sequentially read out. When the image data is read out, data for a plurality of lines is read out at one time. Then, a control signal is generated for each of the exposure heads 166 based on the readout image data. Then, the DMD driver 428 controls, based on the generated control signal, ON/OFF of each of the micromirrors in the DMD 50 for each of the exposure heads 166. In the present embodiment, the size of a micromirror, which is a single pixel portion, is 14 μm×14 μm.

When the DMD 50 is illuminated with the laser light B emitted from the fiber array light source 66, the photoresist 150a on the glass substrate 150 is illuminated by lens systems 54 and 58 with laser light which has been reflected by a micromirror in an ON state. Accordingly, ON/OFF of the laser light emitted from the fiber array light source 66 is performed for each pixel and the photoresist 150a is exposed to light. Further, since the glass substrate 150 is moved together with the stage 152 at constant speed, the photoresist 150a is sub-scanned by the scanner 162 in a direction opposite to the moving direction of the stage. Accordingly, a band-shaped exposed region 170 is formed by each of the exposure heads 160.

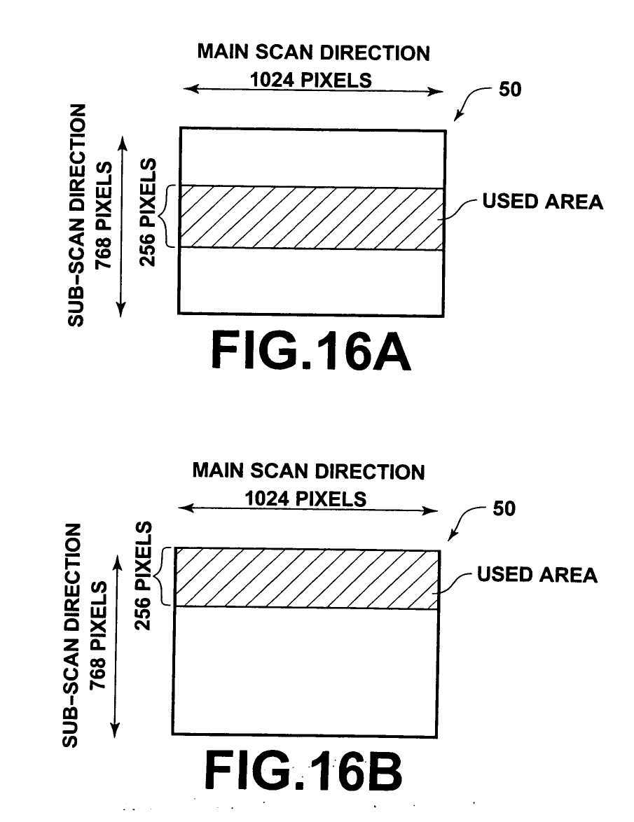

In the present embodiment, 1024 micromirrors are arranged in the main scan direction to form each micromirror row, and 768 micromirror rows are arranged in the sub-scan direction to form the DMD 50, as illustrated in FIGS. 16A and 16B. However, in the present embodiment, the controller 302 controls the operation so that only a part of the micromirrors (for example, 1024 micromirrors×256 row) in the DMD 50 is driven.

When the part of the micromirrors is driven, micromirror rows arranged in the middle of the DMD 50 may be used, as illustrated in FIG. 16A. Alternatively, micromirror rows arranged on an edge of the DMD 50 may be used, as illustrated in FIG. 16B. Further, other micromirror rows in the DMD 50 may be appropriately selected for use according to the condition of the DMD 50 or the like. For example, if a part of the micromirrors has a defect, micromirror rows which do not have defects may be used instead of micromirror rows which have defects.

The data processing speed of the DMD 50 is limited. Further, since modulation speed for each line is proportional to the number of used pixels, if a part of the micromirrors is used, the modulation speed for each line becomes faster. Further, when exposure is performed by constantly moving the exposure head relative to the exposure surface, it is not necessary that the whole pixels in the sub-scan direction are used. Therefore, when resolution in the sub-scan direction should be increased or when the sub-scan speed should be increased, the number of pixels (the number of micromirrors) to be used is determined based on required modulation speed. The number of pixels in the sub-scan direction is set at the necessary number. Accordingly, the performance of the exposure system is determined.

Here, an illumination optical system which illuminates the DMD 50 with the laser light B, as illumination light, will be described, As illustrated in FIG. 5, The illumination optical system includes the fiber array light source 66, the condensing lens 71, the rod integrator 72, the image formation lens 74, the mirror 69 and the TIR prism 70. The rod integrator 72 is, for example, a transparent rod in a shape of a quadrangular prism. When the laser light B propagates through the rod integrator 72 while being totally reflected therein, the intensity of the laser light B in a sectional plane of the beam becomes evenly distributed. Further, reflection prevention coating is applied to the light receiving surface and the light emitting surface of the rod integrator 72 to improve the transmittance of the rod integrator 72. If the intensity of the laser light B, which is illumination light, becomes evenly distributed in the cross-sectional plane of the beam, it is possible to eliminate unevenness in the intensity of the illumination light. Consequently, it becomes possible to expose the photoresist 150a so that a highly precise image is formed thereon.

When the scanner 162 completes sub-scan on the photoresist 150a with the exposure light and the sensor 164 detects the rear edge of the glass substrate 150, the stage 152 is returned to the origin along the guide 158 by the stage drive device 304. The origin is a most-upstream point on the upstream side of the gate 160. Then, the stage 152 is moved again from the upstream side of the gate 160 toward the downstream side of the gate 160 along the guide 158 at constant speed. As described above, in the present embodiment, sub-scan is performed twice on the same photoresist 150a. Therefore, it is possible to perform halftone exposure (intermediate exposure).

Next, the halftone exposure will be described in detail with reference to FIGS. 8A, 8B and 8C. As described above, in the present embodiment, the DMD 50 is tilted. Therefore, exposure beam spots which are adjacent to each other in the sub-scan direction are shifted from each other in the main scan direction by a very small amount (for example, by a distance within the range of approximately 0.1 μm to 0.5 μm). The diameter of the exposure beam spot is within the range of approximately 5 μm to 20 μm, which is larger than an interval between the spots. Therefore, the photoresist 150a is exposed (multiple exposure) to light while spots corresponding to at least two pixels of the DMD 50 partially overlap with each other. Specifically, as indicated with a shade in FIG. 8B, when sub-scan is performed, a portion of the photoresist 150a which has been exposed to a single exposure beam spot 53a sequentially moves to positions which can be exposed to other exposure beam spots 53b, 53c and 53d. When the portion which has been exposed to the exposure beam spot 53a sequentially moves to the positions which can be exposed to the exposure beam spots 53b, 53c and 53d, if the operation of each of the micromirrors in the DMD 50 is controlled so that the portion which has been exposed to the exposure beam spot 53a is actually illuminated with the exposure beam spots 53b, 53c or 53d, it is possible to perform multiple exposure. In FIG. 8C, the overlapped state of the exposure beam spots 53 is illustrated. As illustrated in FIG. 8C, the plurality of exposure beam spots 53 overlaps with each other, being slightly shifted from each other in the main scan direction.

In the present embodiment, the operation is switched, for example, between a state in which ten multiple exposure is performed by setting ten micromirrors 62 which are aligned in the sub-scan direction to ON and a state in which exposure is not performed by setting all of the ten micromirrors 62 to OFF. The operation is switched between the two states by the exposure control unit 422, illustrated in FIG. 15. The exposure control unit 422 switches the operation between the two states, based on the image data represented by three values, in each of the two sub-scan operations. Specifically, if image data represented by three values for each area of the photoresist 150a indicates high density dot recording, the exposure control unit 422 sets the operation to a state in which exposure is performed in both of the first sub-scan and the second sub-scan. If image data indicates low density dot recording, the exposure control unit 422 sets the operation to a state in which exposure is performed only in the first sub-scan. If image data indicates no dot recording, the exposure control unit 422 sets the operation to a state in which exposure is performed neither in the first sub-scan nor in the second sub-scan.

Accordingly, in the present embodiment, an exposed area in which the exposure amount is at two different levels can be formed on the photoresist 150a. Therefore, when development processing is performed later, it is possible to leave the photoresist 150a, based on the exposure pattern, of which the thickness is controlled at two different levels.

In the method according to the present invention, as described above, sub-scan is performed on the photoresist 150a, which is a photosensitive material, with the exposure light a plurality of times, and halftone exposure is performed by controlling exposure on each area of the photoresist 150a in each of the sub-scan operations. Therefore, it is not necessary to use the highly accurate mask, which is used in the conventional technique, as described above. Further, it is not necessary to use any kind of exposure mask itself. Therefore, in the method according to the present invention, it is possible to perform halftone exposure on the photoresist 150a at a low cost.

In the present embodiment, the exposure amount of exposure on the photoresist 150a is controlled at two levels. However, it is needless to say that if the number of times of sub-scan operation is set to three or more, the exposure amount can be controlled at three or more different three levels.

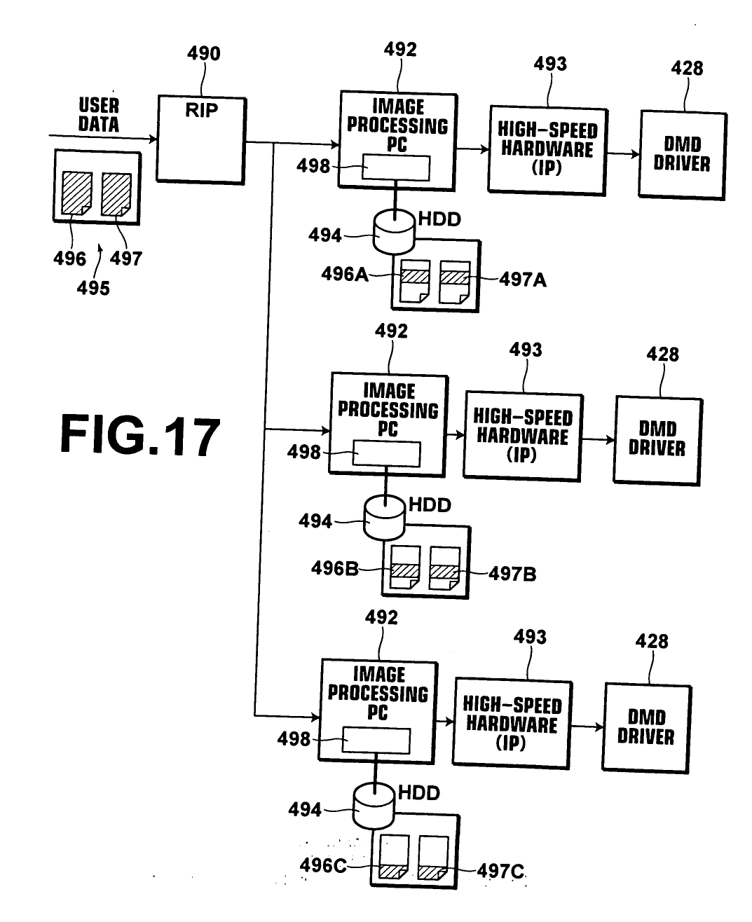

Further, in the exposure apparatus according to the present invention, it is possible to perform exposure processing at high speed by performing exposure processing in parallel on a plurality of areas, which are formed by dividing the whole area of photosensitive material. FIG. 17 is a block diagram illustrating an example of the configuration of the exposure apparatus, in which the parallel processing, as described above, can be performed.

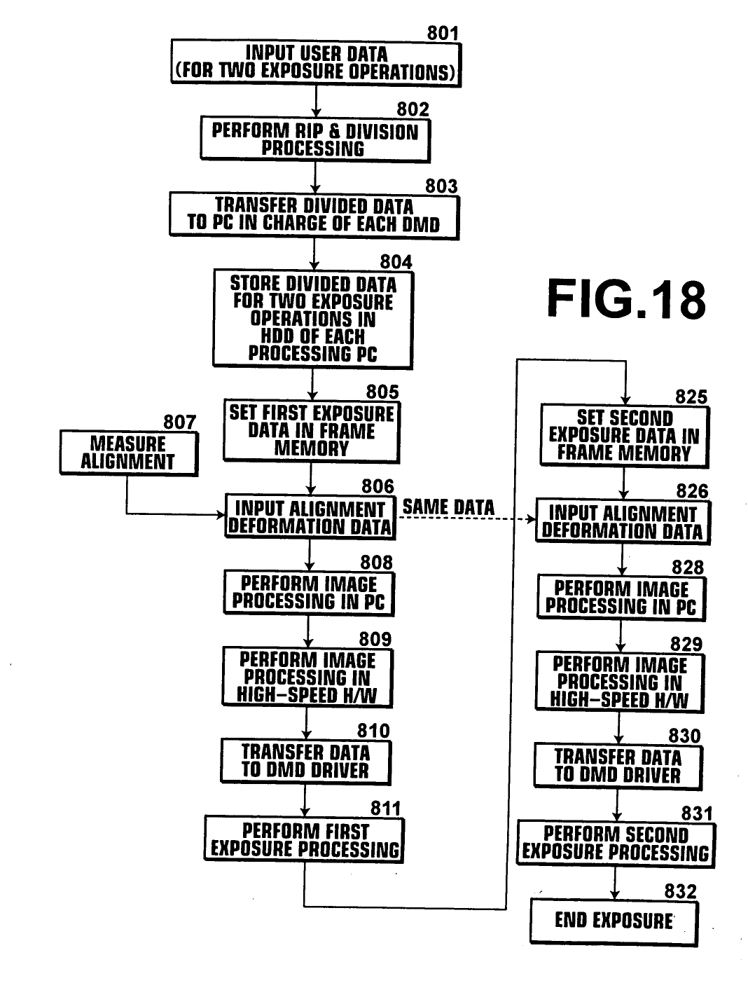

Next, the configuration of the exposure apparatus, illustrated in FIG. 17, and exposure processing performed by the exposure apparatus will be described. In FIG. 18, the flow of exposure processing is illustrated. The configuration of the exposure apparatus and the exposure processing will be described with reference to FIG. 18. User data 495, such as print pattern data as described above, is input to an RIP (Raster Image Processor) 490 (step 801 in FIG. 18). The user data 495 includes first exposure data 496 and second exposure data 497. The first exposure data 496 is data for exposing a single photosensitive material to light in the first sub-scan operation. The second exposure data 497 is data for exposing the same photosensitive material to light in the second sub-scan operation.

The RIP 490 performs raster image processing, namely, processing for converting the input user data 495 into raster format image data. The RIP 490 also performs processing for dividing the user data 495 into data for exposing each of a plurality of areas of the photosensitive material (step 802 in FIG. 18). Then, the RIP 490 transfers the divided image data to a plurality of PC's (personal computers) which process respective areas (step 803 in FIG. 18).

Each of the plurality of image processing PC's 492 includes a frame memory 498 and an HDD (hard disk drive) 494, and stores the divided image data, which has been transferred, in the HDD 494 (step 804 in FIG. 18). In FIG. 17, the divided image data input to the image processing PC 492 on the top of FIG. 17 includes data 496A and data 497A. The data 496A is data on a partial area in the first exposure data 496. The data 497A is data on a partial area in the second exposure data 497. The divided image data input to the second image processing PC 492 includes data 496B and data 497B. The data 496B is data on a partial area in the first exposure data 496. The data 497B is data on a partial area in the second exposure data 497. The divided image data input to the third image processing PC 492 includes data 496C and data 497C. The data 496C is data on a partial area in the first exposure data 496. The data 497C is data on a partial area in the second exposure data 497. The partial area is a part of an area of the photosensitive material, and the partial areas are different from each other among the plurality of image processing PC's 492.

After the divided image data 496A through 496C and 497A through 497C is transferred to all of the image processing PC's 492 and stored therein, the divided image data 496A and 497A is stored in the HDD 494 of the first image processing PC 492. However, the first image processing PC 492 sets only the divided image data 496A, which is used in the first exposure, in the frame memory 498 (step 805 in FIG. 18). In the following description, the first image processing PC 492 is used as an example. However, in the second image processing PC 492, an image exposure operation is performed in a similar manner based on the divided image data 496B and 497B. Further, in the third image processing PC 492, an image exposure operation is performed in a similar manner based on the divided image data 496C and 497C.

While the processing as described above is performed, an alignment measurement means, which is not illustrated, measures the alignment condition of the photosensitive material on the sub-scan means (step 807 in FIG. 18). Then, the measured data is input to the image processing PC 492 as alignment deformation data (step 806 in FIG. 18). The image processing PC 492 performs image processing based on the alignment deformation data so that exposure is performed at a predetermined position on the photosensitive material without being influenced by the alignment condition of the photosensitive material on the sub-scan means (step 808 in FIG. 18).

The divided image data 496A, on which image processing has been performed as described above, is transferred to a high-speed hardware 493, and image processing is appropriately performed on the transferred divided image data 496A at the high-speed hardware 493 (step 809 in FIG. 18). The high-speed hardware 493 transfers the divided image data 496A on which image processing has been performed to the DMD driver 428 (step 810 in FIG. 18). Then, the DMD driver 428 drives the DMD based on the divided image data 496A, and exposure processing in the first sub-scan operation is performed (step 811 in FIG. 18).

Although the divided image data 496A and 497A is stored in the HDD 494, when the first exposure processing ends, the image processing PC 492 sets only the divided image data 497A, which is used in the second exposure processing, in the frame memory 498 (step 825 in FIG. 18). After this, steps 826 and 828 through 831, which are similar to the processing in steps 806 and 808 through 811 in the first exposure processing, are performed, and exposure processing in the second sub-scan ends. Accordingly, exposure processing on the single photosensitive material ends (step 832 in FIG. 18).

Exposure for forming an image based the divided image data 496A and exposure for forming an image based on the divided image data 497A must be performed on the same area of the photosensitive material. Therefore, the same alignment deformation data, as described above, is used in both of the first exposure processing and the second exposure processing.

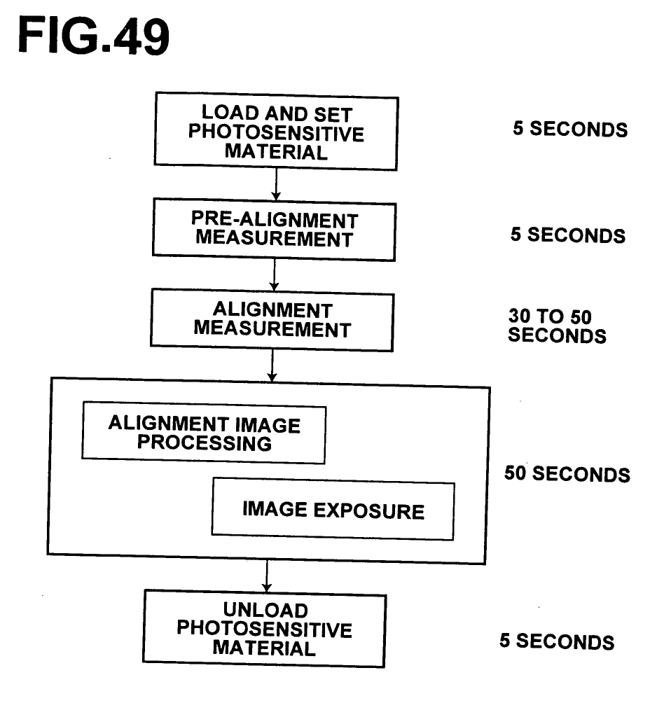

FIG. 49 illustrates an example of time required for major processes in exposure processing, as described above. As illustrated in FIG. 49, normally, it needs 35 to 55 seconds to perform the alignment measurement process including a pre-alignment measurement process. Therefore, if alignment measurement is performed only once, as described above, total time for exposure processing can be reduced by approximately 35 to 55 seconds compared with time required when alignment measurement is performed exactly in the same manner in both of the first exposure processing and the second exposure processing (alignment measurement is performed twice).

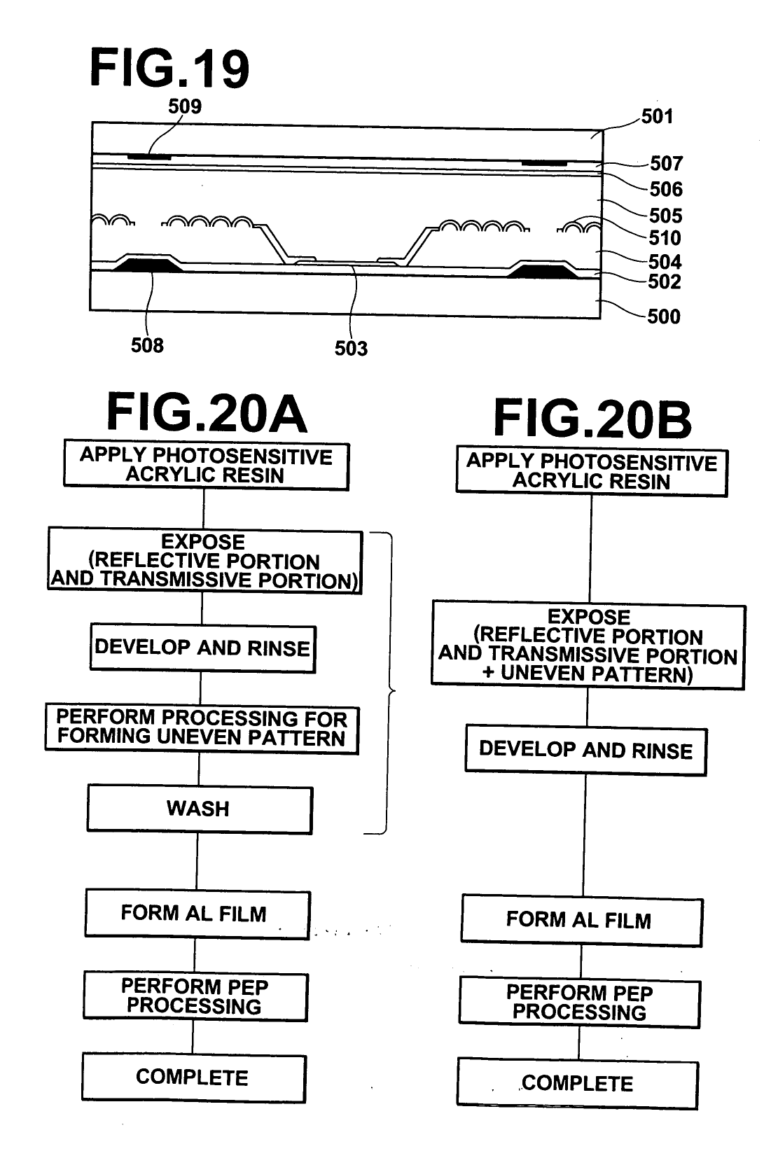

Next, another embodiment of the exposure method according to the present invention will be described with reference to FIG. 19. In the present embodiment, exposure is performed so as to leave a kind of structural member material, of which the thickness is at two different levels, on the substrate. More specifically, FIG. 19 illustrates a highly transmissive LCD-TFT panel disclosed in “High Transmissive Advanced TFT-LCD Technology”, Koichi Fujimori et al., Sharp Technical Report, No. 85, pp. 34-37, April 2003. In the highly transmissive LCD-TFT panel, an insulating film 502, a transparent electrode 503, which forms a transmissive portion, an acrylic resin layer 504 forming a reflective portion as a structural member, a liquid crystal layer 505, an ITO (Indium Tin Oxide) electrode 506 and a color filter 507 are formed between two glass substrates 500 and 501 as substrates. Further, a source bus line 508 and a black matrix 509 are illustrated in FIG. 19. Further, an aluminum electrode 510, which functions as a reflective film for reflecting light which is incident thereon from the top in FIG. 19, is formed on the surface of the acrylic resin layer 504 which forms the reflective portion. In the structure illustrated in FIG. 19, an area surrounded by the black matrix 509 corresponds to a single pixel, and a transmissive portion and a reflective portion are present in the single pixel.

Further, fine uneven patterns are formed on the surface of the acrylic resin layer 504 on which the aluminum electrode 510 is formed. The fine uneven patterns are formed to enhance the light scattering effect of the surface. Conventionally, the structural member material which is structured as described above has been formed through the steps, as illustrated in FIG. 20A. Specifically, first, photosensitive acrylic resin which forms the acrylic resin layer 504 is applied. Then, exposure is performed to form the transmissive portion and the reflective portion. For example, if the type of the photosensitive acrylic resin is a positive type, exposure is performed using a predetermined photomask so that a portion which will become a transmissive portion is exposed to light and a portion which will become a reflective portion is not exposed to light.

Then, development and rinse processing is performed. Accordingly, the unexposed portion of the photosensitive acrylic resin remains and the exposed portion of the photosensitive acrylic resin dissolves. Then, processing for forming uneven patterns on the surface of the remained acrylic resin layer 504 is performed to form the fine uneven patterns on the surface. After the fine uneven patterns are formed, the surface is washed to form an aluminum (Al) film which will become the aluminum electrode 510. Further, PEP (photolitho) process is performed on the aluminum film so as to form an electrode which has a predetermined shape. Accordingly, the structure, as described above, is formed.

In contrast, if the exposure method according to the present invention is applied, the structure, as described above, can be formed by the steps illustrated in FIG. 20B. Specifically, in the exposure method according to the present invention, when exposure is performed to form the transmissive portion and the reflective portion, the photosensitive acrylic resin is exposed to light so that a portion which will become the transmissive portion is illuminated with exposure light in both of the two sub-scan operations to increase the exposure amount. However, the photosensitive acrylic resin in the area which will become the reflective portion is illuminated with the exposure light, based on a predetermined pattern, only in one sub-scan operation to reduce the exposure amount. Accordingly, when development and rinse processing is performed in the next step, the photosensitive acrylic resin in the area which has been exposed to light at a large exposure amount completely dissolves and the transmissive portion is formed. Further, the photosensitive acrylic resin in the area which has been exposed to light at a small exposure amount also dissolves but only the photosensitive acrylic resin in a certain depth dissolves. Accordingly, depressions in the predetermined pattern are formed. Therefore, uneven patterns are formed on the surface of the acrylic resin layer 50 which remains as a reflective portion.

Specifically, if the exposure method according to the present invention is adopted, it is possible to omit the step of forming uneven patterns and the step of washing in the conventional method, illustrated in FIG. 20A.

Further, in the embodiment as described above, exposure processing is performed on the acrylic resin layer 504 at two different exposure amounts so that the acrylic resin layer 504 of which the thickness is at two different levels remains. However, it is needless to say that if exposure processing is performed on the acrylic resin layer 504 at three or more different exposure amounts, it is possible to leave the acrylic resin layer 504, of which the thickness is at three or more different levels.

Further, another embodiment of the exposure method according to the present invention will be described. In the method according to the present embodiment, at least two kinds of structural member are formed on the substrate. More specifically, in the method according to the present embodiment, a rib member and a post member are formed as structural members on the LCD-CF panel, which is a substrate.

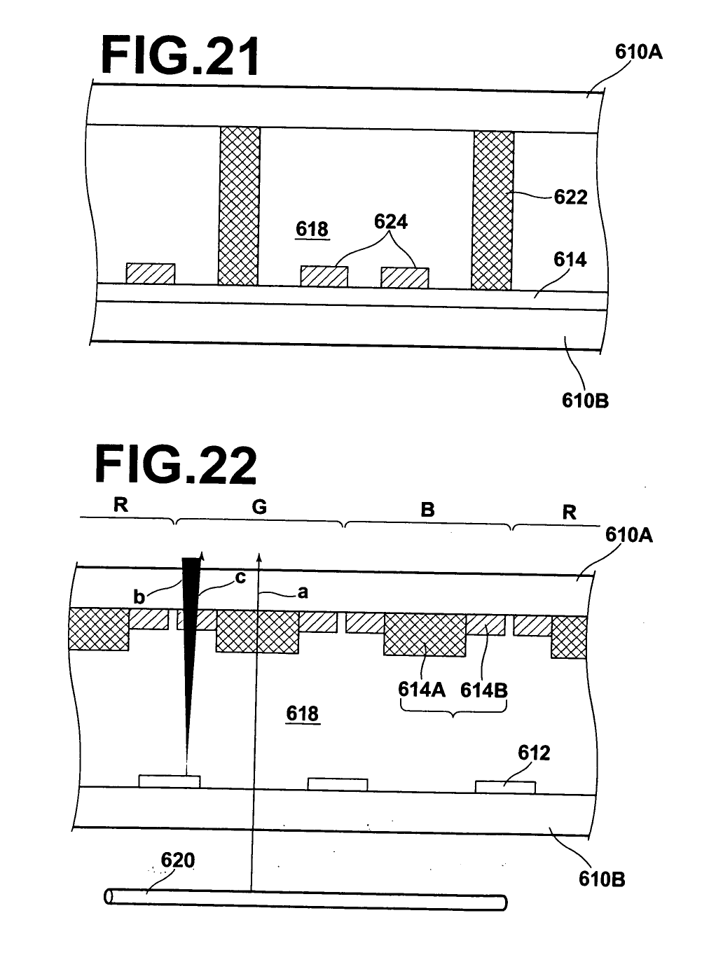

First, with reference to FIG. 21, a spacer 622, which is a post member formed in a liquid crystal layer 618, and a projection 624 for controlling the orientation of liquid crystal, which is a rib member formed in the liquid crystal layer 618, will be described. The spacer 622 and the projection 624 for controlling the orientation of liquid crystal are formed by sticking a transfer sheet to a conductive film (not illustrated) on a color filter film 614 formed on a light-transmissive substrate 610B so as to laminate the conductive film. Accordingly, a first negative-type photosensitive transparent resin layer (first transparent layer), of which the photo-sensitivity is high, and a second negative-type photosensitive transparent resin layer (second transparent layer), of which the photo-sensitivity is relatively low, are sequentially formed from the side of the conductive film. Then, an area which will become the projection portion for controlling the orientation of liquid crystal is exposed to light from the side of the light-transmissive substrate 610B at a low energy amount. Further, an area which will become the spacer portion is exposed to light from the side of the light-transmissive substrate 610B at a high energy amount. Accordingly, when development processing is performed later, the projection portion for controlling the orientation of liquid crystal and the spacer portion are formed at the same time. Exposure at the low energy amount can be achieved by performing laser exposure only in the first sub-scan. Further, exposure at the high energy amount can be achieved by performing laser exposure in both of the first sub-scan and the second sub-scan.

Accordingly, the projection 624 for controlling the orientation of liquid crystal is formed by a projection in which only the first transparent layer remains. Further, the spacer 622 is formed by a post portion in which both of the first transparent layer and the second transparent layer remain. As illustrated in FIG. 21, the spacer 622 in which both of the first transparent layer and the second transparent layer remain is thinker than the projection 624 for controlling the orientation of liquid crystal, in which only the first transparent layer remains, by the thickness of the second transparent layer. It is possible to form the projection 624 for controlling the orientation of liquid crystal and the spacer 622 so that they have appropriate thicknesses, in other words, appropriate heights by appropriately selecting the thickness of each of the negative-type photosensitive transparent resin layers as desired.

Next, actual process will be described.

### [Production of Transfer Sheet]

Application liquid having the following formulation H1 is applied to the surface of a gelatin layer of a polyethylene terephthalate temporary support member (PET temporary support member) which has a thickness of 75 μm, and to which a gelatin layer with a thickness is 0.2 μm has been applied as an undercoat layer. Then, the application liquid is dried to provide a thermoplastic resin layer with a dry-state thickness of 20 μm. Further, application liquid having the following formulation B1 is applied to the surface of the thermoplastic resin layer and dried to provide an intermediate layer with a dry-state thickness of 1.6 μm. In the formulation, the term “part” refers to a mass standard.

### [Formulation H1 for Thermoplastic Resin Layer]

| | | |
|---|---|---|
| copolymer of methylmethacrylate/2- | 15 | parts |
| ethylhexylacrylate/benzylmethacrylate/ | | |
| methacrylic acid (copolymerization | | |
| ratio: 55/4.5/11.7/28.8, weight | | |
| average molecular weight: 90000) | | |
| polypropyleneglycol diacrylate | 6.5 | parts |
| (average molecular weight = 822) | | |
| tetraethyleneglycol dimethacrylate | 1.5 | parts |
| p-toluene sulfonamide | 0.5 | parts |
| benzophenone | 1.0 | part |
| methyl ethyl ketone | 30 | parts |
| [Formulation B1 for Intermediate Layer] | | |
| polyvinyl alcohol | 130 | parts |
| (PVA-205 (saponification rate = 80%), | | |
| manufactured by Kuraray Co, Ltd.) | | |
| polyvinyl pyrolidone | 60 | parts |
| (K-90, manufactured by GAF corporation) | | |
| fluorinated surfactant | 10 | parts |
| (Surflon S-131, manufactured by Asahi | | |
| Glass Co., Ltd.) | | |
| Distilled Water | 3550 | parts |

As described above, the thermoplastic resin layer and the intermediate layer are formed on the temporary support member. Further, negative-type photosensitive transparent resin solution for the transparent layer (A1 layer), having the formulation shown in the following table 1, is further applied to the intermediate layer of the temporary support member in which the thermoplastic resin layer and the intermediate layer are formed. Then, the negative-type photosensitive transparent resin solution is dried to provide a negative-type photosensitive transparent resin layer A1 with a thickness of 1.2 μm. Then, a cover film made of polypropylene (of which the thickness is 12 μm) is attached to the negative-type photosensitive transparent resin layer A1 by pressure. Accordingly, a photosensitive transfer sheet SA1, in which the thermoplastic resin layer, the intermediate layer and the negative-type photosensitive transparent resin layer A1 are superposed one on another, is produced.

TABLE 1

| | A1 |
|---|---|
| copolymer of benzylmethacrylate/methacrylic acid | 7.8 |
| (molar ratio = 73/27, molecular weight 30000) | |
| dipentaerythritol hexacrylate | 5.2 |
| fluorinated surfactant | 0.06 |
| (Megafac F176, manufactured by Dainippon Ink & | |
| Chemicals, Inc.) | |
| 2-trichloromethyl-5-(p-styrylstyryl-1,3,4-oxadiazol | 0.32 |
| Phenothiazine | 0.012 |
| Propyleneglycol monomethylether acetate | 27 |
| methyl ethyl ketone | 35 |

Next, another polyethylene terephthalate film temporary support member which has a thickness of 75 μm is prepared besides the above polyethylene terephthalate film temporary support member. Then, application liquid having the formulation H1 is applied to the surface of PET in a manner similar to the application of the application liquid, as described above. Then, the application liquid is dried to provide a thermoplastic resin layer with a dry-state thickness of 20 μm. Further, application liquid having the formulation B1 is applied to the surface of the thermoplastic resin layer and dried so as to provide an intermediate layer with a dry-state thickness of 1.6 μm. Accordingly, the thermoplastic resin layer and the intermediate layer are provided on the temporary support member. Further, negative-type photosensitive transparent resin solution for a transparent layer (P1 layer), having the formulation shown in the following table 2, is applied to the intermediate layer and dried. Accordingly, a negative-type photosensitive transparent resin layer P1 with a thickness is 4.0 μm is provided. Then, a cover film made of polypropylene (of which the thickness is 12 μm) is attached to the negative-type photosensitive transparent resin layer P1 by pressure. Accordingly, a photosensitive transfer sheet SP1, in which the thermoplastic resin layer, the intermediate layer and the negative-type photosensitive transparent resin layer P1 are superposed one on another, is produced.

TABLE 2

| | P1 |
|---|---|
| copolymer of benzylmethacrylate/methacrylic acid | 7.8 |
| (molar ratio = 73/27, molecular weight 30000) | |
| dipentaerythritol hexacrylate | 5.2 |
| fluorinated surfactant | 0.06 |
| (Megafac F176, manufactured by Dainippon Ink & | |
| Chemicals, Inc.) | |
| Irgacure 651 (manufactured by Ciba Geigy AG) | 0.32 |
| Phenothiazine | 0.012 |
| Propyleneglycol monomethylether acetate | 27 |
| methyl ethyl ketone | 35 |

Further, the photosensitivity h¹ of the negative-type photosensitive transparent resin layer A1 of the photosensitive transfer sheet SA1 and the photosensitivity h² of the negative-type photosensitive transparent resin layer P1 of the photosensitive transfer sheet SP1 are adjusted so that the photosensitivity ratio h¹/h² becomes 10.

### [Production of Spacer and Projection for Controlling the Orientation of Liquid Crystal]

These photosensitive transfer sheets SA1 and SP1 are used and a spacer and a projection for controlling the orientation of liquid crystal are formed on the color filter which has been formed on the glass substrate (thickness is 0.7 mm) in advance. The spacer and the projection for controlling the orientation of liquid crystal are formed by the exposure apparatus similar to the apparatus, as described above, by using the following method.

First, an ITO film is formed, by sputtering, on the color filter which has been formed in advance. The ITO film is formed so that the resistance of the ITO film becomes 20Ω/□. The cover film of the photosensitive transfer SAl is peeled and the exposed surface of the negative-type photosensitive transparent resin layer A1 and the ITO film are attached to each other by pressuring (0.8 kg/cm²) and by heating (130° C.) using a laminator (VP-II, manufactured by Taisei Laminator Co., Ltd.). Then, the intermediate layer and the negative-type photosensitive transparent resin layer A1 are peeled from each other at the interface therebetween. Accordingly, only the negative-type photosensitive transparent resin layer A1 is transferred onto the glass substrate.

Then, the cover film of the photosensitive transfer sheet SP1 is peeled. The exposed negative-type photosensitive transparent resin layer P1 is attached to the surface of the negative-type photosensitive transparent resin layer A1 in a manner similar to the method, as described above. Then, the temporary support member and the thermoplastic resin layer are peeled from each other at the interface therebetween. Accordingly, transfer is performed so that the negative-type photosensitive transparent resin layer A1, the negative-type photosensitive transparent resin layer P1, the intermediate layer and the thermoplastic resin layer are formed on the glass substrate.

Next, exposure is performed by an exposure apparatus which is structured, as described above. The exposure is performed with laser light, of which the wavelength is 405 nm, at an energy amount of 4 mJ/cm² and at an energy amount of 40 mJ/cm². In this case, exposure is performed at the energy amount of 4 mJ/cm² for an area in which only the negative-type photosensitive transparent resin layer A1, which will form the first transparent layer as described above, should be left to form the projection 624 for controlling orientation. Meanwhile, exposure is performed at the energy amount of 40 mJ/cm² for an area in which the negative-type photosensitive transparent resin layer P1, which will form the second transparent layer as described above, and the negative-type photosensitive transparent layer A1 should be left to form the spacer 622.

Then, the negative-type photosensitive transparent resin layer P1 is developed using developer PD2 (manufactured by Fuji Photo Film Co., Ltd.). Accordingly, the thermoplastic resin layer and the intermediate layer are removed. In this case, the negative-type photosensitive transparent resin layer A1 is not substantially developed. Then, an unnecessary portion of the negative-type photosensitive transparent resin layer A1 is developed and removed using developer CD1 (manufactured by Fuji Photo Film Co., Ltd.). Further, finishing processing (brush processing) is performed using SD1 (manufactured by Fuji Photo Film Col, Ltd.). Accordingly, the projection portion for controlling the orientation of liquid crystal and the spacer portion are formed on the glass substrate. The projection portion for controlling the orientation of liquid crystal is a portion formed by a transparent pattern made only of the negative-type photosensitive transparent resin layer A1. The spacer portion is a portion formed by a transparent pattern made of the negative-type photosensitive transparent resin layers A1 and P1 which are superposed one on the other.

Here, the negative-type photosensitive transparent resin layer A1 is formed so as to be substantially sensitive to a wavelength within the range of 330 nm to 390 nm. Further, the negative-type photosensitive transparent resin layer P1 is formed so as to be substantially sensitive to a wavelength within the range of 330 nm to 415 nm.

Next, baking is performed at the temperature of 240° C. for 50 minutes. Accordingly, a spacer 62, of which the height is 3.7 μm, and a projection 624 for controlling the orientation of liquid crystal are formed on the ITO film. The height of the projection 624 is 1.0 μm. As described above, in the present embodiment, it is possible to easily form both of the spacer 622 and the projection 624 for controlling the orientation of liquid crystal, which are highly precise, and of which the heights (thicknesses) are different from each other, at the same time.

Next, another method for forming the spacer 622 and the projection 624 for controlling the orientation of liquid crystal will be described.

Further, in the above embodiment, the PET temporary support member which was used in the process described in the section [Production of Transfer Sheet] is replaced by a polyethylene terephthalate film temporary support member, of which the thickness is 75 μm, and which is not undercoated. Further, neither the thermoplastic resin layer nor the intermediate layer is applied to the surface of the polyethylene terephthalate film temporary support member in advance. Instead, the negative-type photosensitive resin solution for the transparent layer (A1 layer), having the formulation shown in the above table 1, is directly applied to the surface of the temporary support member and dried to provide a negative-type photosensitive transparent resin layer A1, of which the thickness is 1.2 μm. The other processing is performed in a manner similar to the above embodiment. When processing is performed in such a manner, it is possible to form the spacer 622 and the projection 624 for controlling the orientation of liquid crystal.

Next, another embodiment of the exposure method according to the present invention will be described. In the method according to the present embodiment, at least two kinds of structural members are formed on the substrate. Specifically, in the method according to the present embodiment, an RGB member for transmission and an RGB member for reflection are formed as the structural members on the LCD-CF panel as the substrate.

First, a color filter including the RGB member for transmission and the RGB member for transmission will be described with reference to FIG. 22. The color filter is produced by sticking a transfer sheet to a light-transmissive substrate 610A so as to laminate the light-transmissive substrate 610A. Accordingly, a first negative-type photosensitive colored resin layer (first colored layer) and a second negative-type photosensitive colored resin layer (second colored layer) are sequentially formed on the light-transmissive substrate 610A. The first negative-type photosensitive colored resin layer is a layer of which the photosensitivity is high, and the second negative-type photosensitive colored resin layer is a layer of which the photosensitivity is relatively low. Then, an area which will form a reflective-type liquid crystal displayportion is exposed to light by a laser at a low energy amount from the colored-layer side of the light-transmissive substrate 610A. Further, an area which will form a transmissive-type liquid crystal display portion is exposed to light by a laser at a high energy amount from the colored-layer side of the light-transmissive substrate 610A. After exposure, development is performed to produce the color filter.

Specifically, the area which will become the reflective-type liquid crystal display portion is formed by a pixel portion 614B, in which only the first colored layer remains. The area which will become the transmissive-type liquid crystal display portion is formed by a pixel portion 614A, in which both of the first colored layer and the second colored layer remain. A colored pixel (R, G or B) 614 is formed by the pixel portion 614A and two pixel portions 614B sandwiching the pixel portion 614A. The thickness of the pixel portion 614A in which both of the first colored layer and the second colored layer remain is thicker than that of the pixel portion 614B in which only the first colored layer remains by the thickness of the second colored layer. Accordingly, the pixel portion 614A is formed so as to have an appropriate thickness as the transmissive-type portion. The pixel portion 614B is formed so as to have an appropriate thickness as the reflective-type portion.

When the color filter is structured as described above, light emitted from a back light 620 is transmitted to an observing side through the transmissive-type pixel portion 614A, as indicated with arrow a in FIG. 22. Light which has entered from the observing side, as indicated with arrow b in FIG. 22, is reflected by a reflective plate (reflective electrode) 612. Then, the reflected light returns to the observing side through the reflective-type pixel portion 614B, as indicated with arrow c in FIG. 22.

An actual process will be described.

### [Production of Transfer Sheet]

Application liquid having the above formulation H1 is applied to the surface of a gelatin layer of a polyethylene terephthalate temporary support member (PET temporary support member) which has a thickness of 75 μm, and on which a gelatin layer with a thickness of 0.2 μm has been applied as an undercoat layer. Then, the application liquid is dried to provide a thermoplastic resin layer with a dry-state thickness of 20 μm.

Then, application liquid having the formulation B1 is applied to the surface of the thermoplastic resin layer, provided by application, and dried so that an intermediate layer with a dry-state thickness of 1.6 μm is provided.

As described above, three PET temporary support members, in each of which a thermoplastic resin layer and an intermediate layer are provided in advance, are prepared. Then, negative-type photosensitive resin solution for a red layer (R1 layer), negative-type photosensitive resin solution for a green layer (G layer) or negative-type photosensitive resin solution for a blue layer (B1 layer), each having the formulation shown in table 3, is further applied to the intermediate layer of each of the PET temporary support members and dried. Accordingly, the negative-type photosensitive resin layer R1, B1 or G1, which has a thickness of 1.2 μm, is provided by application. Further, a cover film made of polypropylene (of which the thickness is 12 μm) is attached to the negative-type photosensitive transparent resin layer of each color (R1, B1 or G1) by pressure. Accordingly, three kinds of photosensitive transfer sheets R1, B1 and G1, in each of which the thermoplastic resin layer, the intermediate layer and the negative-type photosensitive transparent resin layer (R1, B1 or G1) are superposed one on another, are produced.

TABLE 3

| | R1 | G1 | B1 |
|---|---|---|---|
| copolymer of benzylmethacrylate/ | 7.8 | 10.2 | 9.8 |
| methacrylic acid (molar ratio = | | | |
| 73/27, molecular weight 30000) | | | |
| Dipentaerythritol hexacrylate | 5.2 | 4.6 | 6.1 |
| fluorinated surfactant | 0.06 | 0.14 | 0.12 |
| (Megafac F176, manufactured by | | | |
| Dainippon Ink & Chemicals, Inc.) | | | |
| 7-[2-[4-(3-hydroxymethylpyperidino)- | 1.49 | 1.26 | 0.25 |
| 6-diethylamino]triazylamino]- | | | |
| 3-phenylcoumalin | | | |
| 2-trichloromethyl-5-(p-styrylstyryl- | 0.32 | 0.22 | 0.23 |
| 1,3,4-oxadiazol | | | |
| Phenothiazine | 0.012 | 0.006 | 0.025 |
| C.I. PR254 dispersion liquid | 8.6 | 0 | 0 |
| (RT-107, manufactured by FUJIFILM | | | |
| OLIN Co., Ltd.) | | | |
| C.I. PG36 dispersion liquid | 0 | 5.6 | 0 |
| (GT-2, manufactured by FUJIFILM | | | |
| OLIN Co., Ltd.) | | | |
| C.I. PY138 dispersion liquid | 0 | 3.9 | 0 |
| (YT-123, manufactured by FUJIFILM | | | |
| OLIN Co., Ltd.) | | | |
| C.I. PB15:6 dispersion liquid | 0 | 0 | 13.2 |
| (MHI blue 7075M, manufactured by | | | |
| Mikuni Color Ltd.) | | | |
| Propyleneglycol monomethylether | 27 | 26 | 14 |
| acetate | | | |
| methyl ethyl ketone | 35 | 34 | 44 |

Next, another polythylene terephthalate film temporary support member which has a thickness of 75 μm is prepared besides the polyethylene terephthalate film temporary support member, as described above. Then, application liquid having the formulation H1, as described above, is applied to the surface of PET and dried to provide a thermoplastic resin layer with a dry-state thickness is 20 μm. Further, application liquid having the formulation B1, as described above, is applied to the surface of the thermoplastic resin layer and dried so as to provide an intermediate layer with a dry-state thickness is 1.6 μm. Accordingly, three temporary support members, in each of which the thermoplastic resin layer and the intermediate layer are provided, are prepared. Further, negative-type photosensitive resin solution for a red layer (R2 layer), negative-type photosensitive resin solution for a green layer (G2 layer) or negative-type photosensitive resin solution for a blue layer (B2 layer), each having a formulation shown in the following table 4, is applied to the intermediate layer and dried. Accordingly, a negative-type photosensitive resin layer with a thickness of 1.2 μm is provided by application. Then, a cover film made of polypropylene (of which the thickness is 12 μm) is attached to the negative-type photosensitive resin layer of each color by pressure. Accordingly, three kinds of photosensitive transfer sheets R2, B2 and G2, in each of which the thermoplastic resin layer, the intermediate layer and the negative-type photosensitive resin layer (R2, B2 or G2) are superposed one on another, is produced.

TABLE 4

| | R2 | G2 | B2 |
|---|---|---|---|
| copolymer of benzylmethacrylate/ | 7.8 | 10.2 | 9.8 |
| methacrylic acid (molar ratio = | | | |
| 73/27, molecular weight 30000) | | | |
| Dipentaerythritol hexacrylate | 5.2 | 4.6 | 6.1 |
| fluorinated surfactant | 0.06 | 0.14 | 0.12 |
| (Megafac F176, manufactured by | | | |
| Dainippon Ink & Chemicals, Inc.) | | | |
| 7-[2-[4-(3-hydroxymethylpyperidino)- | 1.49 | 1.26 | 0.25 |
| 6-diethylamino]triazylamino]- | | | |
| 3-phenylcoumalin | | | |
| 2-trichloromethyl-5-(p-styrylstyryl- | 0.32 | 0.22 | 0.23 |
| 1,3,4-oxadiazol | | | |
| Phenothiazine | 0.012 | 0.006 | 0.025 |
| C.I. PR254 dispersion liquid | 19.2 | 0 | 0 |
| (RT-107, manufactured by FUJIFILM | | | |
| OLIN Co., Ltd.) | | | |
| C.I. PG36 dispersion liquid | 0 | 11.3 | 0 |
| (GT-2, manufactured by FUJIFILM | | | |
| OLIN Co., Ltd.) | | | |
| C.I. PY138 dispersion liquid | 0 | 7.8 | 0 |
| (YT-123, manufactured by FUJIFILM | | | |
| OLIN Co., Ltd.) | | | |
| C.I. PB15:6 dispersion liquid | 0 | 0 | 26.4 |
| (MHI blue 7075M, manufactured by | | | |
| Mikuni Color Ltd.) | | | |
| Propyleneglycol monomethylether | 27 | 26 | 14 |
| acetate | | | |
| methyl ethyl ketone | 35 | 34 | 44 |

In the above embodiment, the photosensitivity h¹ of the negative-type photosensitive transparent resin layer of each of the photosensitive transfer sheets R1, B1 and G1 and the photosensitivity h² of the negative-type photosensitive resin layer of each of the photosensitive transfer sheets R2, B2 and G2 are adjusted so that the photosensitivity ratio h¹/h² between the negative-type photosensitive layers of each color becomes 10.

### [Production of Color Filter]

Production of a color filter will be described. The color filter is produced using six kinds of photosensitive transfer sheet obtained as described above.

First, the cover film of the photosensitive transfer R1 is peeled off and the exposed surface of the negative-type photosensitive resin layer R1 is attached to a transparent glass substrate (with a thickness of 1.1 mm) by pressure (0.8 kg/cm²) and by heat (130° C.) by a laminator (VP-11, manufactured by Taisei Laminator Co., Ltd.). Then, the intermediate layer and the negative-type photosensitive resin layer R1 are peeled from each other at the interface therebetween and only the red negative-type photosensitive resin layer R1 is transferred onto the glass substrate. Then, the cover film of the photosensitive transfer sheet R2 is peeled. The exposed negative-type photosensitive resin layer R2 is attached to the surface of the negative-type photosensitive resin layer R1 in a manner similar to the method, as described above. Then, the temporary support member and the thermoplastic resin layer are peeled from each other at the interface therebetween. Accordingly, transfer is performed so that the negative-type photosensitive resin layer R1, the negative-type photosensitive resin layer R2, the intermediate layer and the thermoplastic resin layer are formed on the glass substrate.

Next, exposure is performed by an exposure apparatus which is structured as described above with laser light, of which the wavelength is 405 nm. The exposure is performed at an energy amount of 4 mJ/cm² and at an energy amount of 40 mJ/cm². In this case, exposure is performed at the energy amount of 4 mJ/cm² for an area in which the reflective-type pixel portion 614B should be formed by leaving only the negative-type photosensitive resin layer R1. Meanwhile, exposure is performed at the energy amount of 40 mJ/cm² for an area in which the transmissive-type pixel portion 614A should formed by leaving the negative-type photosensitive resin layer R1 and the negative-type photosensitive resin layer R2. In this case, exposure at the low energy amount can be achieved by performing laser exposure only in the first sub-scan. Further, exposure at the high energy amount can be achieved by performing laser exposure in both of the two sub-scans.

Then, the negative-type photosensitive resin layer R2 is developed using developer PD2 (manufactured by Fuji Photo Film Co., Ltd.). Further, the thermoplastic resin layer and the intermediate layer are removed. In this case, the negative-type photosensitive transparent resin layer R1 is not substantially developed. Then, an unnecessary portion of the negative-type photosensitive transparent resin layer R1 is developed and removed using developer CD1 (manufactured by Fuji Photo Film Co., Ltd.). Further, finishing processing (brush processing) is performed using SD1 (manufactured by Fuji Photo Film Co, Ltd.). Accordingly, a red pattern (reflective display portion) and a red pattern (transmissive display portion) are formed on the glass substrate 610A. The red pattern (reflective display portion) is a pattern made of only the negative-type photosensitive resin layer R1. The red pattern (transmissive display portion) is a pattern made of the negative-type photosensitive resin layers R1 and R2 which are superposed one on the other.

Then, the photosensitive transfer sheets G1 and G2 are sequentially attached to the glass substrate on which the red patterns have been formed, and peeling, exposure and development is performed in a manner similar to the method as described above. Accordingly, a green pattern (reflective display portion) made of only the negative-type photosensitive resin layer G1 and a green pattern (transmissive display portion) made of the negative-type photosensitive resin layers G1 and G2, which are superposed one on the other, are formed. Further, an operation similar to the one described above is repeated using the photosensitive transfer sheets B1 and B2. Accordingly, a blue pattern (reflective display portion) made of only the negative-type photosensitive resin layer B1 and a blue portion (transmissive display portion) made of the negative-type photosensitive resin layers B1 and B2, which are superposed one on the other, are formed on the transparent glass substrate, on which the red patterns and the green patterns have been formed. Accordingly, an RGB color filter for both reflection and transmission is produced.

As described above, a high-resolution color filter including color pixels (R, G and B) can be easily formed. In each pixel formation area of the color filter, in which a pixel is formed when an image is displayed, a reflective display portion and a transmissive display portion for each color are provided. The reflective display portion and the transmissive display portion are portions of which the thicknesses are different from each other.

Next, another method for forming the color filter for both reflection and transmission will be described.

In the embodiment, as described above, the PET temporary support member which was used in the process described in the section [Production of Transfer Sheet] is replaced by a polyethylene terephthalate film temporary support member, of which the thickness is 75 μm, and which is not undercoated. Further, neither the thermoplastic resin layer nor the intermediate layer is formed by application on the surface of the polyethylene terephthalate film temporary support member. Instead, negative-type photosensitive resin solution for the red layer (R1 layer), negative-type photosensitive resin solution for the green layer (G1 layer) or negative-type photosensitive resin solution for the blue layer (B1 layer), each having the formulation shown in table 3, is directly applied to the surface of the temporary support member and dried to provide a negative-type photosensitive resin layers R1, B1 or G1, of which the thickness is 1.2 μm. The other processing is performed in a manner similar to the above embodiment to produce a color filter. It is possible to easily produce a high-resolution color filter formed by color pixels (R, G and B) by using this method.

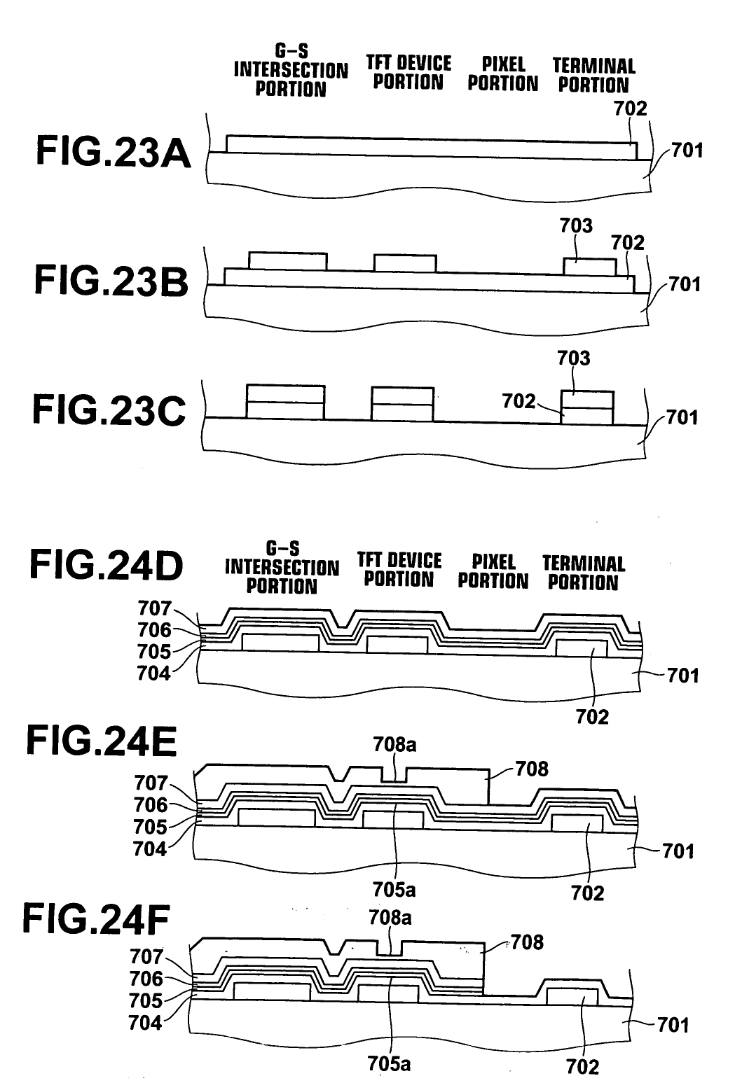

Next, another embodiment of the exposure method according to the present invention will be described with reference to FIGS. 23A through 29S. In the exposure method according to the present embodiment, after a single structural member made of photoresist is formed on a substrate, the photoresist is removed stepwise. Then, processing for forming another structural member is performed by utilizing the single structural member. Accordingly, two or more structural members can be formed on the substrate. Here, a TFT circuit is formed by the structural members.

In FIGS. 23A through 29S, processing for producing an active matrix substrate having a high aperture ratio, as described above, is sequentially illustrated. In each of the diagrams, a cross-sectional structure, in which a G-S intersection portion of a gate electrode and a source electrode, a TFT device portion, a pixel portion and a terminal portion are arranged, is schematically illustrated.

FIG. 23A illustrates a state in which a gate electrode film 702 is formed on the glass substrate 701. The gate electrode film 702 is a metal film made of chromium, aluminum, tantalum or the like, which is formed by using a sputtering method or the like. FIG. 23B illustrates a state in which a resist pattern 703 has been formed using a single photomask after photoresist is evenly applied to the gate electrode film 702. FIG. 23C illustrates a state in which patterning has been performed on the gate electrode film 702 by etching using the resist pattern 703.

Next, as illustrated in FIG. 24D, after the resist pattern 703 is removed, a gate insulating film 704, a first semiconductor layer 705 and a second semiconductor layer 706 are consecutively superposed one on another. Further, a source-drain electrode film 707 is consecutively superposed by using a plasma CVD (chemical vapor deposition) method, a sputtering method or the like. The gate insulating film 704 is formed by a silicon nitride (SiNₓ) film, for example. The first semiconductor layer 705 is formed by an amorphous silicon (a-Si) film. The second semiconductor layer 706 is formed by a silicon (n⁺-Si) film doped with an n-type impurity at high density. The source-drain electrode film 707 is made of metal, such as chromium, aluminum and tantalum.

Next, as illustrated in FIG. 24E, photoresist is applied to the entire surface of the glass substrate 701. Then, exposure is performed by changing the exposure amount for each of predetermined areas. Accordingly, a resist pattern 708, of which the thickness is at multiple levels, is formed by performing a single operation of resist application, exposure and development. Here, the resist pattern 708 is not formed on the pixel portion and the terminal portion. Further, a portion corresponding to a channel portion 705a of the TFT device portion is formed as a thin portion 708a, and the other area is formed as a thick portion. Specifically, the other area is formed so as to have a thickness which is greater than or equal to a first thickness, which is a predetermined thickness. The thin portion 708a is formed so as to have a second thickness which is less than the first thickness. In this case, the exposure amount can be changed for each of the predetermined areas by performing exposure only in the first sub-scan or by performing exposure in both of the two sub-scans.

Next, as illustrated in FIG. 24F, all of the first semiconductor layer 705, the second semiconductor layer 706 and the source-drain electrode film 707 in the area which is not covered by the resist pattern 708 are removed by etching.

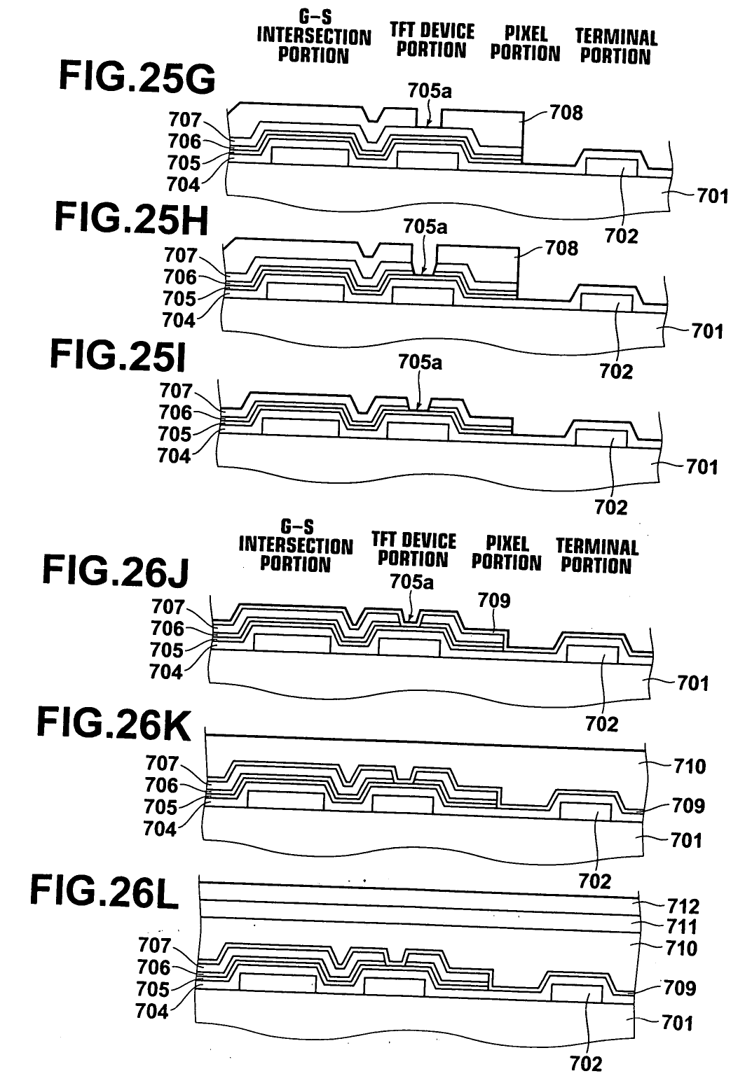

Then, as illustrated in FIG. 25G, the thickness of the whole resist pattern 708 which remains in the state illustrated in FIG. 24F is reduced by ashing. Accordingly, the surface of the source-drain electrode film 707 is exposed at the position of the channel portion 705a, which corresponds to the thin portion 708a.

FIG. 25H illustrates a state in which the source-drain electrode has been divided and channel etching has been performed by utilizing the remaining resist pattern 708. In the channel portion 705a, the thickness of the first semiconductor layer 705 is adjusted, and the second semiconductor layer 706 and the source-drain electrode film 707 are removed. FIG. 25I illustrates a state in which the resist pattern 708 has been removed.

FIG. 26J illustrates a state in which a passivation film 709 is formed on the entire surface of the substrate. The passivation film 709 is a protective film made of silicon nitride (SiNₓ) or the like. The passivation film 709 is formed by using a CVD method, a sputtering method or the like.

FIG. 26K illustrates a state in which an acrylic-based resin film 710, which is an electrically insulating film, and of which the surface is flat, has been formed. The acrylic-based resin film 710 is formed by applying electrically insulating synthetic resin material, such as acrylic-based resin, to the surface of the passivation film 709 and by flattening the surface of the electrically insulating synthetic resin material. Further, FIG. 26L illustrates a state in which a photoresist layer 712 has been formed. After the acrylic-based resin film 710 is pre-baked at a temperature within the range of 80 to 100 degrees, a water repellent resin layer 711 is formed by applying fluorine-based resin on the surface of the pre-baked acrylic-based resin film 710. Further, photoresist is applied to the water repellent resin layer 711 to form the photoresist layer 712.

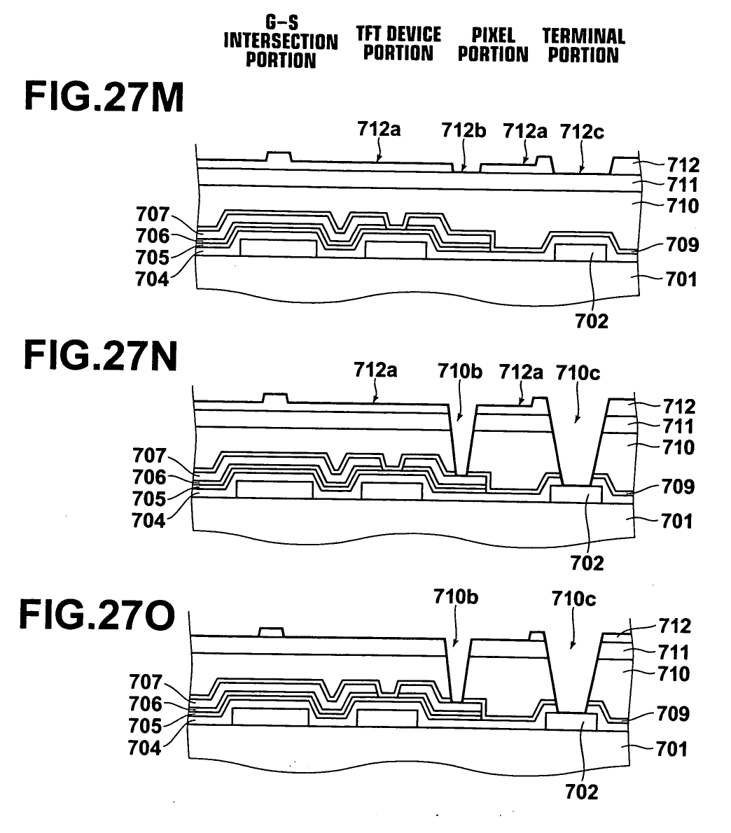

Further, FIG. 27M illustrates a state in which patterning has been performed to form a pattern at multiple thickness levels in a single operation of exposure and development. The pattern is formed at multiple thickness levels by changing the exposure amount for each of predetermined areas on the photoresist layer 712. The exposure amount is adjusted using a slit mask or the like as the third photomask. Since exposure is performed in such a manner, the photoresist layer 712 is exposed and developed so that a predetermined contact hole area 712b in the pixel electrode formation area of the photoresist layer 712 is not cured, a depression 712a, which is a pixel electrode formation area excluding the contact hole area 712b, is partially cured, and the other area is cured.

Further, FIG. 27N illustrates a state in which the contact hole 710b, namely, a through-hole connecting the surface of the acrylic-based resin film 710 and the drain electrode portion, has been formed. The contact hole 710b is formed by performing etching on the acrylic-based resin film 710 and the passivation film 709 using the first resist pattern of the photoresist layer 712 as a mask. In this case, the passivation film 709, the gate insulating film 704 and the like are removed in the terminal portion and a contact hole 710c, which is a through-hole to the gate electrode or a source electrode (not illustrated), is formed. Accordingly, the gate electrode 702 and the source electrode (not illustrated) are exposed. In this case, since the thickness of the water repellent resin layer 711 is thin, the water repellent resin layer 711 in the contact holes 710b and 710c is removed by a process similar to lift-off. FIG. 27O illustrates a state in which a second resist pattern has been formed by reducing the thickness of the photoresist layer 712 as a whole by ashing.

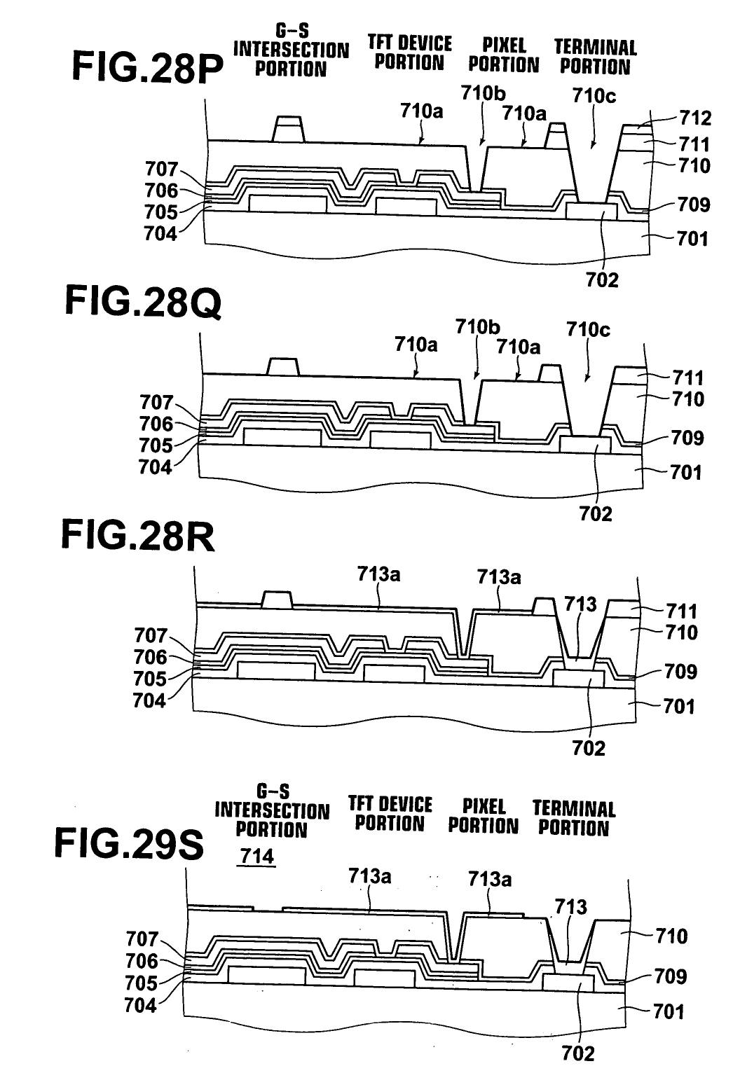

Further, FIG. 28P illustrates a state in which a depression area 710a adjacent to the contact hole is formed in the acrylic-based resin film 710 in the pixel electrode formation area. The depression area 710a is formed by performing etching on the water repellent resin layer 711 using the second resist pattern of the photoresist layer 712 as a mask. FIG. 28Q illustrates a state in which unnecessary photoresist layer 712 which remained in the state illustrated in FIG. 28P has been removed.

FIG. 28R illustrates a state in which an application-type transparent conductive film 713 has been formed by applying an application-type transparent conductive material by spin-coating or the like. The application-type transparent conductive film 713 covers the surface of the depression area 710a of the acrylic-base resin film 710 and the inner surface of the contact holes 710b and 710c. The water repellent resin layer 711 repels the application-type transparent conductive material by its water repellent property. Therefore, the application-type transparent conductive film 713 is not formed in the area in which the water repellent resin layer 711 remains.

Then, a pixel electrode 713a is formed by baking at a temperature within the range of 200° C. to 250° C. Here, the application-type transparent conductive film 713 which forms the pixel electrode 713a may be made of Indium Tin Oxide (ITO) or the like. Since the pixel electrode is formed by applying the application-type transparent conductive material, such as ITO, in the present embodiment, the pixel electrode can be formed without using a vacuum deposition method, such as a plasma CVD method and a sputtering method. Therefore, the production cost can be reduced.

Further, FIG. 29S illustrates a state in which the remaining water repellent resin layer 711 has been removed by ashing or the like after the pixel electrode 713a was formed. Accordingly, an active matrix substrate 714 which has a high aperture ratio can be produced.

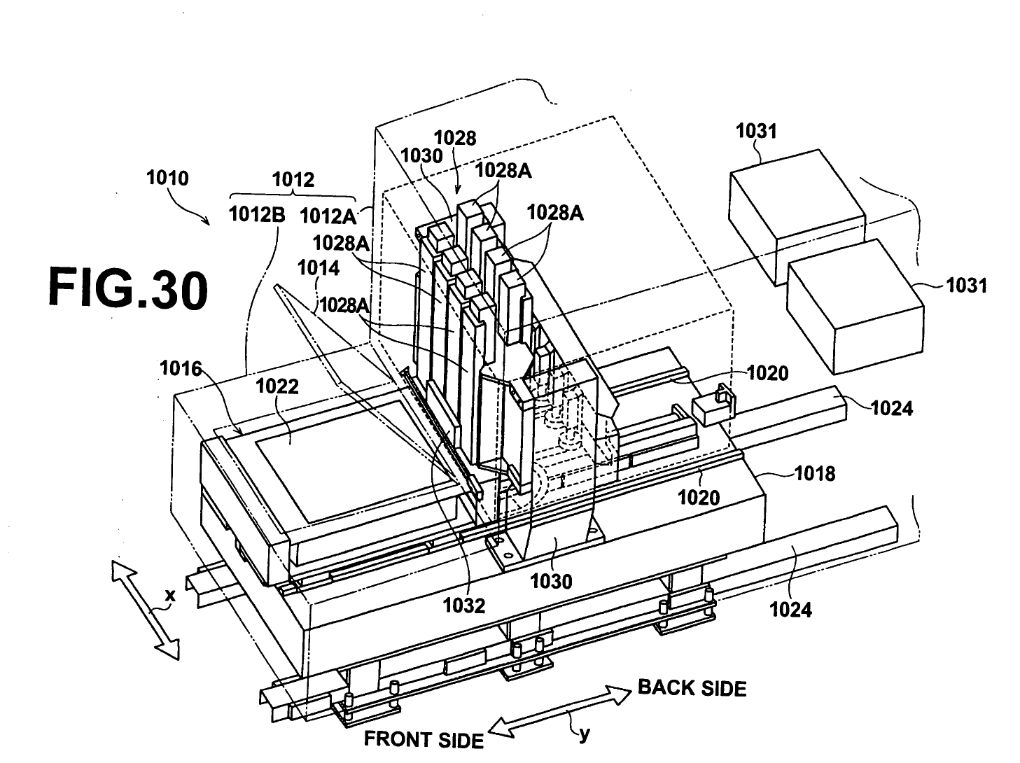

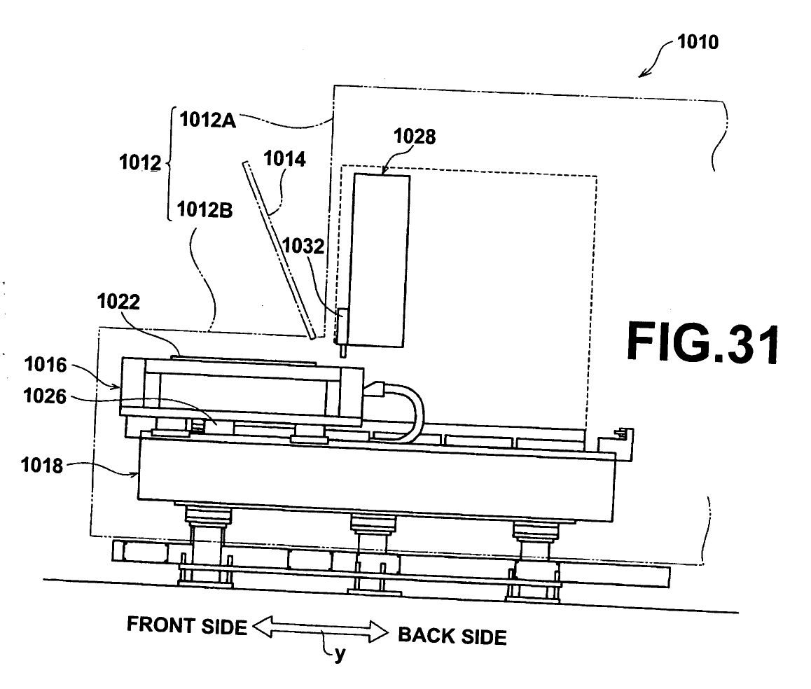

Next, an exposure apparatus according to another embodiment of the present invention will be described. FIGS. 30 and 31 illustrate a flatbed-type image exposure apparatus 1010 according to the present embodiment. In the image exposure apparatus 1010, each element is housed in a rectangular frame 1012 which is formed by combining rod-shaped square pipes in a frame shape. Further, a panel (not illustrated) is attached to the frame 1012 so as to separate the inside of the frame 1012 from the outside of the frame 1012.

The frame 1012 includes a tall housing portion 1012A, a stage portion 1012B, which projects from a side of the housing portion 1012A. The upper surface of the stage portion 1012B is lower than the housing portion 1012A. When an operator stands in front of the stage portion 1012B, the upper surface of the stage portion 1012B is substantially positioned at the height of the waist of the operator. A lid 1014 for opening/closing is provided on the upper surface of the stage portion 1012B. Further, a hinge (not illustrated) is attached to a side of the lid for opening/closing. The hinge is attached to the housing portion 1012A side of the lid 1014 for opening/closing. Therefore, the lid 1014 for opening/closing can be opened and closed by moving the lid 1014 with respect to the side.

When the lid 1014 for opening/closing is open, an exposure stage 1016 on the upper surface of the stage portion 1012B can be exposed. The exposure stage 1016 is supported by a pair of slide rails 1020 which are arranged along the longitudinal direction of a surface plate 1018. The exposure stage 1016 can slide in the y-direction in FIG. 30 by the drive force of a linear motor 1026 (please refer to FIG. 31) provided under the exposure stage 1016. Further, a linear encoder 1027 (not illustrated) is provided under the exposure stage 1016, and the linear encoder 1027 outputs a pulse signal based on the movement of the exposure stage 1016. Accordingly, it is possible to detect position information and sub-scan speed of the exposure stage 1016 along the slide rail 1020 based on the pulse signal. A photosensitive material 1022 is positioned on the exposure stage 1016.

Further, an exposure head unit 1028 is arranged approximately at the middle of the movement path (in the y-direction in FIG. 30) of the exposure stage 1016 on the surface plate 1018. The exposure head unit 1028 is installed to connect a pair of support posts 1030, each of which is erected on the outside of an edge on either side of the surface plate 1018 in the width direction of the surface plate 1018. Specifically, a gate is formed so that the exposure stage 1016 passes between the exposure head unit 1028 and the surface plate 1018.

In the exposure head 1028, a plurality of head assemblies 1028A is arranged along the width direction of the surface plate 1018. The photosensitive material 1022 can be exposed to light by illuminating the photosensitive material 1022 on the exposure stage 1016 with a plurality of light beams (which will be described in detail later). The plurality of light beams are emitted from the head assemblies 1028A at predetermined timing while the exposure stage 1016 is moved forward and backward.

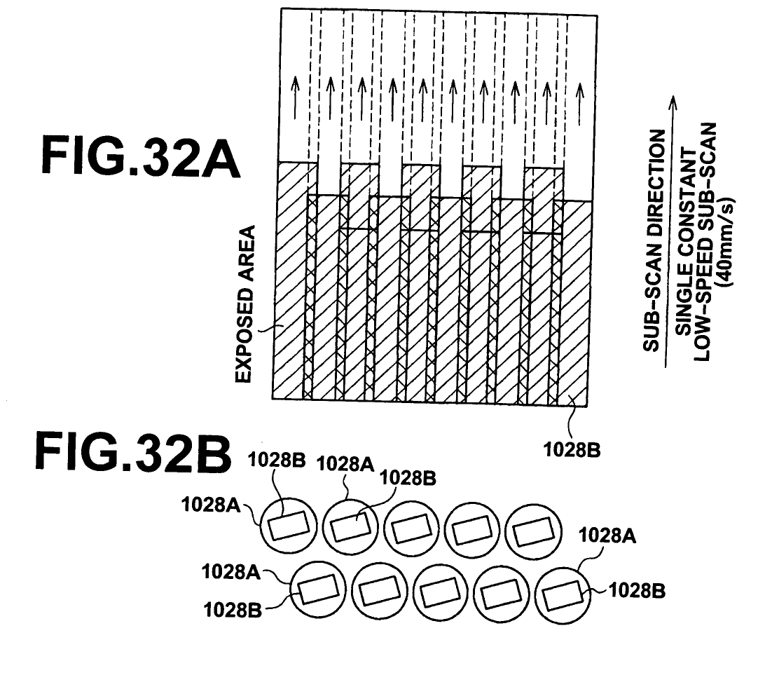

As illustrated in FIG. 32B, the head assemblies 1028A forming the exposure head unit 1028 is substantially arranged in a form of a matrix of m rows×n columns (for example, 2 rows×5 columns). The plurality of head assemblies 1028A is arranged in a direction orthogonal to the movement direction (hereinafter, referred to as a sub-scan direction) of the exposure stage 1016. In the present embodiment, ten head assemblies 1028A in total are arranged in two rows based on the width of the photosensitive material 1022.

Here, the shape of an exposed area 1028B by a single head assembly 1028A is a rectangle with its shorter side parallel to the sub-scan direction. Further, the exposed area 1028A is tilted at a predetermined tilt angle with respect to the sub-scan direction. A band-shaped exposed area is formed by each of the head assemblies 1082A on the photosensitive material 1022 as the exposure stage 1016 moves (please refer to FIG. 32A).

As illustrated in FIG. 30, a light source unit 1031 is provided in the housing portion 1012A. The light source unit 1031 is arranged at a separate position so as not to block the movement of the exposure stage 1016 on the surface plate 1018. A plurality of lasers (semiconductor lasers) is housed in the light source unit 1031, and light emitted from each of the lasers is guided to respective head assemblies 1028A through an optical fiber (not illustrated).

Each of the head assemblies 1028A controls the incident light beam, which has been guided by the optical fiber, using a digital micromirror device (DMD) (not illustrated). The DMD is a spatial light modulation device. The DMD controls each dot of the light beam, and the photosensitive material 1022 is exposed to light in a dot pattern. In the present embodiment, the density of a single pixel is expressed using a plurality of dot patterns, as described above.

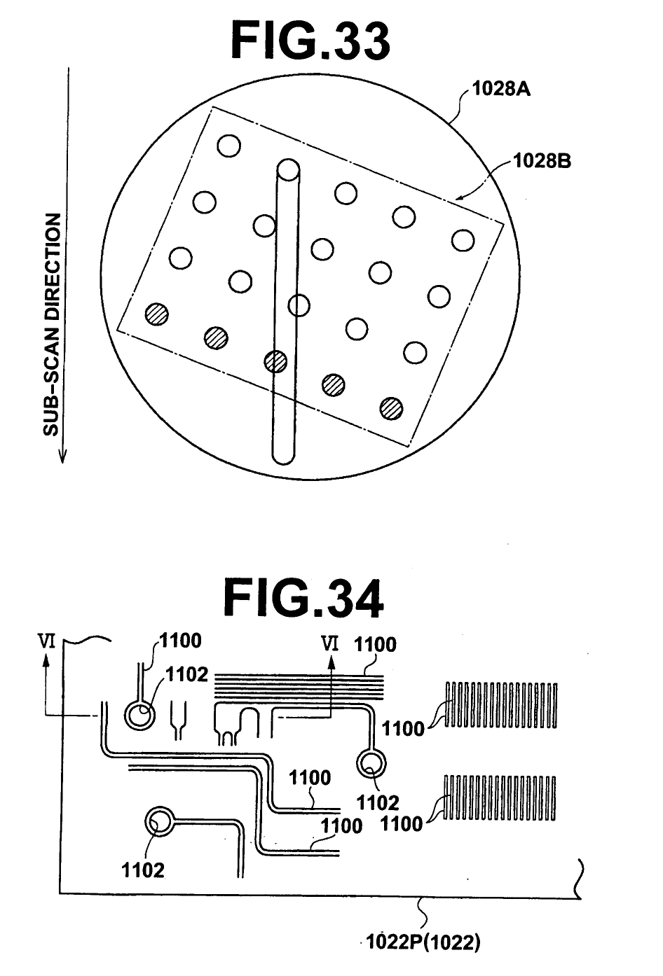

As illustrated in FIG. 33, the band-shaped exposed area 1028B (a single head assembly 1028A) is formed by 20 dots which are two-dimensionally arranged (for example, 4×5).

Further, since the two-dimensionally arranged dot pattern is tilted with respect to the sub-scan direction, each of the dots arranged in the sub-scan direction passes between dots arranged in the direction perpendicular to the sub-scan direction. Therefore, it is possible to substantially narrow a pitch between the dots, and thereby achieving high resolution.

Here, in the stage portion 1012B (please refer to FIG. 30), exposure processing is performed on the photosensitive material 1022 positioned on the exposure stage 1016 in each of the forward movement and the backward movement of the exposure stage 1016 by placing the photosensitive material 1022 on the exposure stage 1016. The forward movement is a movement in which the exposure stage 1016 moves to the back side along the slide rail 1020 on the surface plate 1018. The backward movement is a movement in which the exposure stage 1016 returns from the back side edge of the surface plate 1018 to the front side. When the exposure stage 1016 is moved forward and backward, exposure processing on the photosensitive material 1022 is completed.

Further, an alignment unit 1032 is provided as a unit for obtaining position information about the photosensitive material 1022. The alignment unit 1032 is arranged at a position adjacent to the exposure head unit 1028. The alignment unit 1032 is arranged on the exposure stage 1016 side of the exposure head unit 1028. The alignment unit 1032 emits light to the photosensitive material 1022 on the exposure stage 1016 and photographs the reflected light of the emitted light. Accordingly, the alignment unit 1032 detects a mark on the photosensitive material 1022.

The relative positional relationship between the exposure stage 1016 and the photosensitive material 1022 is determined by the position of the photosensitive material 1022 placed by an operator. Therefore, there is a possibility that the relative positional relationship is slightly shifted from a desired condition. If a shift in the position of the photosensitive material 1022 is recognized based on the photographed mark, the relative positions of the photosensitive material 1022 and an image are adjusted as desired by correcting exposure timing. The exposure timing is timing of exposure by the exposure head unit 1028 which has a known relative relationship with the exposure stage 1016.

Here, the photosensitive material 1022 in the present embodiment is a printed circuit board 1022P (please refer to FIG. 34). The image exposure apparatus 1010 has a function for forming an appropriate printed circuit pattern by exposing a photosensitive layer applied to the surface of the printed circuit board 1022P.

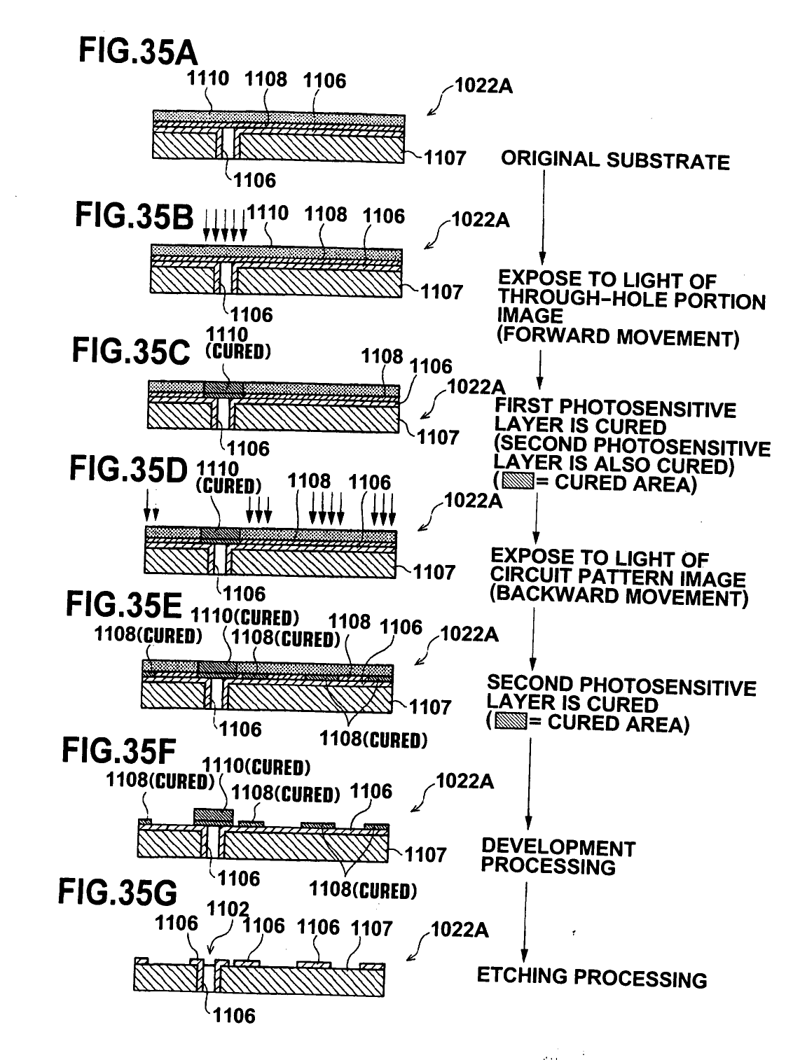

In the printed circuit board 1022P (completed state) which is adopted in the present embodiment, a printed circuit pattern 1100 which is appropriately formed with copper foil is provided. Further, a through-hole 1102, of which the diameter is approximately 3 mm, is provided at an appropriate position of the printed circuit board 1022P. Further, copper foil 1106 (please refer to FIG. 35G) is formed at the periphery of the through-hole 1102 and on the inner wall of the through-hole 1102. For example, the through-hole 1102 is adopted as a position to which an electronic part is electrically or structurally connected. Alternatively, the through-hole 1102 is adopted as a portion for conducting electricity between printed circuit patterns which are provided on both sides of the printed circuit board 1022P.

The printed circuit board 1022P is produced from an original substrate 1022A, as illustrated in FIG. 35A.

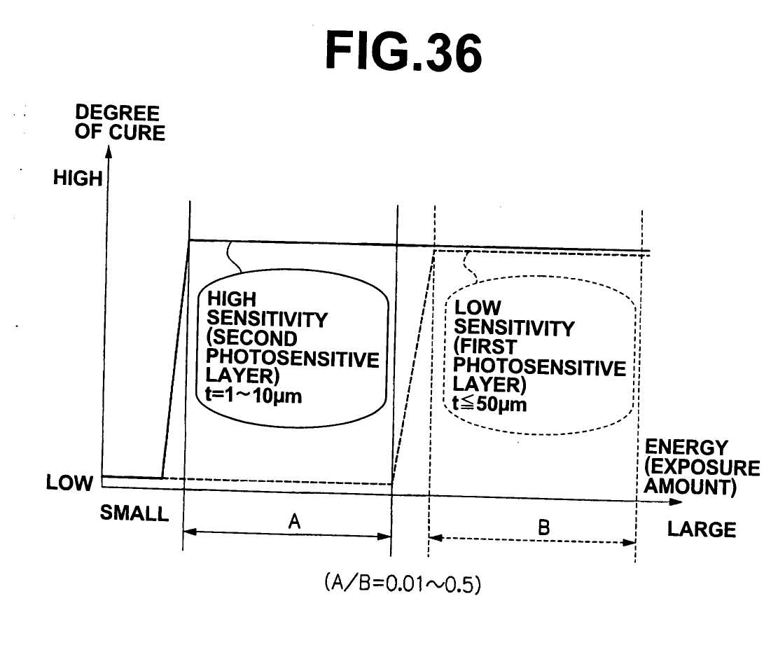

In the original substrate 1022A, copper foil 1106 is attached (by vapor deposition) to a surface (or the surfaces on both sides) of a support member 1107. Further, a thin second photosensitive layer 1108 and a thick first photosensitive layer 1110 are sequentially applied to the upper surface of the copper foil 1106 in this order. Since the sensitivity of the second photosensitive layer 1108 is relatively high, the second photosensitive layer 1108 is cured at a small exposure amount. In contrast, since the sensitivity of the first photosensitive layer 1110 is low, the first photosensitive layer 1110 is cured only at a large exposure amount (please refer to FIG. 36). In FIG. 35A, a protective film or the like is omitted.

The original substrate 1022A is loaded on the exposure stage 1016, and the exposure stage 1016 is moved forward and backward in the sub-scan direction. When the exposure stage 1016 is moved, exposure is performed at different exposure amounts between the forward movement and the backward movement. In the forward movement, a through-hole portion area, which is a low-sensitivity area, is exposed to light (please refer to FIG. 35B) to expose the first photosensitive layer 1110 to light (please refer to FIG. 35C). In the backward movement, a circuit pattern area, which is a high-sensitivity area, is exposed to light (please refer to FIG. 35D) to expose the second photosensitive layer 1108 to light (exposure amount control will be described later).

Since the exposure amounts are changed between the forward movement and the backward movement, an area of the first photosensitive layer 1110 cured by exposure is different from an area of the second photosensitive layer 1108 cured by exposure (please refer to FIG. 35E). When development processing is performed in a state in which the photosensitive layers (the first photosensitive layer 1110 and the second photosensitive layer 1108) have been cured (please refer to FIG. 35F), only the cured portion of the photosensitive material remains, and the uncured portion is removed.

Further, when etching processing is performed, the exposed portion of the copper foil 1106 and the cured photosensitive layers (the first photosensitive layer 1110 and the second photosensitive layer 1108) dissolve. Accordingly, it is possible to produce the printed circuit board 1022P in a completed state (please refer to FIG. 35G).

As described above, in the present embodiment, when the exposure stage 1016 moves forward and backward, exposure processing is separately performed in the forward movement and in the backward movement so as to expose each of two kinds of photosensitive layers at a different exposure amount.

Specifically, in the forward movement, exposure processing directed to the first photosensitive layer 1110 is performed to maintain a tenting characteristic (protectiveness of coating) of the through-hole portion. In the backward movement, exposure processing directed to the second photosensitive layer 1108 is performed to achieve high resolution of the circuit pattern. In the present embodiment, an exposure processing operation directed to the first photosensitive layer 1110 and an exposure processing operation direct to the second photosensitive layer 1108 are performed at different time. Therefore, it is possible to perform optimum exposure processing for each of the first photosensitive layer 1110 and the second photosensitive layer 1108 without interference therebetween.

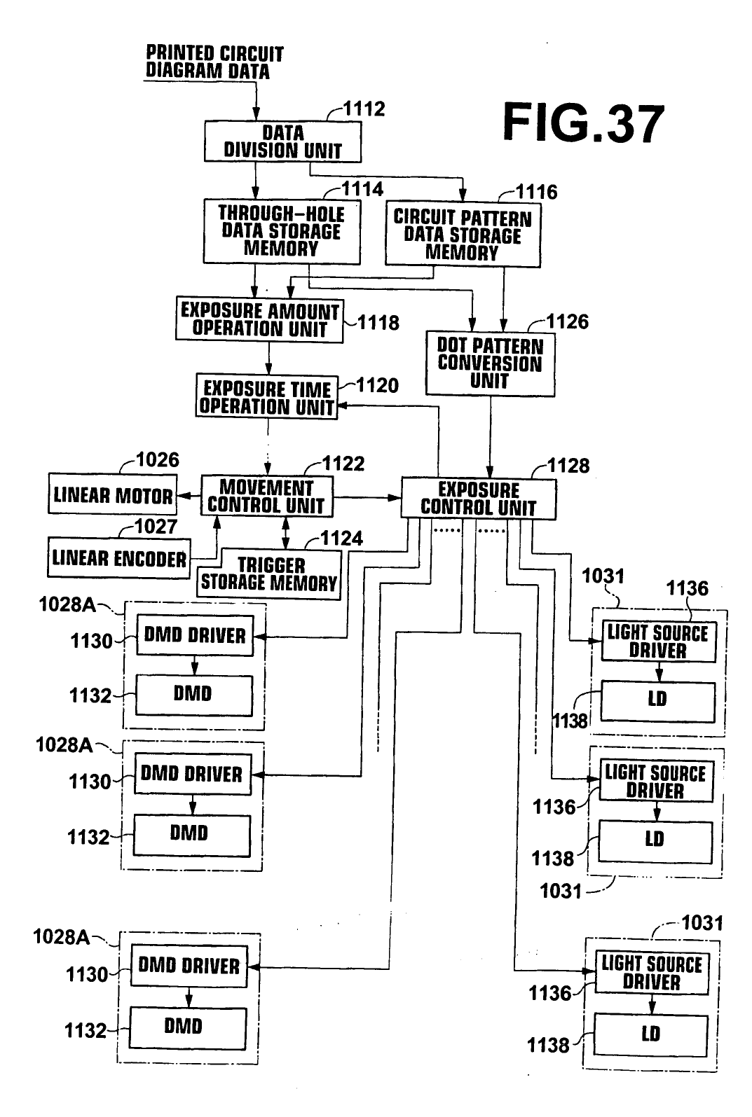

FIG. 37 is a functional block diagram illustrating a control operation in exposure. In the image exposure apparatus 1010 according to the present embodiment, exposure is performed in the forward movement and in the backward movement when the exposure stage 1016 moves forward and backward. A CPU (central processing unit), which is not illustrated in FIG. 37, is provided, and the CPU outputs an instruction for starting exposure processing in the forward movement and an instruction for starting exposure processing in the backward movement.

A data division unit 1112 is connected to a through-hole data storage memory 1114 and a circuit pattern data storage memory 1116. When printed circuit diagram data (generated in a circuit designing process before the present embodiment) is input to the data division unit 1112, the data division unit 1112 identifies a circuit pattern portion and a through-hole portion based on the printed circuit diagram data. Then, the data division unit 1112 divides the printed circuit diagram data into through-hole portion image data and circuit pattern portion image data. The through-hole portion image data is low-sensitivity portion image data, and the circuit pattern portion image data is high-sensitivity portion image data. The data division unit 1112 stores the through-hole portion image data in the through-hole data storage memory 1114. The data division unit 1112 stores the circuit pattern portion image data in the circuit pattern portion data storage memory 1116.

An exposure amount operation unit 1118 is connected to the through-hole data storage memory 1114, the circuit pattern data storage memory 1116, an exposure time operation unit 1120 and the CPU (not illustrated). When the exposure amount operation unit 1118 receives an instruction for starting exposure in the forward movement from the CPU (not illustrated), the exposure amount operation unit 1118 reads the through-hole portion image data from the through-hole data storage memory 1114. Then, the exposure amount operation unit 1118 performs an operation for obtaining a necessary exposure amount (hereinafter, referred to as a through-hole portion necessary exposure amount) for exposing the first photosensitive layer 1110 to light in a pattern based on the through-hole portion image data for each exposure position on the printed circuit board.

When the exposure amount operation unit 1118 receives an instruction for starting exposure in the backward movement from the CPU (not illustrated), the exposure amount operation unit 1118 reads the circuit pattern portion image data from the circuit pattern data storage memory 1116, and performs an operation for obtaining a necessary exposure amount (hereinafter, referred to as a circuit pattern portion necessary exposure amount) for exposing the second photosensitive layer 1108 to light in a pattern based on the circuit pattern portion image data for each exposure position on the printed circuit board. Each of the obtained necessary exposure amounts is sent to an exposure time operation unit 1120.

The exposure time operation unit 1120 is connected to the exposure amount operation unit 1118, a movement control unit 1122 and an exposure control unit 1128. The exposure time operation unit 1120 received light amount data, which is output from a light source unit 1031, from the exposure control unit 1128 (will be described later). The exposure time operation unit 1120 also receives each of necessary exposure amounts output from the exposure amount operation unit 1118. Then, the exposure time operation unit 1120 performs an operation to obtain exposure time for achieving each of the necessary exposure amounts based on the light amount data. Specifically, the exposure time operation unit 1120 performs an operation for obtaining exposure time (hereinafter, referred to as through-hole portion exposure time) for achieving the through-hole portion necessary exposure amount in the exposure processing in the forward movement. The exposure time operation unit 1120 performs an operation for obtaining exposure time (hereinafter, referred to as circuit pattern portion exposure time) for achieving the circuit pattern portion necessary exposure amount in the exposure processing in the backward movement. The exposure time operation unit 1120 sends the obtained exposure time to the movement control unit 1122.

The movement control unit 1122 is connected to a linear motor 1026, a linear encoder 1027, the exposure time operation unit 1120, a trigger storage memory 1124 and the exposure control unit 1128. The movement control unit 1122 receives the through-hole portion exposure time from the exposure time operation unit 1120 in the exposure processing in the forward movement. The movement control unit 1122 receives the circuit pattern portion exposure time from the exposure time operation unit 1120 in the exposure processing in the backward movement. The movement control unit 1122 controls the movement of the linear motor 1026 based on the exposure time in each of the forward movement and the backward movement, and moves the exposure stage 1016 forward and backward. When the movement control unit 1122 performs processing, as described above, the movement control unit 1122 detects a pulse output from the linear encoder 1027 to detect position information about the exposure stage 1016 and sub-scan speed. The pulse is generated by the movement of the exposure stage 1016. Specifically, the movement control unit 1122 detects the position information about the exposure stage 1016 along the slide rail 1020 by counting the number of pulses from the start position of exposure processing in each of the forward movement and the backward movement. Then, the movement control unit 1122 detects the sub-scan speed by measuring a pulse interval (time interval between detection of pulses). The movement control unit 1122 controls the movement of the linear motor 1026 based on the detected sub-scan speed so that sub-scan is performed at desired speed. Further, the movement control unit 1122 sends the position information about the exposure stage 1016 to the exposure control unit 1128.

Further, the movement control unit 1122 performs an operation for obtaining the number of pulses to reach a position for starting exposure for the through-hole portion. The movement control unit 1122 obtains the number of pulses based on the through-hole portion exposure time for each of exposure position in the exposure processing in the forward movement (exposure processing of through-hole portion image data). Further, the movement control unit 1122 stores the obtained number of pulses as an exposure position trigger in the trigger storage memory 1124. Processing is performed in such a manner so as to reduce total processing time by increasing the sub-scan speed in the area (area between dispersed through-holes) other than the through-hole portions. The sub-scan speed in the area other than the through-hole portions is increased because the exposure processing in the forward movement is performed to expose only the through-holes dispersed on the printed circuit board. When the number of detected pulses generated by the movement of the exposure stage 1016 reaches the value of the exposure position trigger, the movement control unit 1122 controls the sub-scan speed and performs exposure for the through-hole portions. When exposure for the through-hole portions ends, the movement control unit 1122 increases the sub-scan speed.

A dot pattern data conversion unit 1126 is connected to the through-hole data storage memory 1114, the circuit pattern storage memory 1116, the exposure control unit 1128 and the CPU (not illustrated). When the dot pattern data conversion unit 1126 receives an instruction for starting exposure in the forward movement from the CPU (not illustrated), the dot pattern data conversion unit 1126 reads the through-hole portion image data from the through-hole data storage memory 1114 and converts the read data into dot pattern data. Further, when the dot pattern data conversion unit 1126 receives an instruction for starting exposure in the backward movement from the CPU (not illustrated), the dot pattern data conversion unit 1126 reads the circuit pattern portion image data from the circuit pattern data storage memory 1116, and converts the read data into dot pattern data. The converted dot pattern data is sent to the exposure control unit 1128.

The exposure control unit 1128 is connected to the exposure time operation unit 1120, the movement control unit 1122, the dot pattern conversion unit 1126, each of head assemblies 1028A and each of light source units 1031. The exposure control unit 1128 receives the position information about the exposure stage 1016 from the movement control unit 1122. The exposure control unit 1128 receives each set of dot pattern data from the dot pattern conversion unit 1126. The exposure control unit 1128 controls a DMD driver 1130 in each of the plurality of head assemblies 1028A to control ON/OFF of the DMD 1132 at each position of the movement of the exposure stage 1016. The exposure control unit 1128 controls the DMD driver 1130 based on the dot pattern data which is obtained by converting the through-hole portion image data in the forward movement. The exposure control unit 1128 controls the DMD driver 1130 based on the dot pattern data which is obtained by converting the circuit pattern portion image data in the backward movement. Further, the exposure control unit 1128 sends a lighting signal to a light source driver 1136 of the light source unit 1031 to turn on an LD (semiconductor laser) 1138.

Further, the exposure control unit 1128 sends a light amount of LD's 1138 turned on in each of exposure in the forward movement and exposure in the backward movement as light amount data to the exposure time operation unit 1120. In the present embodiment, all of the LD's 1138 are turned on (a maximum light amount) in both of the forward movement and the backward movement. Therefore, the light amount data sent to the exposure time operation unit 1120 in exposure in the forward movement is the same as the light amount data sent in exposure in the backward movement.

The action of the present embodiment will be described. Exposure processing on the photosensitive material 1022 (please refer to FIG. 30) is performed when the exposure stage 1016, on the surface of which the photosensitive material 1022 is attached by suction, passes under the exposure head unit 1028. In exposure in the forward movement, the movement control unit 1122 (please refer to FIG. 37) controls the linear motor 1026 and moves the exposure stage 1016 along the slide rail 1020 on the surface plate 1018 from the stage portion 1012B to the back side of the housing portion 1012A.

When the exposure stage 1016 passes under the alignment unit 1032, the alignment unit 1032 (please refer to FIG. 31) detects a mark which has been provided on the photosensitive material 1022 in advance. The mark is compared with a mark which has been stored in advance. Then, exposure timing by the exposure head unit 1028 is corrected based on the positional relationship between the detected mark and the stored mark. Exposure processing in the forward movement and exposure processing in the backward movement are performed based on the corrected exposure timing.

In the exposure head unit 1028, the DMD is illuminated with laser light at the corrected exposure timing based on the position information about the exposure stage 1016 and the dot pattern data which has been converted from the through-hole portion image data. When a micromirror in the DMD is ON, reflected laser light is guided to the photosensitive material 1022 through an optical system. Accordingly, an image is formed on the photosensitive material 1022 (please refer to FIG. 35B).

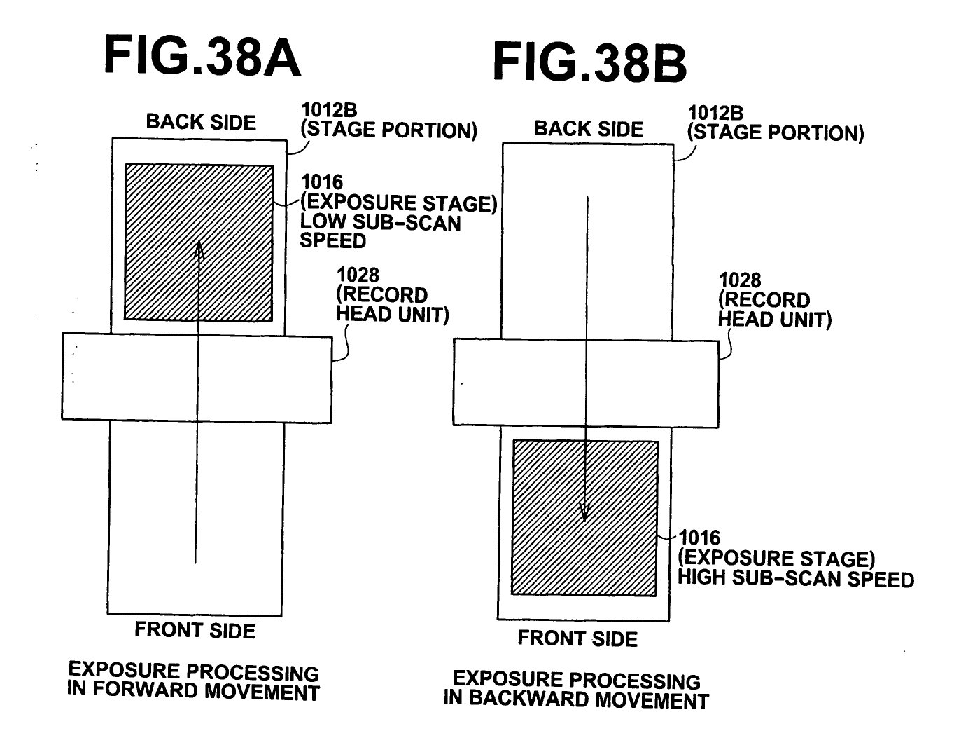

The movement control unit 1122 (please refer to FIG. 37) lowers the sub-scan speed of the exposure stage 1016, as illustrated in FIG. 38A, so as to cure the first photosensitive layer 1110 on the photosensitive material 1022 in the through-hole portion. When the sub-scan speed is lowered, exposure time, in which the first photosensitive layer 110 is exposed to laser light emitted from the exposure head unit 1028, becomes longer. Therefore, a necessary exposure amount for curing the first photosensitive layer 1110 is achieved.

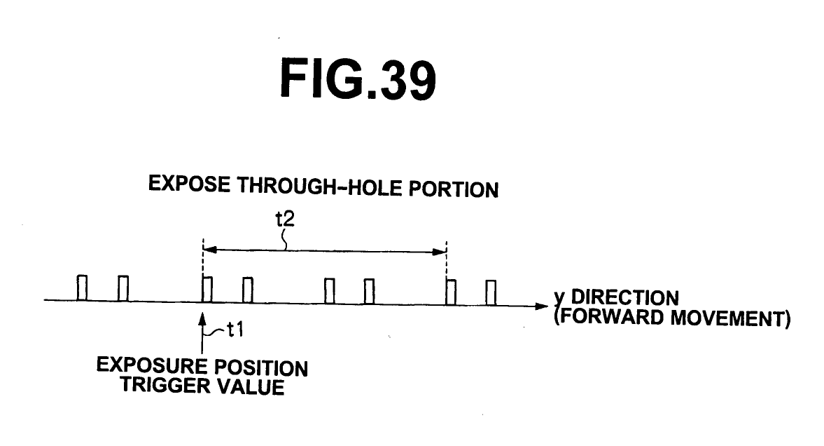

Further, the movement control unit 1122 increases the sub-scan speed in the area other than the through-hole portion because exposure is not performed in the area other than the through-hole portion. Specifically, as illustrated in FIG. 39, when the counted number of pulses output from the linear encoder 1027 reaches the exposure position trigger value (arrow t1 in FIG. 39) stored in the trigger storage memory 1124 (please refer to FIG. 37) as the exposure stage 1016 moves, the sub-scan speed of the exposure stage 1016 is lowered to perform exposure for the through-hole portion (period t2 in FIG. 39). When exposure for the through-hole portion ends, the sub-scan speed is increased.

When the exposure stage 1016 (please refer to FIG. 30) reaches the end of the forward movement, exposure processing in the forward movement ends, and exposure processing in the backward movement starts. In the exposure processing in the backward movement, the movement control unit 1122 (please refer to FIG. 37) controls the linear motor 1026 to move the exposure stage 1016 (please refer to FIG. 31) from the back side of the housing portion 1012A toward the front side.

In the exposure head unit 1028, the DMD is illuminated with laser light based on the position information about the exposure stage 1016 and the dot pattern data which has been converted from the circuit pattern portion image data in a manner similar to the exposure processing in the forward movement. Accordingly, an image is formed with the laser light reflected by the DMD on the photosensitive material 1022 (please refer to FIG. 35D).

The movement control unit 1122 increases the sub-scan speed of the exposure stage 1016, as illustrated in FIG. 38B, to cure the second photosensitive layer 1108. If the sub-scan speed is increased, exposure time, in which the photosensitive material is illuminated with the laser light, becomes shorter. Therefore, a necessary exposure amount for curing only the second photosensitive layer 1108 can be achieved.

In the present embodiment, the sub-scan speed of the exposure stage 1016 is controlled, as described above. Therefore, a tent characteristic (protectiveness of coating) of the through-hole portion area can be maintained in the exposure processing in the forward movement by exposing the first photosensitive layer 1110 to light based on the through-hole portion image data. Further, high resolution of the circuit pattern area can be achieved by exposing the second photosensitive layer 1108 to light based on the circuit pattern portion image data.

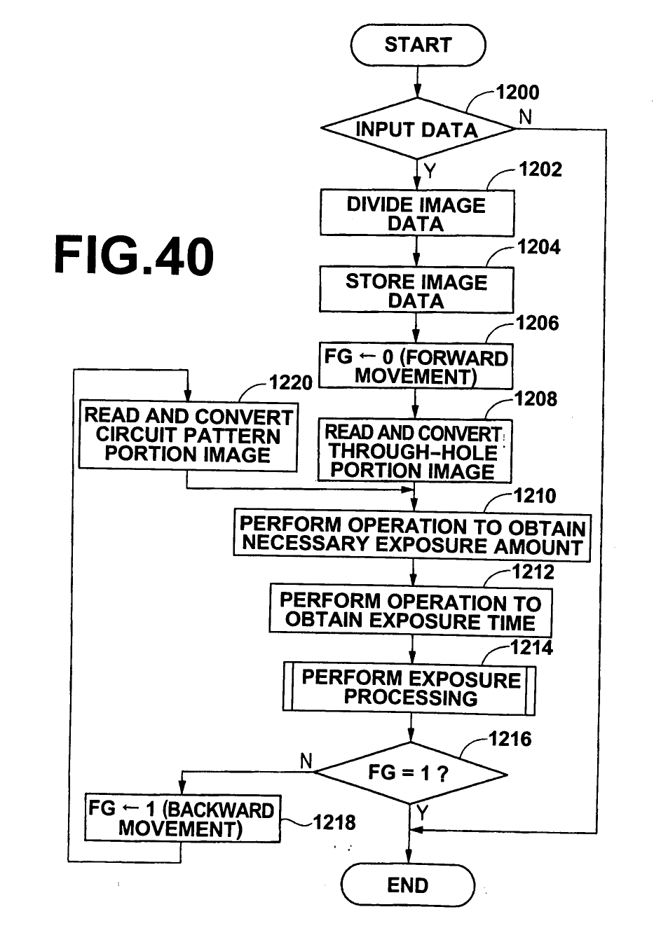

A flow of processing in an image data division process, a divided image data processing process, an exposure control process in the forward movement and an exposure control process in the backward movement will be described with reference to the flow chart illustrated in FIG. 40.

In step 1200, judgment is made as to whether printed circuit diagram data has been input. If the judgment is YES, processing goes to step 1202. In step 1202, a circuit pattern and a through-hole portion in the input printed circuit diagram data are identified. Then, the printed circuit diagram data is divided into through-hole portion image data and circuit pattern portion image data, and processing goes to step 1204.

In step 1204, the through-hole portion image data is stored in the through-hole data storage memory 1114 (please refer to FIG. 37). The circuit pattern portion image data is stored in the circuit pattern data storage memory 1116. Then, processing goes to step 1206. In step 1206, exposure processing in the forward movement starts, and a forward/backward processing flag FG in exposure is set to 0, which indicates a forward movement. Then, processing goes to step 1208.

In step 1208, the exposure amount operation unit 1118 and the dot pattern conversion unit 1126 read the through-hole portion image data from the through-hole data storage memory 1114 so as to perform exposure processing in the forward movement. Further, the dot pattern conversion unit 1126 converts the through-hole portion image data into dot pattern data. Then, processing goes to step 1210.

In step 1210, an operation is performed to obtain a necessary exposure amount for exposing the photosensitive layer to light in a pattern based on each image data in each of exposure processing in the forward movement and exposure processing in the backward movement. Specifically, in exposure processing in the forward movement (the forward/backward processing flag FG is 0), an operation is performed to obtain a necessary exposure amount for exposing the first photosensitive layer 1110 to light in a pattern based on the through-hole portion image data. In exposure processing in the backward movement (forward/backward processing flag FG is 1), an operation is performed to obtain a necessary exposure amount for exposing the second photosensitive layer 1108 to light in a pattern based on the circuit pattern portion image data. Then, processing goes to step 1212.

In step 1212, an operation for obtaining exposure time for achieving the necessary exposure amount obtained in step 1210 is performed for each exposure position. The exposure time is obtained based on light amount data (light amount output from the light source unit 1031) sent from the light source unit 1031. Then, processing goes to step 1214.

In the exposure processing in the forward movement (the forward/backward processing flag FG is 0), an operation is performed to obtain the number of pulses for reaching a position for starting exposure of the through-hole portion. The obtained number of pulses is stored as an exposure position trigger in the trigger storage memory 1124.

In step 1214, exposure processing is performed based on the dot pattern data converted from the image data (the through-hole portion image data in the forward movement and the circuit pattern portion image data in the backward movement) and the exposure time obtained by the operation. The exposure processing in the forward movement and the exposure processing in the backward movement are performed, as described at the beginning of the description of the action of the present embodiment.

In step 1216, judgment is made, based on the forward/backward processing flag FG, as to whether backward (1) processing has ended. If the judgment is NO, the exposure processing in the backward movement has not been performed. Therefore, processing goes to step 1218. Then, the forward/backward processing flag F is set to 1, which indicates a backward movement, to start the exposure processing in the backward movement. Then, processing goes to step 1220.

In contrast, if the judgment is YES in step 1216, both of exposure processing in the forward movement and exposure processing in the backward movement have been finished. Therefore, processing ends.

In step 1220, the exposure amount operation unit 1118 and the dot pattern conversion unit 1126 read the circuit pattern portion image data in exposure processing in the backward movement. Further, the dot pattern conversion unit 1126 converts the read circuit pattern portion image data into dot pattern data. Then, processing goes to step 1210, and the exposure processing in the backward movement is performed.

As described above, in the present embodiment, it is possible to increase or decrease the exposure amount at the printed circuit board (photosensitive material 1022) by controlling the sub-scan speed of the exposure stage 1016 without increasing or decreasing the number of light sources. Further, the sub-scan speed of the exposure stage 1016 is controlled in each of exposure processing in the forward movement and exposure processing in the backward movement. Accordingly, the first photosensitive layer 1110 is exposed to light based on the through-hole portion image (low-sensitivity portion image) data. Further, the second photosensitive layer 1108 is exposed to light based on the circuit pattern portion image data (high-sensitivity portion image) data. Therefore, it is possible to improve the tenting characteristic (protectiveness of coating) of the through-hole portion and to achieve high resolution of the circuit pattern.

Further, in the present embodiment, a head assembly 1028A is used in the exposure head unit 1028, and a single pixel is expressed by a dot pattern. However, the exposure head unit 1028 may be an exposure head which does not have a dot pattern, and which emits light at a single light amount.

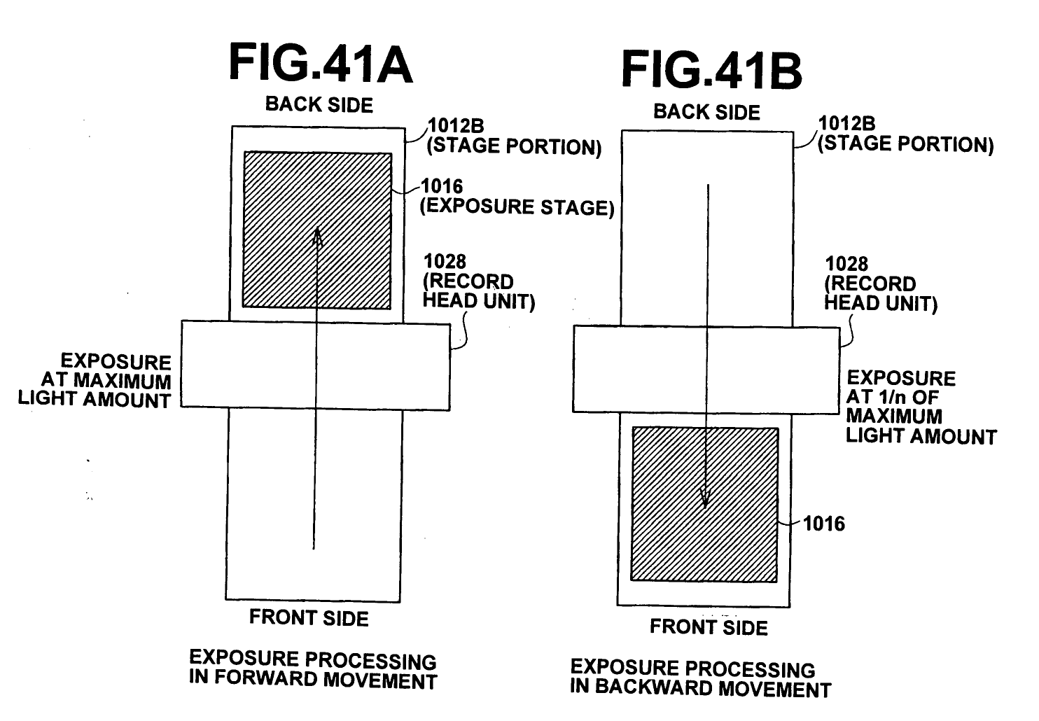

Further, in the present embodiment, the exposure amount at the printed circuit board is adjusted by controlling the sub-scan speed of the exposure stage 1016. Alternatively, the sub-scan speed may be kept constant, and the light amount may be controlled by switching a part of 20 dots which are two-dimensionally arranged (please refer to FIG. 33) in each head assembly 1028A to an OFF state. The part of 20 dots may be switched to an OFF state in exposure processing in the forward movement or the backward movement, thereby adjusting the exposure amount of light reaching the printed circuit board. In this case, for example, in exposure processing in the forward movement, the low-sensitivity first photosensitive layer 1110 may be exposed to light based on the through-hole portion image data by switching all of the dot patterns to an ON state (maximum light amount) (please refer to FIG. 41A). In exposure processing in the backward movement, the high-sensitivity second photosensitive layer 1108 may be exposed to light based on the circuit pattern portion image data by switching a part (for example, shaded dot patterns in FIG. 33) of the dot patterns to an OFF state (the light amount is 1/n of the maximum light amount) (please refer to FIG. 41B) Alternatively, a filter may be set on the exposure head to reduce the light amount in the exposure processing in the backward movement to 1/n of the maximum light amount. Then, the second photosensitive layer 1108 may be exposed to light based on the circuit pattern portion image data.

Next, an embodiment of an exposure apparatus, in which halftone exposure of a photosensitive material such as photoresist can be achieved at a low cost, will be described. In the following descriptions, only a structure for achieving the low-cost halftone exposure will be explained. As a structure for forming exposed areas on the photosensitive material at least at two different exposure amounts, various kinds of structures, as described above, may be appropriately adopted.

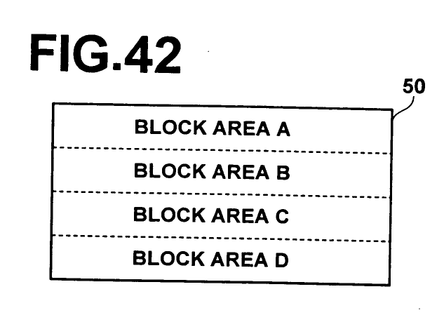

The exposure apparatus according to the present embodiment is a kind of parallel processing apparatus, as described above with reference to FIG. 18. The basic structure of the exposure apparatus according to the present embodiment is the same as that of the exposure apparatus illustrated in FIG. 1. The DMD 50 adopted in the exposure apparatus according to the present embodiment is divided into four block areas A through D, each including a plurality of micromirror rows, as illustrated in FIG. 42. Further, control signals for the block areas A through D are transferred to the respective block areas in parallel. The micromirror row is a row of micromirrors arranged in a direction of which the angle with respect to the sub-scan direction of exposure light is greater than an angle formed by micromirrors arranged in the other direction perpendicular to the direction of the micromirror row in the micromirrors 62 (please refer to FIG. 6).

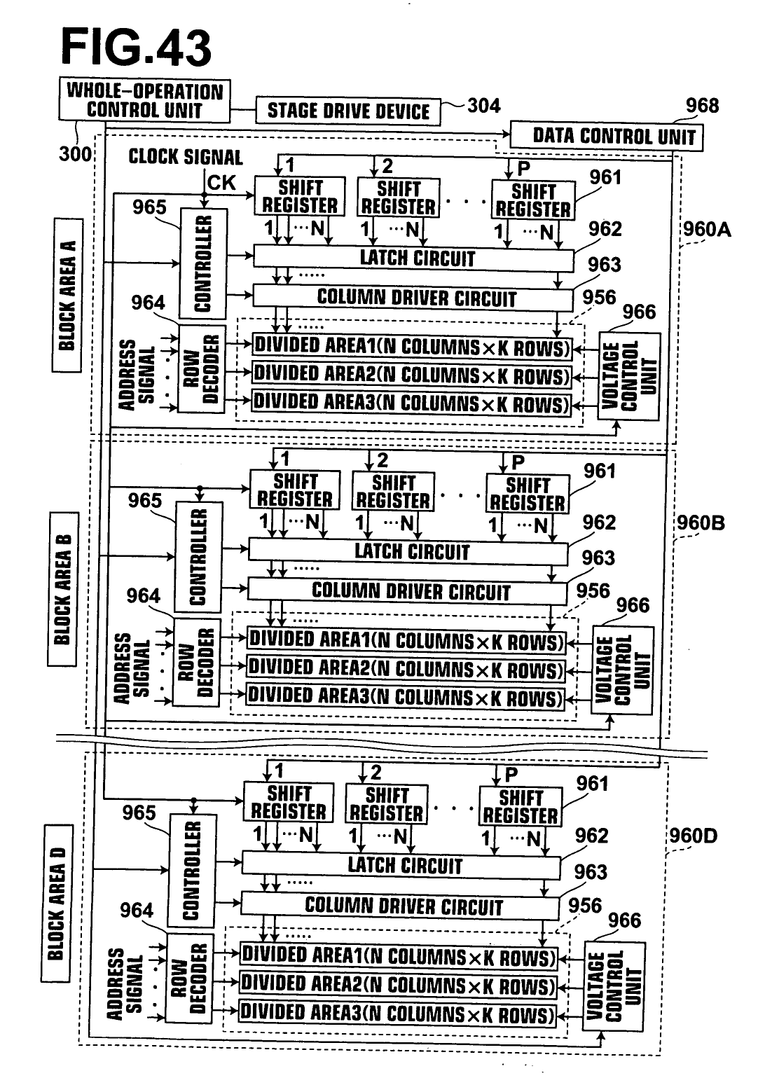

As described above, four control signal transfer units 960A through 960D for the block areas A through D are provided in each of the exposure heads 166 (please refer to FIG. 2), as illustrated in FIG. 43. The four control signal transfer units 960A thorough 960D are provided to transfer control signals to block areas A through D of the DMD 50 in parallel. In FIG. 43, the transfer signal transfer unit 960C is omitted. Further, in the present embodiment, the DMD is divided into four block areas. However, the DMD may be divided into any number of block areas, if the number of block areas is two or more.

Each of the control signal transfer units 960A through 960D includes P number of shift register circuits 961, a latch circuit 962 and a column driver circuit 963, as illustrated in FIG. 43. A clock signal CK is input from a controller 965 to each of the P number of shift register circuits 961, and a single control signal is simultaneously written, based on the clock signal CK, in each of the P number of shift register circuits 961. When N number of control signals are written in each of the P number of shift register circuits 961, a row of NXP number of control signals is transferred to the latch circuit 962.

Then, the row of control signals transferred to the latch circuit 962 is directly transferred to a column driver circuit 963. The row of control signals is output from the column driver circuit 963 and written in a predetermined row in an SRAM (static random access memory) array 956. A predetermined row in which the control signals are written is selected based on an address signal by a row decoder 964.

While the control signals are latched in the latch circuit 962 and written in the predetermined row of the SRAM array 956, as described above, controls signals for the next row are written in the shift register circuits 961. Timing at which the control signals are written in the shift register circuit 961, the latch circuit 962, the column driver circuit 963 and the SRAM array 956 is controlled by the controller 965.

Then, after the control signals are written in the SRAM array 956, as described above, a voltage control unit 966 applies a control voltage based on the written control signals to an electrode portion provided for each of the micromirrors 62. Accordingly, each of the micromirrors 62 is reset.

Here, the voltage control unit 966 provided for each of the block areas A through D can output a control voltage for each of three divided areas 1 through 3 in each of the block areas A through D. The three divided areas 1 through 3 are formed by further dividing each of the block areas A through D every K micromirror rows. In the present embodiment, each of the block areas A through D is divided into three divided areas. However, each of the block areas A through D may be divided into any number of areas, if the number of the divided areas is two or more.

Further, it is preferable that the number N of divided areas in each of the block areas A through D satisfies the following equation:

N=Tsr/Ttr,

where Ttr: reset time of each of the divided areas, and

Tsr: time for transferring a control signal to each of the divided areas.

Further, a whole-operation control unit 300 and a data control unit 968 are provided in the exposure apparatus according to the present embodiment, as illustrated in FIG. 43. The whole-operation control unit 300 controls the operation of the whole exposure apparatus. The data control unit 968 outputs control signals to the control signal transfer unit 960A through 960D in each of the exposure heads 166. The whole-operation control unit 300 controls processing for writing the control signals in the SRAM array 956 of the DMD 50, as described above. The whole-operation control unit 300 also controls the drive of the micromirrors 62. Further, the whole-operation control unit 300 controls the drive of the stage drive apparatus 304 which moves the stage 152 (please refer to FIG. 1).

Next, the action of the exposure apparatus according to the present embodiment will be described in detail. First, a predetermined data generation apparatus (not illustrated) generates image data corresponding to an image, which should be formed on the photosensitive material (for example, the photoresist 150a on the glass substrate 150 illustrated in FIG. 1) by exposure. The image data is output to the data control unit 968. Then, the data control unit 968 generates, based on the image data, a control signal which is output to each of the exposure heads 166. In the exposure apparatus according to the present embodiment, a control signal for each of the block areas A through D of the DMD 50 is transferred so that the drive of the micromirrors 62 in each of the block areas A through D is controlled. Therefore, the control signal is also generated for each of the block areas A through D.

The control signal for each of the exposure heads 166 is generated by the data control unit 968, as described above, and a stage drive control signal is output from the whole-operation control unit 300 to the stage drive apparatus 304. The stage drive apparatus 304 moves the stage 152, based on the stage drive control signal, at desired speed along the guide 158 in the stage movement direction. When the stage 152 passes under the gate 160, if the sensor 164 attached to the gate 160 detects a leading edge of the photoresist 150a, the data control unit 968 outputs a control signal to each of the exposure heads 166. Then, image drawing by each of the exposure heads 166 starts.

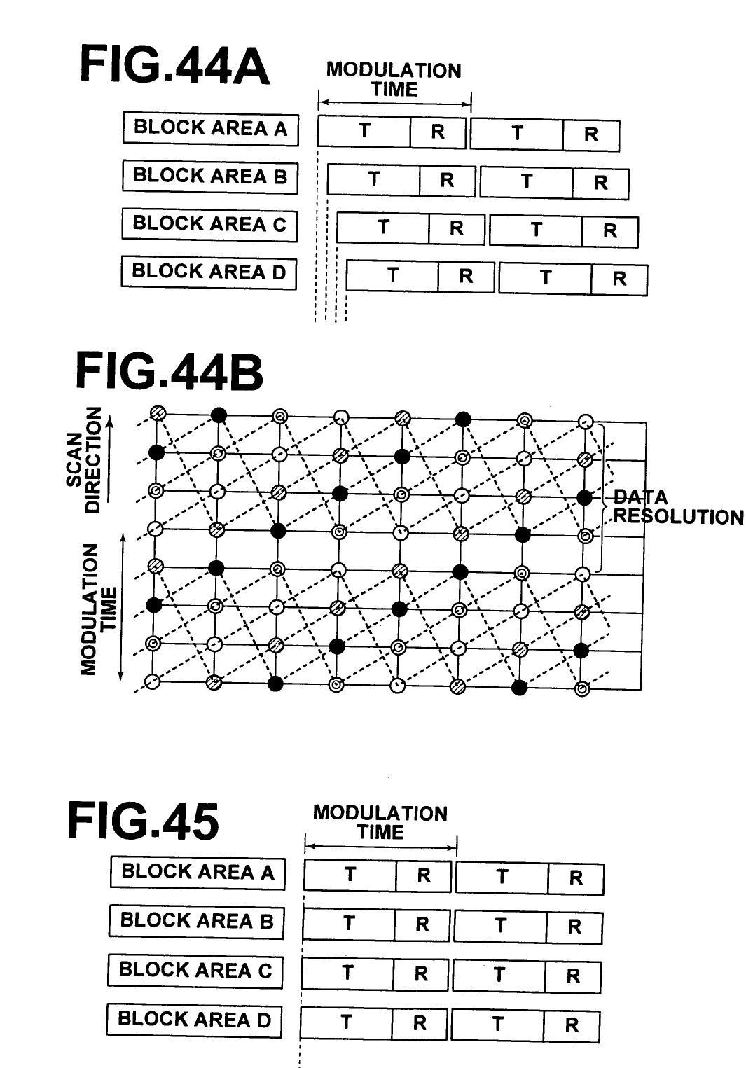

Here, control of the drive of the DMD 50 in each of the exposure heads 166 will be described in detail. First, the control signals for the block areas A through D in the DMD 50, generated as described above, are transferred from the data control unit 968 to respective control signal transfer units 960A through 960D. When the control signals are transferred, a row of control signals is transferred at one time. Control signals for each of the block areas A through D are transferred at the timing illustrated in FIG. 44A. In FIG. 44A, the letter “T” represents transfer, and the letter “R” represents reset. Specifically, the control signals are transferred to each of the block areas A through D at different timing, which is shifted from each other by predetermined time.

Then, each of the control signal transfer units 960A through 960D for the block areas A through D writes the control signals, which have been transferred as described above, in the SRAM array 966 for each of the block areas A though D, as described above.

Then, when transfer of the control signals for a block area ends, the micromirrors 62 in the block area are sequentially reset based on the transferred control signals, as illustrated in FIG. 44A.

FIG. 44B illustrates an example of points which are drawn on the photoresist 150a. The points are drawn by transferring control signals to each of the block areas A through D at the timing illustrated in FIG. 44A and by resetting the micromirrors 62 in each of the block areas A through D. In FIG. 44B, a white circle represents a point drawn by a micromirror 62 in a block area A. A double circle represents a point drawn by a micromirror in the block area B. A black circle represents a point drawn by a micromirror in the block area C. A shaded circle represents a point drawn by a micromirror in the block area D. Further, in the exposure apparatus according to the present embodiment, the DMD 50 is tilted with respect to the scan direction by an angle so that micromirrors 62 in each of the block areas A through D pass the same sub-scan line, as illustrated in FIG. 44B.

The timing of modulation in each of the block areas A through D is shifted from each other by predetermined time, as described above. Therefore, for example, as illustrated in FIG. 44B, points drawn by the micromirrors 62 in the block area B, the micromirrors 62 in the block area C and the micromirrors 62 in the block area D can be arranged in equal intervals between the points drawn by the micromirrors 62 of the block area A. Points of the block areas B through D drawn during modulation time of the block area A in FIG. 44B are not drawn in the same frame. The points of each of the block areas B through D are drawn in a different frame. Here, the frame is a single unit when processing for sequentially transferring control signals for the block areas A through D and processing for sequentially resetting the micromirrors 62 is regarded as a single processing unit.

Further, the drawn points of each of the block area B, the block area C and the block area D can be arranged in equal intervals between the drawn points of the block area A by shifting the modulation timing of each of the block areas A through D. Alternatively, the drawn points can be arranged, as described above, by controlling the sub-scan speed of the photoresist 150a. Specifically, the movement speed of the stage 152 may be controlled.

In the whole-operation control unit 300, movement speed of the stage 152 corresponding to a shift in modulation timing of each of the block areas A through D is set in advance. The stage drive apparatus 304 is controlled so that the stage 152 moves at the moving speed, which has been set in advance.

Further, in the exposure apparatus according to the present embodiment, the timing of modulation of each of the block areas A through D is shifted from each other, as described above. However, it is not necessary that the timing is shifted from each other. The control signals may be simultaneously transferred to each of the block areas A through D, as illustrated in FIG. 45. In FIG. 45, the letter “T” represents transfer, and the letter “R” represents reset. Accordingly, the micromirrors in each of the block areas A through D may be simultaneously reset, as illustrated in FIG. 45.

Alternatively, the moving speed of the stage 152 may be set at desired speed in advance, and modulation timing of each of the block areas A through D may be controlled or set relative to the set moving speed.

Alternatively, the modulation timing of each of the block areas A through D or the moving speed of the stage 152 may be controlled so that the drawn points of each of the block areas A through D overlap with each other.

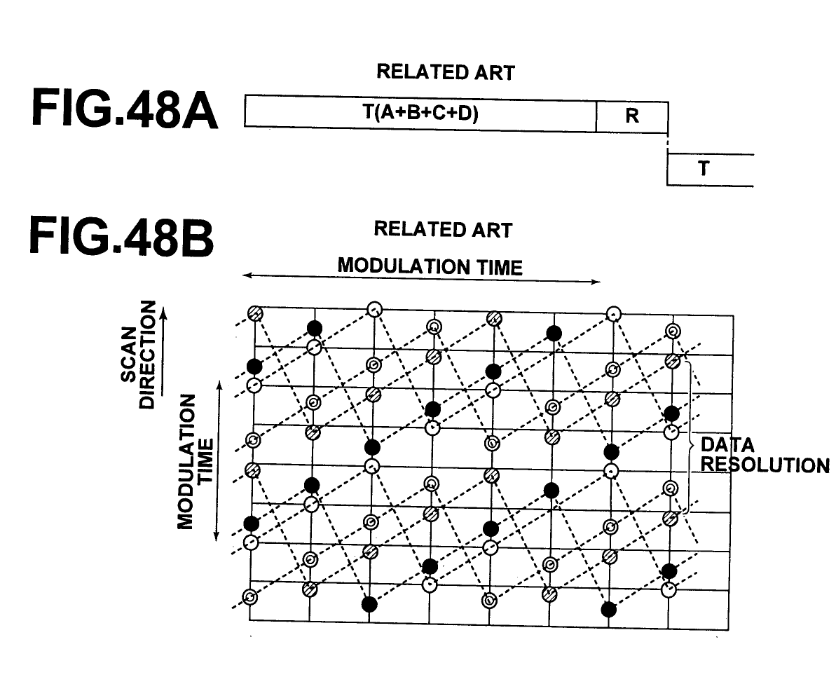

In the above embodiment, the micromirrors of each of the block areas A through D are sequentially reset by transferring the control signals to respective block areas A through D. FIGS. 48A and 48B illustrate a comparative example in which the micromirrors are reset after the control signals are transferred to all of the block areas A through D instead of sequentially resetting the micromirrors of each of the block areas A through D. When the micromirrors 62 are reset after the control signals are transferred to all of the block areas A through D, as illustrated in FIG. 48A, the drawn points are arranged, as illustrated in FIG. 48B. In FIG. 48B, points drawn by the micromirrors in the block area B, the block area C and the block area D are randomly arranged between the points drawn by the micromirrors 62 in the block area A. The drawn points are arranged in such a manner because timing of drawing in each of the block areas A through D is not determined by the sub-scan speed but only by modulation time. In FIG. 48A, the letter “T” represents transfer, and the letter “R” represents reset.

In the exposure apparatus according to the present embodiment, the drive of the DMD 50 in each of the exposure heads 166 is controlled, as described above. Accordingly, the drawn points are formed on the photoresist 150a, as described above.

Then, the photoresist 150a moves together with the stage 152 at constant speed, and a band-shaped exposed area 170 (please refer to FIG. 3A) is formed for each of the exposure heads 166.

When the first sub-scan on the photoresist 150a with exposure light ends and the sensor 164 detects a rear edge of the photoresist 150a, as described above, the stage drive device 304 returns the stage 152 to the origin on the most upstream side of the gate 160 along the guide 158. Then, second sub-scan is continuously performed. When two sub-scan operations are performed, an exposed area of which the exposure amount is at two different levels is formed on the photoresist 150a, as described above already.

In the exposure apparatus according to the present embodiment, the DMD 50 is divided into a plurality of block areas with respect to the sub-scan direction, and control signals for each of the plurality of block areas are transferred in parallel. Therefore, it is possible to increase the modulation speed compared with the conventional method. In the conventional method, image data is sequentially transferred and written in the SRAM. When the image data is transferred and written, image data corresponding to a row of micromirrors is transferred and written at one time. Then, the DMD 50 is reset after image data for all of the rows of micromirrors is transferred to the SRAM array. In the present embodiment, the DMD 50 is divided into 4 block areas, for example. Therefore, it is possible to increase the modulation speed four times.

Next, an exposure apparatus according to another embodiment will be described. The basic structure of the exposure apparatus in the present embodiment is substantially the same as that of the exposure apparatus in the afore-mentioned embodiment. In the present embodiment, the method for controlling the drive of the DMD 50 in each of the exposure heads 166 is different from the aforementioned embodiment. Therefore, only the method for controlling the drive of the DMD 50 in each of the exposure heads 166 will be described.

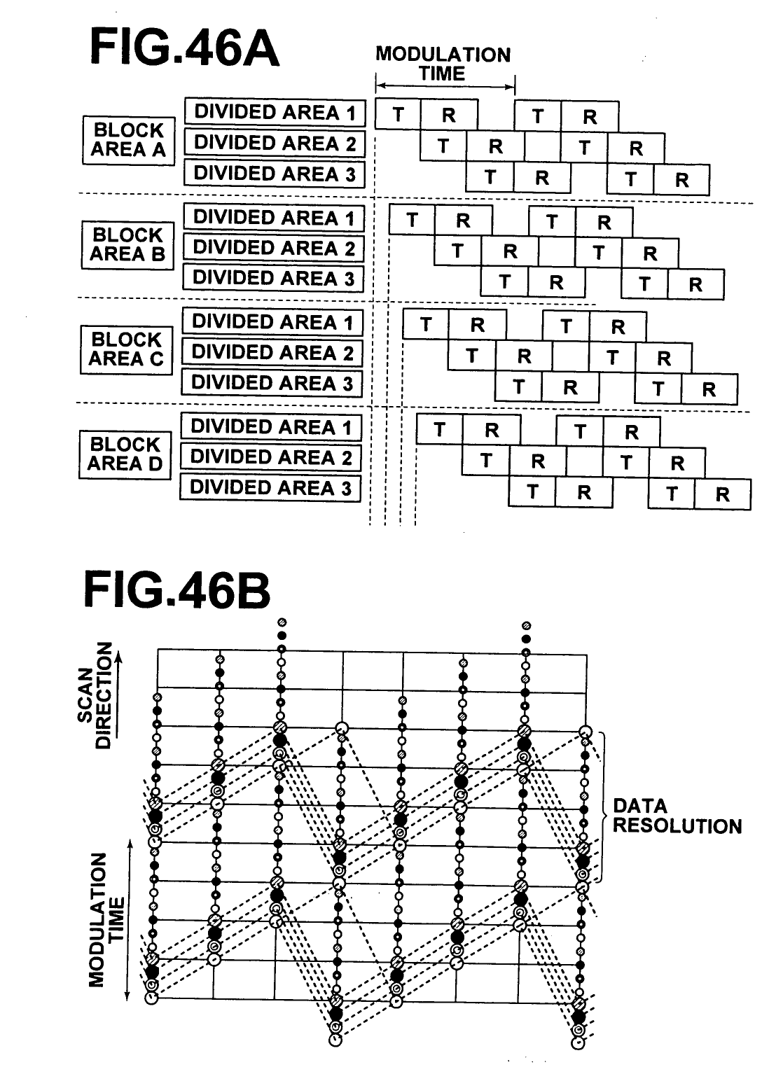

First, controls signals for each of the block areas A through D of the DMD 50 are transferred from the data control unit 968 to each of the control signal transfer units 960A through 960D. When the control signals are transferred, control signals for a row of micromirrors is transferred at one time. For example, in the block area A, control signals are sequentially transferred for each of the divided areas 1 through 3 of the block area A, as illustrated in FIG. 46A. In FIG. 46A, the letter “T” represents transfer, and the letter “R” represents reset. When transfer for each of the divided areas 1 through 3 in the block area A ends, the micromirrors 62 in the respective divided areas 1 through 3 are sequentially reset. In the other block areas B through D, the control signals are sequentially transferred to each of the divided areas 1 through 3 in a manner similar to the processing performed for the block area A. Then, when transfer for each of the divided areas 1 through 3 ends, the micromirrors 62 in the respective divided areas 1 through 3 are reset. Further, as illustrated in FIG. 46A, the control signals for each of the divided areas 1 through 3 in each of the block areas A through D are transferred by shifting timing of transfer by predetermined time, which has been set in advance.

In the present embodiment, the control signals are transferred to each of the divided areas 1 through 3 in each of the block areas A through D at the timing, as illustrated in FIG. 46A. Then, the micromirrors 62 in each of the divided areas 1 through 3 in each of the block areas A through Dare reset at the timing, as illustrated in FIG. 46A, and points are drawn on the photoresist 150a. FIG. 46B illustrates an example of the drawn points. In FIG. 46B, a white circle represents a point drawn by a micromirror 62 in a block area A. A double circle represents a point drawn by a micromirror 62 in the block area B. A black circle represents a point drawn by a micromirror 62 in the block area C. A shaded circle represents a point drawn by a micromirror 62 in the block area D.

As described above, in each of the block areas A through D, the control signals are transferred to each of the divided areas 1 through 3 and micromirrors in each of the divided areas 1 through 3 are reset. The timing of resetting for each of the divided areas 1 through 3 in each of the block areas A through D may be shifted from each other by predetermined time, which has been set in advance. Accordingly, as illustrated in FIG. 46B, it is possible to arrange the drawn points formed by the micromirrors 62 in each of the block area B, the block area C and the block area D in equal intervals between the drawn points formed by the micromirrors 62 in the block area A. Further, it is possible to repeatedly draw points three times by the micromirrors 62 of the block areas A through D while the photoresist 150a moves for the modulation time illustrated in FIG. 46B. In this case, the timing of resetting for each of the divided areas 1 through 3 may be directly controlled or set. Alternatively, the timing of resetting for each of the divided areas 1 through 3 in each of the block areas A through D may be controlled or set by controlling the timing of resetting of each of the block areas A through D. Further, the points which are drawn in the block areas A through D during the modulation time illustrated in FIG. 46B are not drawn in the same frame. The points of each of the block areas A through D are drawn in respective different frames. Further, the drawn points of each of the block area B, the block area C and the block area D may be arranged in equal intervals between the drawn points of the block area A, as described above, in a manner similar to the method in the first embodiment. Specifically, the sub-scan speed of the photoresist 150a, namely the movement speed of the stage 152, may be controlled based on a shift in modulation timing of each of the block areas A through D.

In the preset embodiment, each of the block areas is further divided into a plurality of divided areas with respect to the sub-scan direction. Further, in each of the block areas, controls signals are sequentially transferred to each of the divided areas. Further, modulation is sequentially performed when transfer ends. Therefore, in each of the block areas, transfer of image data to another divided area can be performed during resetting time of a single divided area. Therefore, it is possible to further increase the modulation speed for each of the block areas. Specifically, since each of the four block areas is divided into three divided areas, the modulation speed can be increased 12 times compared with the modulation speed in the conventional technique (assuming that the resolution is the same).

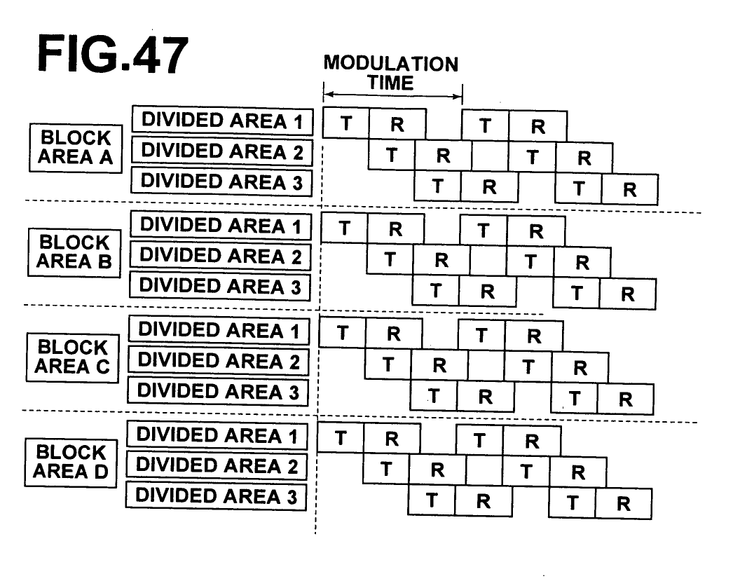

Further, in the exposure apparatus according to the present embodiment, the timing of modulation for each of the divided areas 1 through 3 in each of the block areas A through D is shifted from each other. However, it is not necessary that the modulation timing is shifted from each other. As illustrated in FIG. 47, the control signals may be simultaneously transferred to corresponding divided areas 1 through 3 in the block areas A through D so that the micromirrors 62 in corresponding divided areas 1 through 3 in all of the block areas A through D are simultaneously reset. In FIG. 47, the letter “T” represents transfer, and the letter “R” represents reset.

Further, the modulation timing of each of the divided areas 1 through 3 in each of the block areas A through D or the movement speed of the stage 152 may be controlled so that the drawn points of each of the divided areas 1 through 3 in each of the block areas A through D overlap with each other.

Further, in the above embodiment, the DMD 50 is divided into a plurality of block areas A through D with respect to the scan direction. However, it is not necessary that the DMD 50 is divided with respect to the scan direction. Alternatively, the DMD 50 may be divided into a pluralityof block areas, for example, in a direction perpendicular to the scan direction. Then, control signals may be transferred to respective block areas in parallel. Further, the block areas, which are formed by dividing the DMD 50 as described above, may be further divided into divided areas. The divided areas may be formed by dividing each of the block areas in the scan direction or in a direction perpendicular to the scan direction. Then, the control signals may be transferred and modulation may be performed for each of the divided areas in a manner similar to the aforementioned embodiment.

In the above embodiment, an exposure apparatus including a DMD as a spatial light modulation device has been described. However, it is not necessary that the DMD, which is a reflective-type spatial light modulation device, is used as the spatial light modulation device. Alternatively, a transmissive-type spatial light modulation device may be used as the spatial light modulation device.

Further, in the above embodiment, a so-called flatbed-type exposure apparatus was used as an example. However, the exposure apparatus may be a so-called outer-drum-type exposure apparatus, in which a photosensitive material is wound on a drum.

Further, it is not necessary that the photosensitive material, which is an exposure object in the above embodiment, is the photoresist 150a. The photosensitive material may be a print substrate or a filter for a display. Further, the shape of the photoresist 150a may be a sheet-shape or a long-length type (flexible substrate or the like).

1. An exposure method for exposing a photosensitive material to light in a predetermined pattern by illuminating the photosensitive material with exposure light emitted by an exposure head which emits light modulated by a spatial light modulation device, wherein an area extending in a predetermined direction on the photosensitive material is illuminated with the exposure light emitted from the exposure head, and wherein while the area is illuminated, the exposure head and the photosensitive material are moved relative to each other in a direction substantially perpendicular to the predetermined direction at least twice for each photosensitive material, and wherein the operation of the spatial light modulation device is controlled in each of the relative movements so as to enable formation of an exposed area, of which the exposure light amount is at least at two different levels, on the photosensitive material.

2. An exposure method as defined in claim 1, wherein a two-dimensional spatial light modulation device having a plurality of two-dimensionally arranged pixels is used as the spatial light modulation device, and wherein a portion of the photosensitive material is illuminated with light from a plurality of pixels consecutively aligned in a sub-scan direction so that the same portion is illuminated more than once.

3. An exposure method as defined in claim 1, wherein a DMD (digital micromirror device) is used as the spatial light modulation device.

4. An exposure method as defined in claim 1, wherein the photosensitive material is a photoresist formed on a base material or a structural member material formed on the base material so as to process the base material or the structural member material.

5. An exposure method as defined in claim 4, wherein the photoresist has a two-layer structure including a layer which is formed on the base material, and which has a relatively high sensitivity, and a layer which is further formed on the relatively high sensitivity layer, and which has a relatively low sensitivity.

6. An exposure method as defined in claim 4, wherein at least two structural members are formed by removing the photoresist stepwise from portions, of which the exposure light amounts are different from each other.

7. An exposure method as defined in claim 4, wherein the base material is an LCD-TFT (Liquid Crystal Display—Thin Film Transistor) panel, and wherein the structural member material is a material for forming a TFT (Thin Film Transistor) circuit.

8. An exposure method as defined in claim 1, wherein the base material is a conductive film, and wherein the photosensitive material has a two-layer structure including a layer which is formed on the base material, and which has a relatively high sensitivity, and a layer which is further formed on the relatively high sensitivity layer, and which has a relatively low sensitivity.

9. An exposure method as defined in claim 1, wherein the photosensitive material is a kind of structural member material which remains on the base material, and wherein the remained material includes portions, of which the thicknesses are at least at two different levels.

10. An exposure method as defined in claim 9, wherein the base material is an LCD-TFT panel, and wherein the structural member material is a material for a reflective member which is formed on the LCD-TFT panel, and which has an uneven pattern on its surface.

11. An exposure method as defined in claim 1, wherein the photosensitive material is at least two kinds of structural member material which remain on the base material.

12. An exposure method as defined in claim 11, wherein the structural member material has at least two layers, wherein the two layers are a layer which is formed on the base material, and which has a relatively high sensitivity, and a layer which is further formed on the relatively high sensitivity layer, and which has a relatively low sensitivity.

13. An exposure method as defined in claim 9, wherein the base material is an LCD-CF (Liquid Crystal Display—Color Filter) panel, and wherein the structural member material is at least a material for a rib member and a material for a post member.

14. An exposure method as defined in claim 9, wherein the base material is an LCD-CF (Liquid Crystal Display—Color Filter) panel, and wherein the structural member material is at least a material for an RGB (Red, Green and Blue) member for transmission and a material for an RGB member for reflection.

15. An exposure apparatus for exposing a photosensitive material to light in a predetermined pattern by illuminating the photosensitive material with exposure light modulated by a spatial light modulation device, the apparatus comprising;
an exposure head for illuminating an area extending in a predetermined direction on the photosensitive material with the modulated exposure light;
a sub-scan means for moving the exposure head and the photosensitive material relative to each other in a direction substantially perpendicular to the predetermined direction at least twice for each photosensitive material; and
an exposure amount control means for controlling the operation of the spatial light modulation device in each of the relative movements, wherein an exposed area, of which the exposure light amount is at least at two different levels, can be formed on the photosensitive material.

16. An exposure apparatus as defined in claim 15, wherein the spatial light modulation device is a two-dimensional spatial light modulation device having a plurality of two-dimensionally arranged pixels.

17. An exposure apparatus as defined in claim 15 ef4, wherein the spatial light modulation device is a DMD (digital micromirror device).

18. An exposure apparatus comprising:
a data division means for dividing original data on an image to be formed on a photosensitive material into image data on a low-sensitivity portion and image data on a high-sensitivity portion;
an exposure amount operation means for performing an operation, based on the image data on the low-sensitivity portion, to obtain an exposure amount for exposing a first photosensitive layer on the photosensitive material to light and for performing an operation, based on the image data on the high-sensitivity portion, to obtain an exposure amount for exposing a second photosensitive layer on the photosensitive material to light; and
an exposure control means for controlling each of exposure of the first photosensitive layer and exposure of the second photosensitive layer, based on the operation result obtained by the exposure amount operation means, separately in a forward movement and in a backward movement when exposure heads and the photosensitive material are moved relative to each other, wherein the first photosensitive layer and the second photosensitive layer on the photosensitive material are exposed to light by forming an image on the photosensitive material by projection of a light beam from a plurality of linearly arranged exposure heads onto the photosensitive material and by moving the plurality of exposure heads and the photosensitive material, forward and backward, relative to each other in a sub-scan direction, which is substantially perpendicular to the direction in which the plurality of exposure heads is linearly arranged, wherein the photosensitive material is formed by superposing the first photosensitive layer, which has a relatively low sensitivity, and the second photosensitive layer, which has a relatively high sensitivity, one on the other on a conductive film on a surface of a support.

19. An exposure apparatus comprising:
a data division means for dividing data on a printed circuit diagram, which is original data on an image for forming a printed circuit on a photosensitive material, into image data on a through-hole portion, which is related to the position of a through-hole penetrating the photosensitive material from one side of the photosensitive material to the other side thereof, and image data on a circuit pattern portion, which is related to a circuit pattern to be formed on the photosensitive material;
an exposure amount operation means for performing an operation, based on the image data on the through-hole portion, to obtain an exposure amount for exposing a first photosensitive layer on the photosensitive material to light and for performing an operation, based on the image data on the circuit pattern portion, to obtain an exposure amount for exposing a second photosensitive layer on the photosensitive material to light; and
an exposure control means for controlling each of exposure of the first photosensitive layer and exposure of the second photosensitive layer, based on the operation result obtained by the exposure amount operation means, separately in a forward movement and in a backward movement when exposure heads and the photosensitive material are moved relative to each other, wherein the first photosensitive layer and the second photosensitive layer on the photosensitive material are exposed to light by forming an image on the photosensitive material by projection of a light beam from a plurality of linearly arranged exposure heads onto the photosensitive material and by moving the plurality of exposure heads and the photosensitive material, forward and backward, relative to each other in a sub-scan direction, which is substantially perpendicular to the direction in which the plurality of exposure heads is linearly arranged, wherein the photosensitive material is formed by superposing the first photosensitive layer, which has a relatively low sensitivity, and the second photosensitive layer, which has a relatively high sensitivity, one on the other on a conductive film on a surface of a support.

20. An exposure apparatus as defined in claim 18, wherein the light amount of the light beam emitted from the plurality of exposure heads is constant, and wherein the exposure control means changes sub-scan speed, at which the plurality of exposure heads and the photosensitive material move relative to each other in the sub-scan direction, so that the sub-scan speed in the forward movement and the sub-scan speed in the backward movement are different from each other.

21. An exposure apparatus as defined in claim 19, wherein the light amount of the light beam emitted from plurality of exposure heads is constant, and wherein the exposure control means changes sub-scan speed, at which the plurality of exposure heads and the photosensitive material move relative to each other in the sub-scan direction, so that the sub-scan speed in the forward movement and the sub-scan speed in the backward movement are different from each other.

22. An exposure apparatus, as defined in claim 18, wherein the sub-scan speed, at which the plurality of exposure heads and the photosensitive material move relative to each other forward and backward in the sub-scan direction, is constant through the forward movement and the backward movement, and wherein the exposure control means controls the light amount of the light beam emitted from the plurality of exposure heads so that the light amount becomes a maximum light amount during exposure of the first photosensitive layer and the light amount of the light beam becomes 1/n (n is a positive integer) of the maximum light amount during exposure of the second photosensitive layer.

23. An exposure apparatus as defined in claim 19, wherein the sub-scan speed, at which the plurality of exposure heads and the photosensitive material move relative to each other forward and backward in the sub-scan direction, is constant through the forward movement and the backward movement, and wherein the exposure control means controls the light amount of the light beam emitted from the plurality of exposure heads so that the light amount becomes a maximum light amount during exposure of the first photosensitive layer light amount during exposure of the second photosensitive layer.

24. An exposure apparatus, as defined in claim 19, wherein the exposure control means moves the exposure heads and the photosensitive material relative to each other at higher speed without performing exposure in an area other than through-holes portions which are scattered on the photosensitive material during exposure based on the image data on the through-hole portion.
